(19) United States
(12) Patent Application Publication
(10) Pub. No.: US 2007/0256118 A1
(43) Pub. Date: Nov. 1, 2007

(54) Server Device, Device-Correlated Registration Method, Program, and Recording Medium

(76) Inventors: Takashi Nomura, Tokyo (JP); Masayuki Ishikawa, Chiba (JP); Takashi Kanao, Tokyo (JP); Eiju Yamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/662,211

(22) PCT Filed: May 11, 2006
(86) PCT No.: PCT/JP06/09515

§ 371 Date: Mar. 8, 2007

(30) Foreign Application Priority Data
May 11, 2005 (JP) 2005-138943
Apr. 27, 2006 (JP) 2006-124533

(51) Int. Cl. G06F 15/16

(52) U.S. Cl. 726/3

(57) ABSTRACT

In a network system controlling a device at home via a network, a direct access management server easily registering a control device and the controlled device is provided. The direct access management server receives a control device and service management ID acquisition request transmitted by a service server in response to a request from the control device, generates a control device and service management ID for a combination of the control device and a service, stores the control device and service management ID on a storage unit, and transmits the control device and service management ID to the service server. Upon receiving a password acquisition request, the direct access management server generates a controlled device registration password and transmits the controlled device registration password to the control device via the service server. The direct access management server authenticates the controlled device, thereby generating a device authentication continuation ID, and notifying the controlled device of the device authentication continuation ID. Upon receiving a controlled device registration request containing the controlled device registration password and the device authentication continuation ID from the controlled device, the direct access management server checks these pieces of information, generates a controlled device management ID for the controlled device, and stores on the storage unit the controlled device management ID with the control device and service management ID associated therewith.

### TECHNICAL FIELD

The present invention relates to a server apparatus, a registration method of registering a device, a program and a recording medium for registering devices as a control device and a controlled device in association with each other in order to allow a first device to access a second device via a network.

### BACKGROUND ART

A DDNS (Dynamic Domain Name System) or a mail system is available as a method of allowing a control device over the Internet to access a controlled device at home.

In the DDNS system, the controlled device at home registers the address thereof on a DDNS server, and receives a designation of a domain name and a port number from a control device over the Internet. The control device can thus access the controlled device.

As protocols for performing a real-time communication, XMPP (eXtensible Messaging and Presence Protocol) is available (for example, refer to “‘Extensible Messaging and Presence Protocol (XMPP):Core’, RFC3920, The Internet Engineering Task Force (IETF), October 2004”). One of real-time communications using the XMPP is Instant Messaging (IM) (for example, refer to “‘Extensible Messaging and Presence Protocol (XMPP):Instant Messaging and Presence’, RFC3921, The Internet Engineering Task Force (IETF), October 2004”). In Instant Messaging (IM), a determination is made as to whether an IM client (a partner exchanging IM) is on-line over the Internet, and exchanging chat and files with that IM client is thus performed.

Another protocol to call data and service available on another computer is SOAP (Simple Object Access Protocol) (for example, refers to “‘SOAP Version 1.2’, W3C Recommendation, World Wide Consortium (W3C), June 2003”). In communications using SOAP, a message having incidental information called an envelope is converted into XML (eXtensible Markup Language) document in accordance with HTTP (HyperText Transfer Protocol). Since each of a client receiving service and a server providing service has a generation and interpretation engine thereof, an object can be called between different environments.

### DISCLOSURE OF INVENTION

### Problems to be Solved by the Invention

The DDNS method requires that a combination of a domain name and a port number be registered in response to application on a control device. If a plurality of controlled devices is present at home, a port disclosed to the Internet needs to be fixed. To this end, an address to the controlled device at home and a port forward to a port need to be set on a per application basis, with each application corresponding to a controlled device. This setting is time consuming. A port with the port forward set remains open, thereby decreasing security level.

In summary, the DDNS method is effective only in an environment where only one apparatus, providing an application, such as a Web server permits a control device to access a single port at home.

In accordance with the mail system, a control device conveniently accesses a controlled device with an existing mail client software program. Since the controlled device acquires a mail by polling a mail server, a polling interval as long as at least several minutes occurs, and real-time feature is thus destroyed. Vulnerability to spam mail needs to be improved.

In view of the above-mentioned problems, it is an object of the present invention to provide a server apparatus, a registration method of a device, a program, and a recording medium for easily registering each device in a network system in which a first device controls a second device via a network.

### MEANS FOR SOLVING THE PROBLEM

To overcome the above-described problems, a server apparatus of the present invention for registering a first device and a second device with the devices associated with each other, the first device being linked to the second device via a network, includes storage means for storing information, first processing means for generating a first password in response to a password issuance request from the first device, storing the first password with first identification of the first device associated therewith on the storage means, and transmitting the first password to the first device, and second processing means for receiving a second password transmitted from the second device, determining whether the received second password is the one stored on the storage means, and storing second identification information of the second device with the first identification information associated therewith if the second password is stored on the storage means.

The server apparatus issues the first password to the first device, and stores the first password with the first identification information of the first device associated therewith on the storage means. The first password issued to the first device is transferred from the first device to the second device, and then stored as the second password on the second device. Upon receiving the second password transmitted from the second device, the server apparatus determines whether the received second password has been stored on the storage means. If the second password is stored on the storage means, the server apparatus stores the second identification information of the second device with the first identification information associated therewith on the storage means. In accordance with the present invention, the first device issues the password issuance request to the server apparatus, and the second apparatus acquires the first password from the first device and sends the acquired first password to the server apparatus. The first identification information of the first device and the second identification information of the second device as a device to be controlled by the first device are stored in association with each other.

In the server apparatus of the present invention, the first processing means generates the first identification information of the first device, and stores the generated first identification information and the first password in association with each other on the storage means.

In the server apparatus of the present invention, the first device may be connected to the server apparatus via a service server apparatus providing a service to the first device, and the first processing means may generate, as the first identification information, identification information of the first device and the service server apparatus. In this case, the first processing means generates, as the first identification information, identification information of a combination of the first device and the service provided by the service server apparatus.

The server apparatus of the present invention may further include means for performing a device authentication process authenticating the second device, generating authentication identification information relating to authentication information required to authenticate the second device, and transmitting the generated authentication identification information to the second device, wherein the second processing means stores, as the second identification information, the authentication identification information with the first identification information associated therewith on the storage means.

In the server apparatus of the present invention, the first processing means sets an effective period to the first password, and the second processing means checks the effective period and if the effective period of the first password has expired, does not associate the second identification information with the first identification information.

In the server apparatus of the present invention, the first processing means transmits to the first device the generated first password and information relating to the effective period of the first password.

In the server apparatus of the present invention, the server apparatus associates a plurality of pieces of second identification information with the first identification information.

In the server apparatus of the present invention, the server apparatus associates the second identification information with a plurality of pieces of first identification information.

In the server apparatus of the present invention, the second processing means deletes the first password stored on the storage means when the second identification information is stored with the first identification information associated therewith.

The server apparatus of the present invention may further include means for generating a list of the second identification information with the first identification information associated therewith based on association between the first identification information and the second identification information stored on the storage means and transmitting the list to the first device.

Upon receiving a request from the first device forwarded to the second device, the server apparatus determines whether the first identification information of the first device is stored with the second identification information associated therewith on the storage means, and transmits an error signal to the first device if the first identification information is not stored with the second identification information associated therewith.

Upon receiving a request from the first device forwarded to the second device, the server apparatus determines whether the first identification information of the first device is stored with the second identification information associated therewith on the storage means, and transmits the request from the first device to the second device if the first identification information is stored with the second identification information associated therewith.

### Advantages

The present invention provides a server apparatus, a registration method of registering a device, a program and a recording medium for registering devices as a control device and a controlled device in association with each other in order to allow a first device to access a second device via a network.

### BRIEF DESCRIPTION OF THE DRAWINGS

FIG. 1 generally illustrates a network system in accordance with a first embodiment of the present invention.

FIG. 2 illustrates a sequence chart of flow of information in the registration of a combination of a control device and a service thereof and the registration of a controlled device in the network system of FIG. 1.

FIG. 3 is a flowchart illustrating operation of the control device during the registration process of FIG. 2.

FIG. 4 is a flowchart illustrating operation of a service server during the registration process of FIG. 2.

FIG. 5 is a flowchart illustrating operation of a direct access management server during the registration process shown FIG. 2.

FIG. 6 is a flowchart illustrating operation of a DVR during the registration process of FIG. 2.

FIG. 7 is a sequence chart of a flow of information during an XMPP login and a remote preprogrammed recording operation of the controlled device in the network system of FIG. 1.

FIG. 8 is a flowchart of a remote preprogrammed recording operation of a cellular phone.

FIG. 9 is a flowchart illustrating a remote preprogrammed recording operation of a service server.

FIG. 10 is a flowchart illustrating an XMPP login of the controlled device, a remote preprogrammed recording operation, and a content acquisition operation of a direct access management server.

FIG. 11 is a flowchart of a remote preprogrammed recording operation, and a content acquisition operation of the direct access management server.

FIG. 12 is a flowchart of a remote preprogrammed recording operation, and a content acquisition operation of the DVR.

FIG. 13 is a sequence chart of a flow of information in a direct remote preprogrammed recording operation performed by a cellular phone in the network system of FIG. 1.

FIG. 14 is a sequence chart of a flow of information in a tunneling remote preprogrammed recording operation performed by the cellular phone in the network system of FIG. 1.

FIG. 15 is a sequence chart of a flow of information in a content acquisition operation performed through direct access by the cellular phone in the network system of FIG. 1.

FIG. 16 is a sequence chart of a flow of information in a content acquisition operation performed through direct access by the service server in the network system of FIG. 1.

FIG. 17 is a flowchart of a content acquisition operation of the cellular phone.

FIG. 18 is a flowchart of a content acquisition operation of the service server.

FIG. 19 is a flowchart of a content acquisition operation of the service server.

FIG. 20 is a sequence chart of a flow of information at the ending of a direct access in the network system of FIG. 1.

FIG. 21 is a flowchart of a direct access completion operation of the service server.

FIG. 22 is a flowchart of a direct access completion operation of the direct access management server.

FIG. 23 is a flowchart of a direct access completion operation of the DVR.

FIG. 24 illustrates a structure of FullJID.

FIG. 25 illustrates a structure of another FullJID.

FIG. 26 is a sequence chart of a flow of information in the registration operation of a combination of the cellular phone and the service thereof and the registration operation of the DVR in the network system in accordance with a second embodiment of the present invention.

FIG. 27 is a flowchart illustrating the registration operation of the cellular phone of FIG. 26.

FIG. 28 is a flowchart illustrating the registration operation of the service server of FIG. 26.

FIG. 29 is a flowchart of the registration operation of the direct access management server of FIG. 26.

FIG. 30 is a flowchart of the registration operation of the direct access management server of FIG. 26.

FIG. 31 is a flowchart illustrating the registration operation of the DVR of FIG. 26.

FIG. 32 is a sequence chart of a flow of information in the tunneling remote preprogrammed recording operation from the cellular phone without the service server being involved.

FIG. 33 illustrates the concept of the present invention.

FIG. 34 illustrates one modification of the server apparatus of the present invention.

FIG. 35 illustrates another modification of the server apparatus of the present invention.

FIG. 36 illustrates yet another modification of the server apparatus of the present invention.

### BEST MODE FOR CARRYING OUT THE INVENTION

The embodiments of the present invention are described below.

### First Embodiment

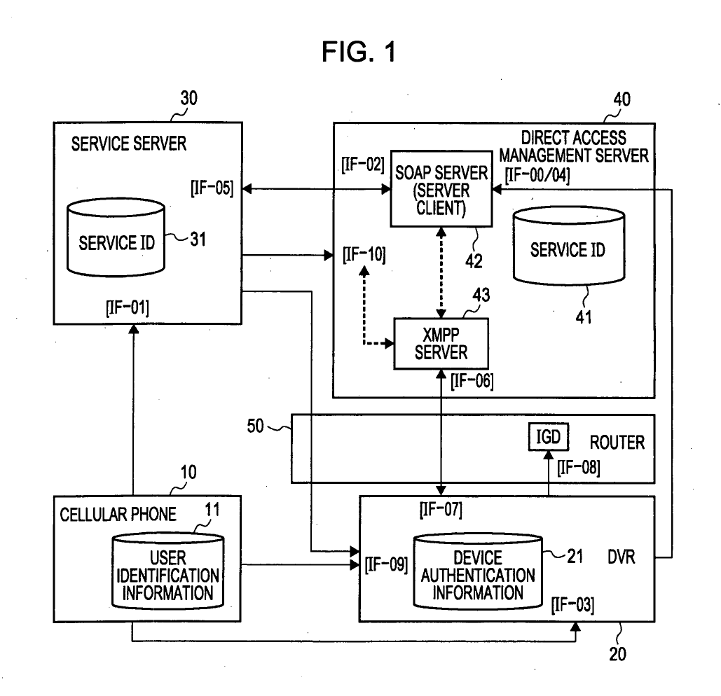

FIG. 1 generally illustrates a network system in accordance with a first embodiment of the present invention.

The network system includes a cellular phone 10 as a control device, a DVR (Digital Video Recorder) 20 as a controlled device, a service server 30, a direct access management server 40 and a router 50.

The cellular phone 10 operates as the control device controlling the controlled device. Any device can be the control device as long as that device controls the controlled device. The control device may be a PC (Personal Computer), a PDA (Personal Digital Assistant), or the like.

The cellular phone 10 includes, in addition to a telephone function, a main memory storing a program, a CPU (Central Processing Unit) performing a variety of processes by executing the program stored the main memory, an interface with a network, an interface with the DVR 20, a user interface such as a key input unit or a display, and a non-volatile storage unit 11. The storage unit 11 stores user identification information registered on the cellular phone 10. The main memory stores, in addition to the program for operating the telephone function, a program for registering own device onto the service server 30, a remote preprogrammed recording operation of content, and performing a process to acquire content.

The DVR 20 includes a recording and reproducing functional unit for recording content such as a broadcast program to or reproducing content from a medium, a main memory storing a program, a CPU performing a variety of processes by executing the program stored on the main memory, an interface with the network, an interface with the cellular phone 10, a non-volatile storage unit 21, a remote signal receiver, and an interface for connection with a TV or the like. The storage unit 21 pre-stores device authentication information permanently assigned to a controlled device. The main memory stores, in addition to a program for controlling the recording and reproducing functional unit in the DVR 20, a program for registering of the controlled device to a direct access management server 40, setting remote preprogrammed recording for content, and acquiring content. In accordance with the present embodiment, the DVR 20 is the controlled device. Any device is acceptable as the controlled device as long as that device has a networking function. A television receive may be acceptable as the controlled device, for example.

The service server 30 provides a variety of services that allow the control device such as the cellular phone 10 to access the controlled device via a network. The service server 30 includes an input unit such as a keyboard and a mouse, a display, a main memory storing a program, a CPU performing a variety of processes by executing the program stored on the main memory, a communication unit with the network, and a storage unit. The service server 30 is typically constructed of a computer system. The main memory stores a program to perform service in addition to a basic program required to operate the computer system. The storage unit 31 stores ServiceID for identifying a service server for each service provided by the service server 30 and a Service ID for identifying a service.

The direct access management server 40 manages correspondence between a combination of the control device and the service of the service server 30 and the controlled device. For example, the direct access management server 40 includes an input unit such as a keyboard and a mouse, a display, a main memory storing a program, a CPU for performing a variety of processes by executing the program stored on the main memory, an interface with the network, and a storage unit 41. The direct access management server 40 may be constructed of a typical computer system. The main memory stores, in addition to a basic program for operating the computer system, a program for causing the computer system to function as a direct access management server.

The direct access management server 40 includes a SOAP (Simple Object Access Protocol) server 42 and an EXMPP (eXtensible Messaging and Presence Protocol) server 43. The SOAP server 42 registers a combination of the control device and the service thereof, registers the controlled device, and performs information exchange for direct access to the service server. The XMPP server 43 sets a two-way stay-connected session with the DVR 20 as the controlled device. The SOAP server and the XMPP server are used in one embodiment only, and the SOAP server may be replaced with a server using another API calling method, and the XMPP server may be replaced with a server using another IM method.

The interfaces of the devices are described below. As shown in FIG. 1, [IF-**] represents an interface number.

The SOAP server 42 of the direct access management server 40 includes an interface [IF-02] to be accessed by the service server 30 and an interface [IF-00, IF-04] to be accessed by the DVR 20. The SOAP server 42 has a SOAP client function and accesses an interface [IF-05] on the side of the service server 30. The interface of the XMPP server 43 is accessed by an XMPP client to establish an XMPP session. In the present system, an interface [IF-06] to be accessed by the DVR 20 corresponds to the interface of the XMPP server 43. Since messages can be exchanged in two ways using the interface [IF-06] after establishing the XMPP session, an interface [IF-07] in the DVR 20 can be accessed by the XMPP server 43. The direct access management server 40 includes, with respect to the service server 30, an interface [IF-10] for a direct access URI (Uniform Resource Identifier) provided during XMPP tunneling operation to be discussed later.

The service server 30 includes an interface [IF-01] to be accessed by the cellular phone 10 and the interface [IF-05] to be accessed by the direct access management server 40.

The service server 30 is not directly interfaced to the XMPP server 43 in the direct access management server 40 in this system configuration. Alternatively, the service server 30 may be directly interfaced to the XMPP server 43.

The DVR 20 includes the interface [IF-07] to be accessed by the direct access management server 40 subsequent to the establishment of an XMPP session, an interface [IF-03] for exchanging data with the cellular phone 10 by means of infrared light or an USB (Universal Serial Bus), and an interface [IF-09] supporting a direct access URI to be accessed by the cellular phone 10.

The router 50 includes an interface [IF-08] having a UPnP (Universal Plug and Play) IGD (Internet Gateway Device) function to be accessed by the DVR 20.

Operation of the network system of the present embodiment is described below. In the discussion that follows, a format <X-XX> represents a request and a format <X-XXR> represents a response.

[1. Control Device and Service, and Registration of Controlled Device]

A control device and service management ID issued for each combination of the cellular phone 10 (control device) and service thereof is linked to a controlled device management ID issued in the direct access management server 40 for each DVR 20 (controlled device). This linking operation is described first.

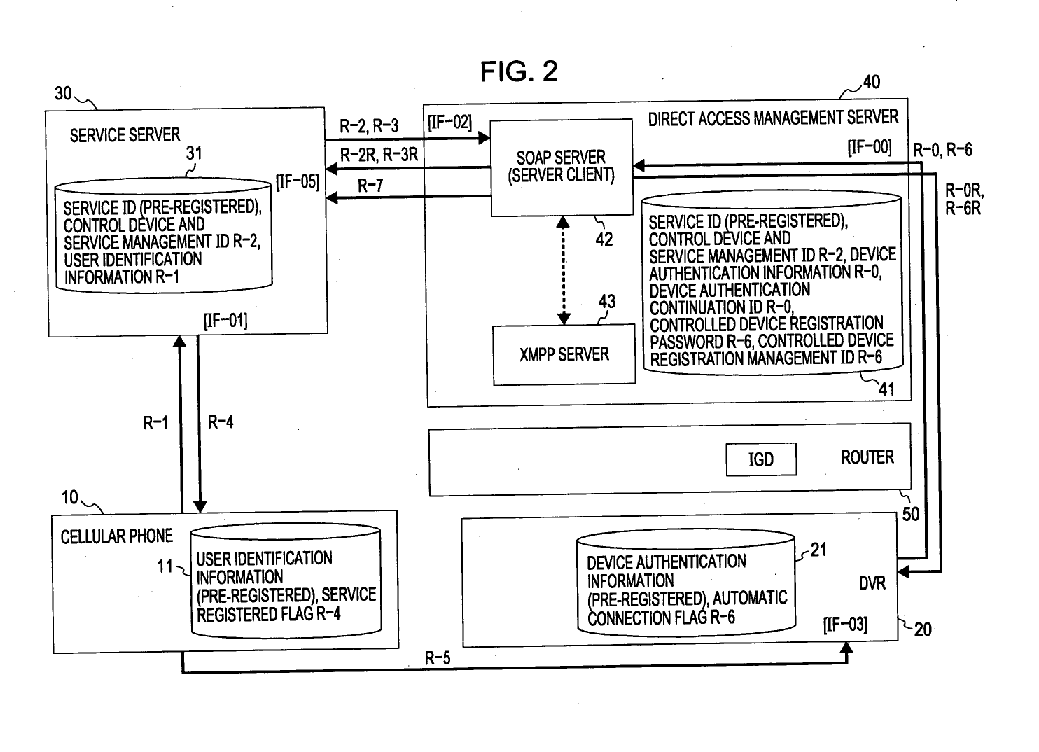

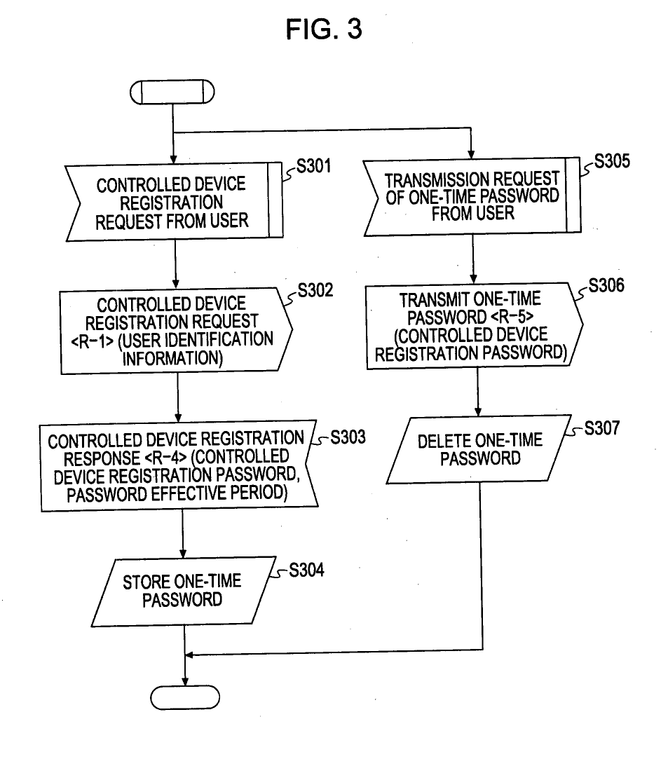

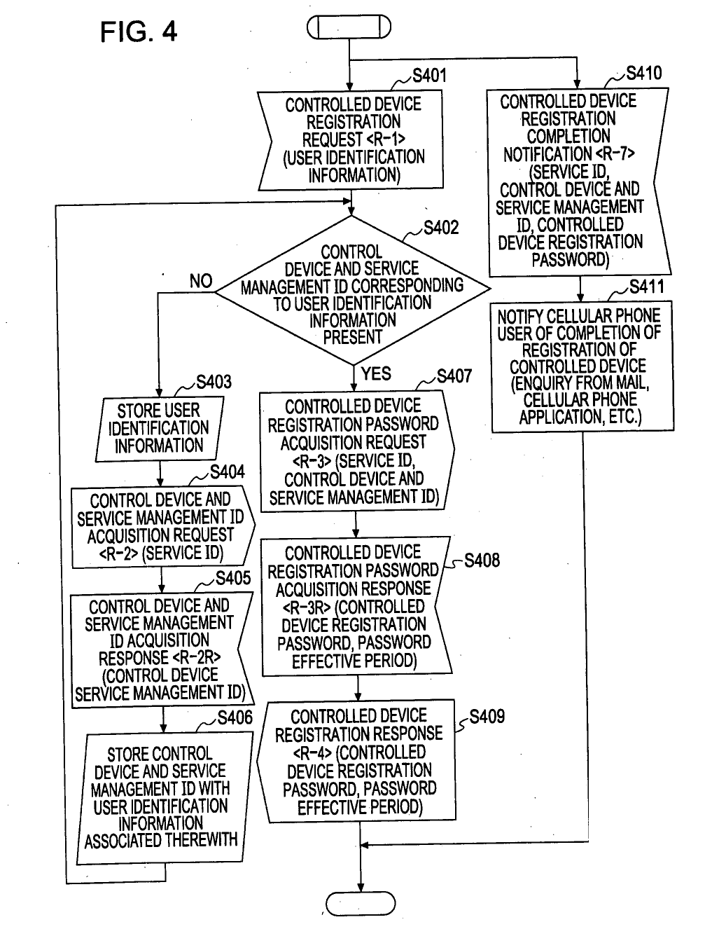

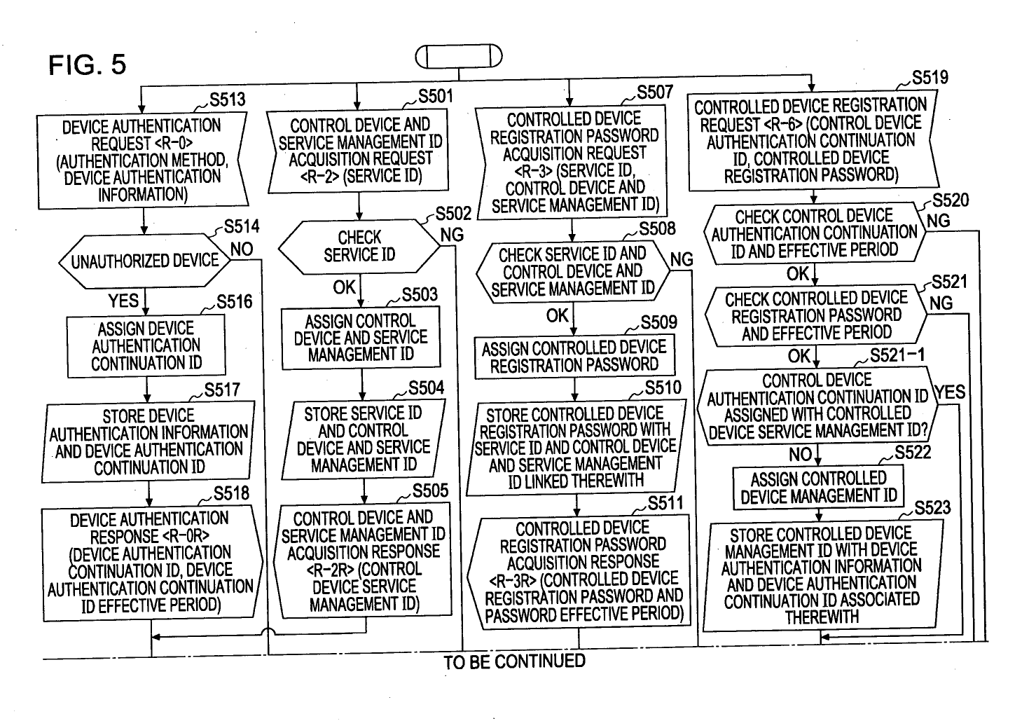

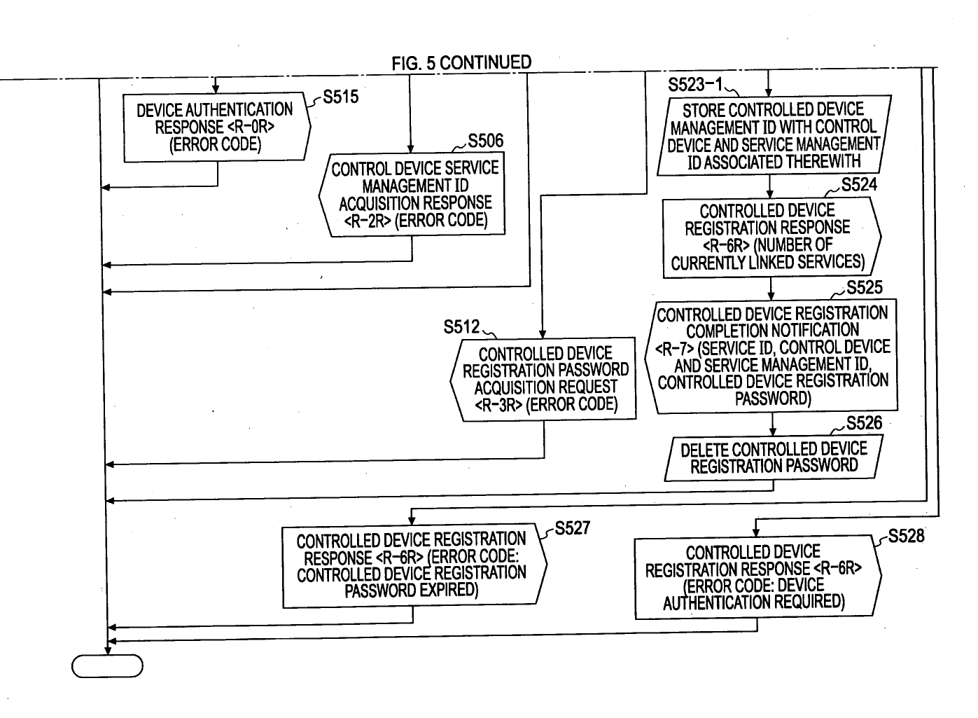

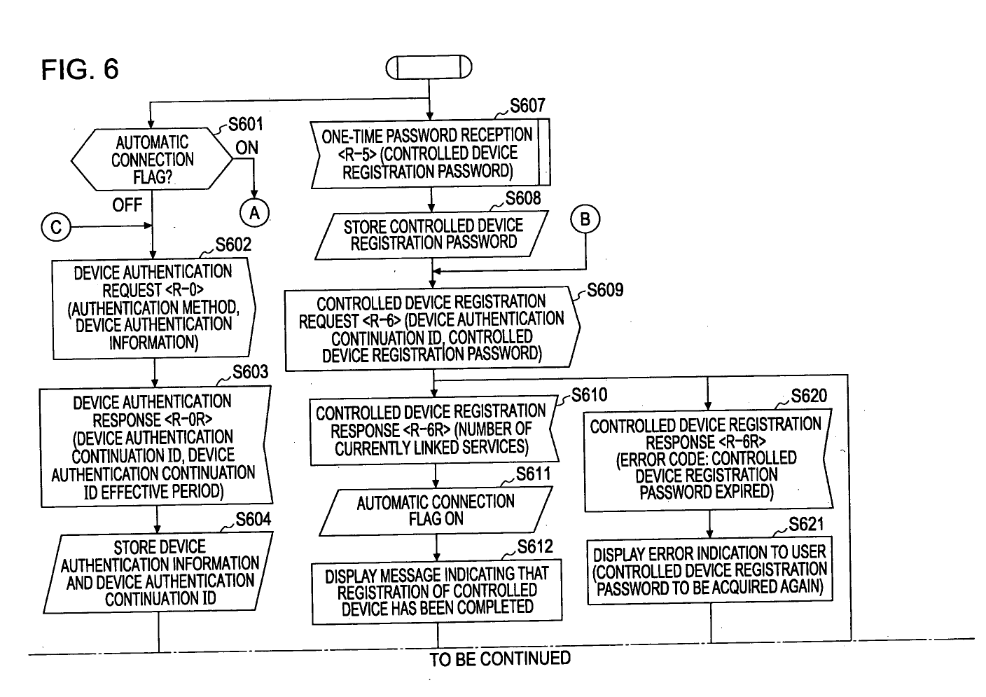

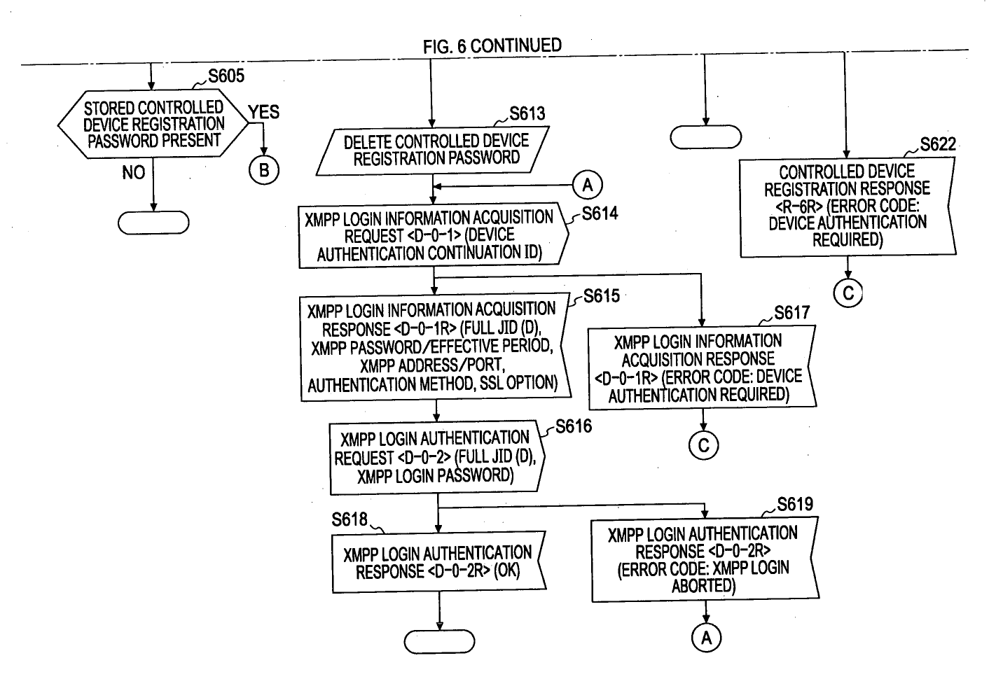

FIG. 2 is a sequence chart of a flow of information in the registration process of the cellular phone 10 and the service thereof and the registration process of the DVR 20. FIG. 3 is a flowchart of the registration process of the cellular phone 10. FIG. 4 is a flowchart of the registration process of the service server 30. FIG. 5 is a flowchart of the registration process of the direct access management server 40. FIG. 6 is a flowchart of the registration process of the DVR 20.

[1.1. Registration of Combination of the Control Device and Service]

The cellular phone 10 receives an instruction for controlled device registration from a user (FIG. 3: step S301), and issues a controlled device registration request <R-1> containing user identification information (FIG. 3: step S302).

Upon receiving the controlled device registration request <R-1> containing the user identification information (FIG. 4: step S401), the service server 30 determines whether the control device and service management ID corresponding to the user identification information is stored on the storage unit 31 (FIG. 4: step S402).

If the control device and service management ID corresponding to the user identification information is not stored, the service server 30 stores the user identification information on the storage unit 31 (FIG. 4: step S403), and issues a control device and service management ID acquisition request <R-2> containing ServiceID pre-assigned thereto to the SOAP server 42 in the direct access management server 40 (FIG. 4: step S404). The control device and service management ID is an ID uniquely assigned to a combination of each service provided by a service provider and a control device.

Upon receiving the control device and service management ID acquisition request <R-2> (FIG. 5: step S501), the SOAP server 42 determines whether the ServiceID contained in the control device and service management ID acquisition request <R-2> matches the ServiceID pre-registered on the storage unit 41 in the direct access management server 40 (FIG. 5: step S502). If one ID fail to match the other, the SOAP server 42 transmits to the service server 30 an error code, as a control device and service management ID acquisition response <R-2R>, indicating that the ServiceID is unregistered (FIG. 5: step S506). If the two ServiceIDs match each other, the SOAP server 42 issues a new control device and service management ID (FIG. 5: step S503), registers the association relationship between the control device and service management ID to the ServiceID on the storage unit 41 (FIG. 5: step S504). The SOAP server 42 transmits that control device and service management ID as the control device and service management ID acquisition response <R-2R> to the service server 30 (FIG. 5: step S505). In this way, the direct access management server 40 identifies the control side, viewed from the direct access management server 40, in the form of a combination of the cellular phone 10 as the control device and the service provided by the service server 30 and used by the cellular phone 10.

Upon receiving the control device and service management ID as the control device and service management ID acquisition response <R-2R> (FIG. 4: step S405), the service server 30 registers the control device and service management ID with the user identification information associated therewith on the storage unit 31 (FIG. 4: step S406). By storing the control device and service management ID with the user identification information associated therewith, the service server 30 requests the direct access management server 40 to perform a process using the control device and service management ID corresponding to the user identification information of the cellular phone 10 when the service server 30 is accessed by the cellular phone 10. The service server 30 can thus cause the direct access management server 40 to identify uniquely the control source side as a combination of the cellular phone 10 as the control device and the service of the service server 30.

After the service server 30 registers the control device and service management ID with the user identification information associated therewith on the storage unit 31 or if the control device and service management ID corresponding to the user identification information contained in the controlled device registration request <R-1> received from the cellular phone 10 is stored on the storage unit 31, the service server 30 issues to the SOAP server 42 in the direct access management server 40 a controlled device registration password acquisition request <R-3> containing the control device and service management ID and the ServiceID (FIG. 4: step S407).

Upon receiving the controlled device registration password acquisition request <R-3> ((FIG. 5: step S507), the SOAP server 42 in the direct access management server 40 determines whether the combination of the control device and service management ID and the user identification information contained in the controlled device registration password acquisition request <R-3> is registered on the storage unit 41 (FIG. 5: step S508). If the combination is not registered, the SOAP server 42 transmits to the service server 30 an error code as a controlled device registration password acquisition response <R-3R> indicating that the combination of the control device and service management ID and the ServiceID is unregistered (FIG. 5: step S512). If the combination of the control device and service management ID and the user identification information contained in the controlled device registration password acquisition request <R-3> is already registered on the storage unit 41, the SOAP server 42 generates a new controlled device registration password ((FIG. 5: step S509). The SOAP server 42 registers the controlled device registration password and information relating to an effective period set to the controlled device registration password with the control device and service management ID and the ServiceID contained in the controlled device registration password acquisition request <R-3> associated therewith on to the storage unit 41 (FIG. 5: step S510). The SOAP server 42 then transmits to the service server 30 the controlled device registration password and the information relating to the effective period of the controlled device registration password as the controlled device registration password acquisition response <R-3R> (FIG. 5: step S511).

Upon receiving the controlled device registration password acquisition response <R-3R> (FIG. 4: step S408), the service server 30 transmits to the cellular phone 10 the controlled device registration password and the information relating to the effective period thereof, contained in the controlled device registration password acquisition response <R-3R>, as a controlled device registration response <R-4> (FIG. 4: step S409).

Upon receiving the controlled device registration response <R-4> (FIG. 3: step S303), the cellular phone 10 stores the controlled device registration password and the information relating to the effective period thereof contained in the controlled device registration response <R-4> onto the storage unit 11 (FIG. 3: step S304).

In this way, the registration process of the control device and service management ID of the combination of the cellular phone 10 and the service and the issuance process of issuing the controlled device registration password for use in associating the controlled device to the control device have been completed.

[1.2. Registration of the Controlled Device]

Operation of the DVR 20 as the controlled device during the registration process is described below.

As described below, the DVR 20 performs a device authentication process thereof in the direct access management server 40 before a user uses the DVR 20.

The DVR 20 first checks the value of an automatic connection flag (FIG. 6: step S601). The automatic connection flag prior to the registration of the controlled device to the direct access management server 40 is off. The DVR 20 in this case transmits device authentication request <R-0> containing information concerning an authentication method predetermined therein and device authentication information to the SOAP server 42 in the direct access management server 40 (FIG. 6: step S602).

Upon receiving the device authentication request <R-0> from the DVR 20 (FIG. 5: step S513), the SOAP server 42 in the direct access management server 40 determines, based on the information concerning the authentication method and the device authentication information contained in the device authentication request <R-0>, whether the DVR 20 is an authorized device (FIG. 5: step S514). If it is determined that the DVR 20 is an unauthorized device, i.e., if the authentication method is different from a predetermined one, or if the device authentication information is different from a format of the predetermined device authentication method, the SOAP server 42 transmits to the DVR 20 an error code as a device authentication response <R-0R> indicating that the device authentication is aborted (FIG. 5: step S515). If it is determined that the DVR 20 is an authorized device, i.e., if the authentication method matches a predetermined one, and if the device authentication information agrees with the format of the predetermined device authentication method, the SOAP server 42 generates a device authentication continuation ID to be assigned to the DVR 20 (FIG. 5: step S516), and stores the generated device authentication continuation ID with the device authentication information contained in the device authentication request <R-0> associated therewith on the storage unit 41 (FIG. 5: step S517). The SOAP server 42 transmits device authentication response <R-0R> containing the device authentication continuation ID and the information relating to the effective period of the device authentication continuation ID to the DVR 20 (FIG. 5: step S518). The device authentication continuation ID is identification information assigned to a device that has been authenticated by the direct access management server 40. Using that identification information, the direct access management server 40 can recognize device authentication status of the DVR 20 as the controlled device.

Upon receiving the device authentication response <R-0R> containing the device authentication continuation ID and the effective period thereof from the SOAP server 42 in the direct access management server 40 (FIG. 6: step S603), the DVR 20 stores the device authentication continuation ID and the information of the effective period thereof, contained in the device authentication response <R-0R>, with the device authentication information associated therewith on the storage unit 21 (FIG. 6: step S604).

The DVR 20 determines whether the controlled device registration password is stored on the storage unit 21 (FIG. 6: step S605). If no controlled device registration password is stored on the storage unit 21, processing ends. If the controlled device registration password is stored on the storage unit 21, processing proceeds to step S609. Since the controlled device registration password is not stored immediately subsequent to the acquisition of the device authentication continuation ID, processing ends. The DVR 20 as the controlled device stores a combination of the device authentication continuation ID, the information relating to the effective period of the device authentication continuation ID, and the device authentication information on the storage unit 21. The direct access management server 40 stores a combination of the device authentication continuation ID and the device authentication information on the storage unit 41.

[1.1. Linking of Control Device and Service Management ID to Controlled Device Management ID]

The control device and service management ID and the controlled device management ID are associated with each other and then registered on the direct access management server 40. The cellular phone 10 receives a one-time password transmission request from the user (FIG. 3: step S305). Upon receiving the one-time password transmission request from the user, the cellular phone 10 transfers the controlled device registration password stored on the storage unit 11 to the DVR 20 as the controlled device as a one-time password <R-5> using an interface [IF-03] of infrared type or USB type (FIG. 3: step S306). To transfer the controlled device registration password, a variety of methods using contactless type IC card, radio link such as Bluetooth (Trade Mark), or radio LAN, may be considered. Any method is acceptable as long as the method permits the controlled device registration password to be transferred from the cellular phone 10 as the control device to the DVR 20 as the controlled device. Then, the cellular phone 10 deletes the controlled device registration password from the storage unit 11 (FIG. 3: step S307).

Upon receiving the controlled device registration password <R-5> from the cellular phone 10 (FIG. 6: step S607), the DVR 20 stores the controlled device registration password on the storage unit 21 (FIG. 6: step S608). In succession, the DVR 20 transmits, to the SOAP server 42 in the direct access management server 40, a controlled device registration request <R-6> containing the device authentication continuation ID stored on the storage unit 21, and the controlled device registration password received from the cellular phone 10 (FIG. 6: step S609). The DVR 20 thus requests the direct access management server 40 to store the controlled device registration password in association with the cellular phone 10.

Upon receiving the controlled device registration request <R-6> from the DVR 20 (FIG. 5: step S519), the SOAP server 42 in the direct access management server 40 determines whether the device authentication continuation ID contained in the controlled device registration request <R-6> matches the one stored on the storage unit 41 and checks the effective period of the device authentication continuation ID (FIG. 5: step S520). If a no good result is obtained, i.e., if the device authentication continuation IDs fail to match each other, or if the effective period of the device authentication continuation ID has expired, the SOAP server 42 transmits to the DVR 20 a controlled device registration response <R-6R> containing an error code indicating that device authentication is required (FIG. 5: step S528). Upon receiving the controlled device registration response <R-6R> containing the error code (FIG. 6: step S622), the DVR 20 returns to step S602 to repeat the device authentication process.

If an OK check result is obtained in step S520, i.e., if the device authentication continuation ID matches the one stored on the storage unit 41, and if the effective period of the device authentication continuation ID has not expired, the SOAP server 42 determines whether the controlled device registration password contained in the controlled device registration request <R-6> received from the DVR 20 matches the one stored on the storage unit 41 and checks the effective period of the controlled device registration password (FIG. 5: step S521). If a no good result is obtained, i.e., if the two controlled device registration passwords fail to match each other or if the effective period of the device authentication continuation ID has expired, the SOAP server 42 transmits to the DVR 20 an error code, as a controlled device registration response <R-6R>, indicating that the controlled device registration password contained in the controlled device registration request <R-6> is invalid (FIG. 5: step S527). Upon receiving the error code as the controlled device registration response <R-6R> (FIG. 6: step S620), the DVR 20 displays an error message on a screen of a TV connected thereto to the user thereby prompting the user to re-acquire the controlled device registration password (FIG. 6: step S621). Processing thus ends.

If an OK check result is obtained in step S521, i.e., if the controlled device registration password matches the one stored on the storage unit 41, and the effective period of the controlled device registration password has not expired, the SOAP server 42 references information stored on the storage unit 41 to determine whether the controlled device management ID is assigned to the device authentication continuation ID contained in the controlled device registration request <R-6> (FIG. 5: step S521-1). If the controlled device management ID is not assigned to the device authentication continuation ID, the SOAP server 42 assigns the controlled device management ID to the DVR 20 (FIG. 5: step S522). The SOAP server 42 stores the assigned controlled device management ID with the device authentication information and the device authentication continuation ID of the DVR 20 associated therewith on the storage unit 41 (FIG. 5: step S523). If the controlled device management ID is already assigned to the device authentication continuation ID contained in the controlled device registration request <R-6>, the SOAP server 42 stores on the storage unit 41 the controlled device management ID with the control device and service management ID, stored in association with the controlled device registration password, associated therewith (FIG. 5: step S523-1). The controlled device management ID is identification information uniquely assigned to the controlled device in the direct access management server 40. In this way, the control device and service management ID assigned to the combination of the control device and the service is linked to the controlled device management ID assigned to the controlled device. In the linking process, a plurality of controlled device management IDs may be assigned to a single control device and service management ID or conversely, a plurality of control device and service management IDs may be assigned to a single controlled device management ID.

The SOAP server 42 transmits to the DVR 20 the number of currently linked services as a controlled device registration response <R-6R> (FIG. 5: step S524). The SOAP server 42 transmits to the service server 30 a controlled device registration completion notification <R-7> containing the ServiceID, the control device and service management ID, and the controlled device registration password, stored on the storage unit 41 (FIG. 5: step S525). The SOAP server 42 deletes the controlled device registration password on the storage unit 41 ((FIG. 5: step S526), thereby ending the process. Upon receiving the controlled device registration completion notification <R-7> from the SOAP server 42 ((FIG. 4: step S410), the service server 30 notifies the cellular phone 10 of the completion of the registration of the controlled device ((FIG. 4: step S411). Methods of the service server 30 notifying the cellular phone 10 of the completion of the registration of the controlled device may include an electronic mail, or an application prepared to perform communication with the cellular phone 10.

Upon receiving the number of currently linked services as the controlled device registration response <R-6R> from the SOAP server 42 (FIG. 6: step S610), the DVR 20 sets an automatic connection flag to on ((FIG. 6: step S611), and displays a message indicating that the registration of the controlled device has been completed (FIG. 6: step S612). The DVR 20 deletes the controlled device registration password from the storage unit 21 ((FIG. 6: step S613). To establish a stay-connected session with the XMPP server 43 in the direct access management server 40, the DVR 20 transmits to the SOAP server 42 in the direct access management server 40 an XMPP login information acquisition request <D-0-1> containing the device authentication continuation ID ((FIG. 6: step S614).

[2. XMPP Login of Controlled Device]

The network system includes the XMPP server 43 in the direct access management server 40 to set the two-way stay-connected session with the controlled device. For the cellular phone 10 as the control device to access the DVR 20 as the controlled device via a network, the DVR 20 establishes the stay-connected session with the XMPP server 43 by logging in with the XMPP server 43. One of the service server 30 and the cellular phone 10 can acquire required information from the DVR 20 as necessary. To simplify the design of the service server 30, an XMPP protocol is hidden in the direct access management server 40 so that only an SOAP interface can exchange information with the XMPP server 43 having established the two-way stay-connected session with the DVR 20.

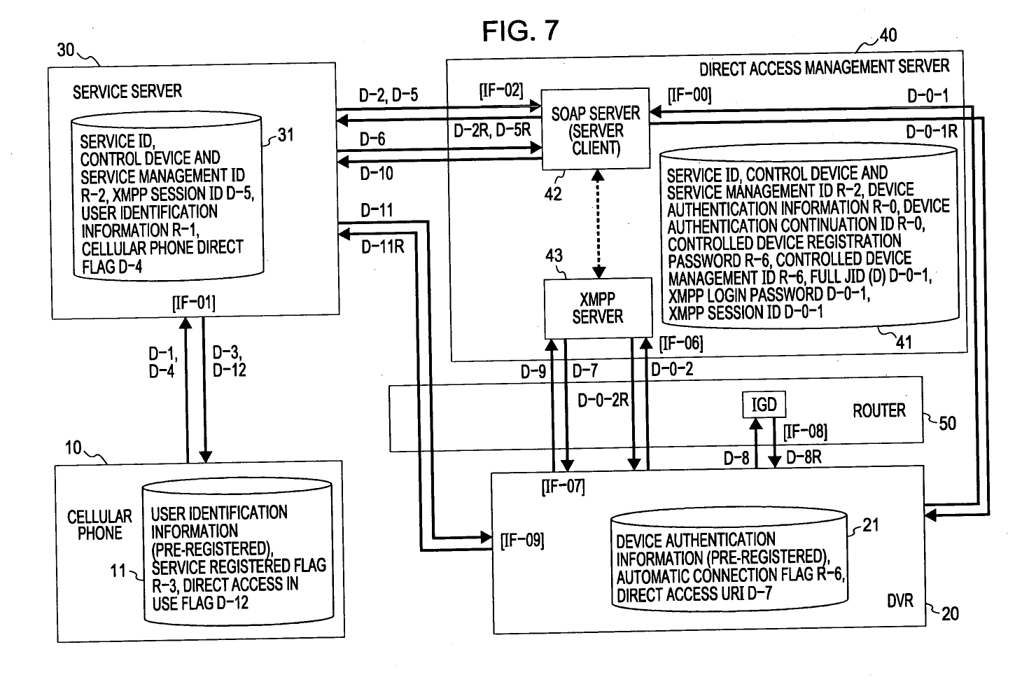

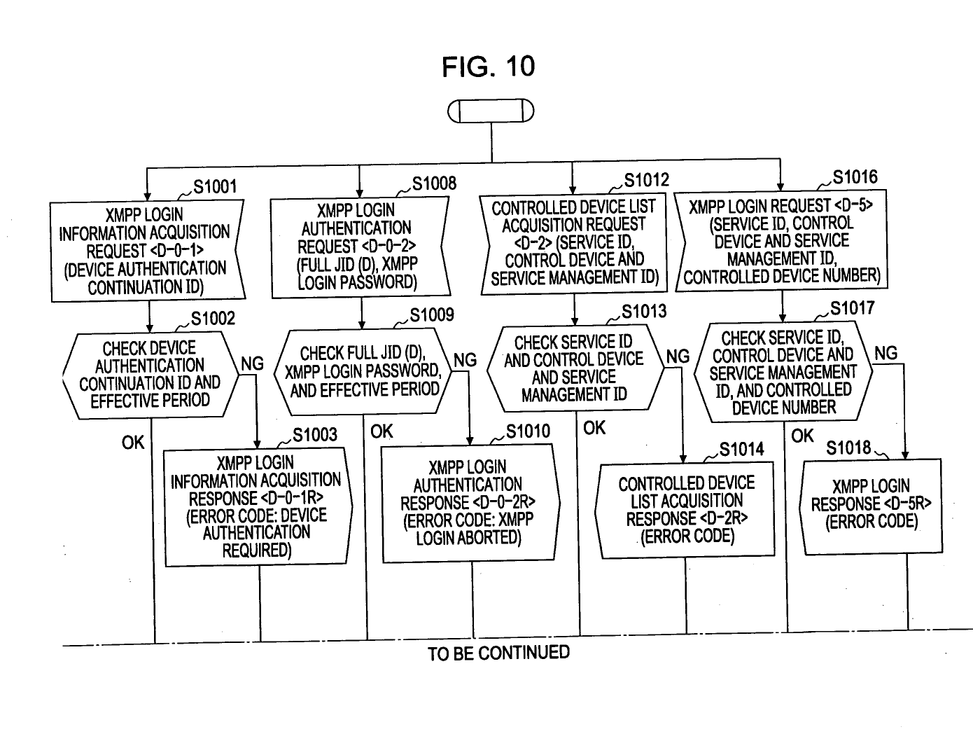

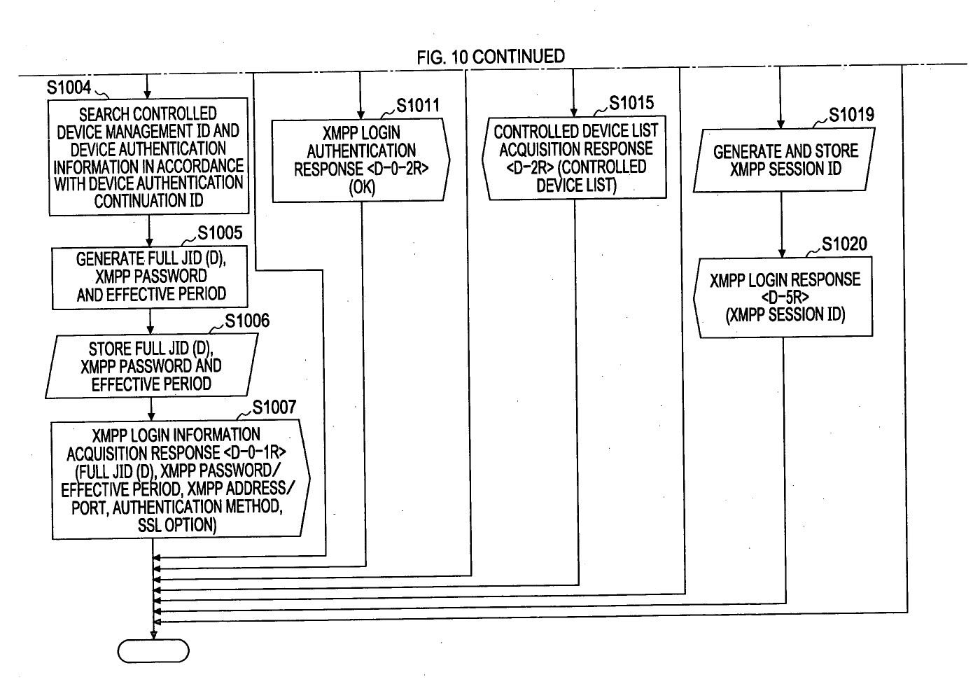

FIG. 7 is a sequence chart partially showing a flow of information in the XMPP login of the controlled device and FIG. 10 is a flowchart partially showing the XMPP login of the controlled device performed by the direct access management server 40.

As shown, upon receiving the XMPP login information acquisition request <D-0-1> containing the device authentication continuation ID from the DVR 20 (FIG. 10: step S1001), the direct access management server 40 checks the device authentication continuation ID and the effective period of the device authentication continuation ID, contained in the XMPP login information acquisition request <D-0-1> (FIG. 10: step S1002). If the device authentication continuation ID contained in the XMPP login information acquisition request <D-0-1> fails to match the one stored on the storage unit 41 in the direct access management server 40, or if the effective period has expired, the DVR 20 may not have been correctly registered in the direct access management server 40 or the effective period of the device authentication continuation ID, even if registered in the past, may have expired. The direct access management server 40 transmits to the DVR 20 an error code as an XMPP login information acquisition response <D-0-1R> indicating that device authentication is required (FIG. 10: step S1003). If the device authentication continuation ID is stored on the storage unit 41 and if the effective period of the device authentication continuation ID has not expired, the direct access management server 40 searches for the controlled device management ID linked to the device authentication continuation ID and the device authentication information on the storage unit 41 (FIG. 10: step S1004). From the controlled device management ID and the device authentication information, the direct access management server 40 generates FullJID(D) as an XMPP login ID required for the DVR 20 to log in with the SOAP server 42, an XMPP login password, and information relating to an effective period of the XMPP login password (FIG. 10: step S1005), and stores these pieces of information onto the storage unit 41 (FIG. 10: step S1006). The direct access management server 40 adds an XMPP address and port number, information concerning the authentication method, an SSL (Secure Socket Layer) option to the generated FullJID(D), XMPP login password, and information concerning the effective period of the XMPP login password and transmits the resulting added information as an XMPP login information acquisition response <D-0-1R> to the DVR 20 (FIG. 10: step S1007).

Upon receiving the XMPP login information acquisition response <D-0-1R> containing the FullJID(D) and the XMPP login password from the SOAP server 42 in the direct access management server 40 (FIG. 6: step S615), the DVR 20 transmits to the XMPP server 43 in the direct access management server 40 an XMPP login authentication request <D-0-2> containing the FullJID(D) and the XMPP login password (FIG. 6: step S616).

Upon receiving the XMPP login authentication request <D-0-2> from the DVR 20 (FIG. 10: step S1008), the XMPP server 43 in the direct access management server 40 checks the FullJID(D), the XMPP login password and the effective period of the XMPP login password contained in the XMPP login authentication request <D-0-2> ((FIG. 10: step S1009). If FullJID(D) fails to match the one stored on the storage unit 41, if the XMPP login password fails to match the one stored on the storage unit 41, or if the effective period of the XMPP login password has expired, the XMPP server 43 transmits to the DVR 20 an error code as an XMPP login authentication response <D-0-2R> indicating that the XMPP login has failed (FIG. 10: step S1010). All of FullJID(D), the XMPP login password, and the effective period are satisfied, the XMPP server 43 in the direct access management server 40 transmits to the DVR 20 a code as an XMPP login authentication response <D-0-2R> indicating an XMPP login permit (FIG. 10: step S1011).

Upon receiving the error code as the XMPP login authentication response <D-0-2R> indicating an aborted XMPP login from the direct access management server 40 (FIG. 6: step S619), the DVR 20 returns to step S614 to place an acquisition request for the XMPP login information. Since the effective period of the XMPP login password may have expired, an acquisition request process for the XMPP login information is placed. Upon receiving a code as the XMPP login authentication request <D-0-2R> indicating the XMPP login permit from the direct access management server 40 (FIG. 6: step S618), the DVR 20 completes the XMPP login process.

When the DVR 20 has received from the SOAP server 42 in the direct access management server 40 the error code as the XMPP login information acquisition response <D-0-1R> indicating that device authentication is required (FIG. 6: step S617), the DVR 20 itself may not have been correctly registered in the direct access management server 40 or the effective period of the device authentication continuation ID may have expired. For this reason, the DVR 20 transmits to the SOAP server 42 in the direct access management server 40 the device authentication request <R-0> containing the information concerning the authentication method predetermined thereon and the device authentication information in order to register again own device (FIG. 6: step S602).

In the network system, the direct access management server 40 generates the XMPP login ID (FullJID(D)) and the XMPP login password required for the DVR 20 to log in with the XMPP server 43, and then distributes FullJID(D) and the XMPP login password to the DVR 20. The FullJID(D) includes a Bare JID part and a Resource part as shown in FIG. 24. The controlled device management ID assigned to the controlled device is used in the Bare JID part, and a product code and a serial number obtained from the device authentication information are used in the Resource part. As shown in FIG. 25, the control device and service management ID for identifying the combination of the control device and the service may be used in the Resource part.

With the automatic connection flag set to be on in step S611, the DVR 20 starts with the transmission process of the XMPP login information acquisition request <D-0-1> in step S614 in succession to the check of the automatic connection flag in step S601, at a next connection, i.e., when power is switched on again after a power interruption on the DVR 20, or when a session with the XMPP server 43 is re-established after a session interruption. More specifically, at a re-connection, the DVR 20 enters a process of the XMPP login, by skipping the process of device authentication, the acquisition of the controlled device registration password from the cellular phone 10, and the process for the controlled device registration. During the re-connection, the DVR 20 can establish the connection session with the XMPP server 43 by simply performing the XMPP login.

The process of associating the DVR 20 as the device to be controlled by the cellular phone 10 with the cellular phone 10 as the control device is thus completed. A specific process of the cellular phone 10 controlling the DVR 20 with one device in association with the other device is described below.

[3. Remote Preprogrammed Recording Setting]

A remote preprogrammed recording operation to the DVR 20 is described below.

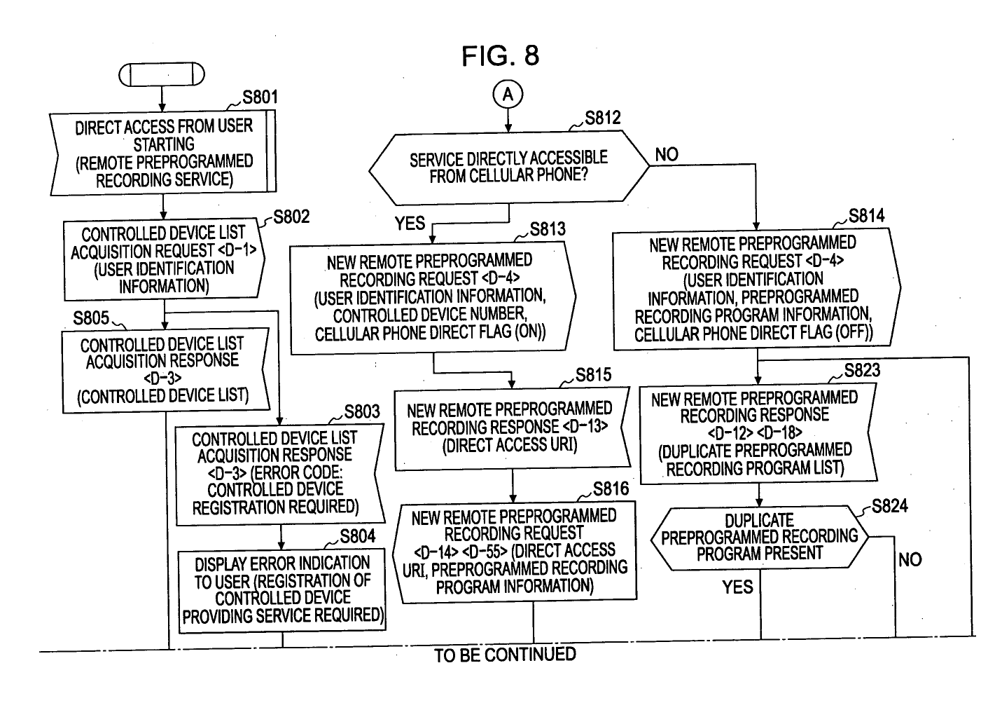

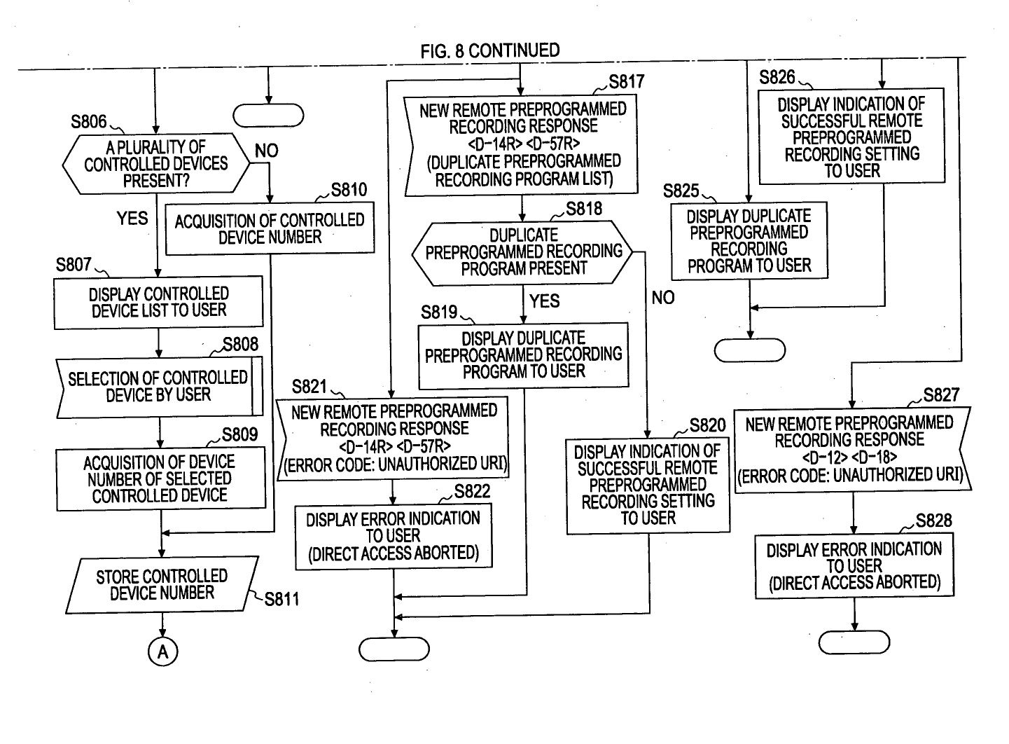

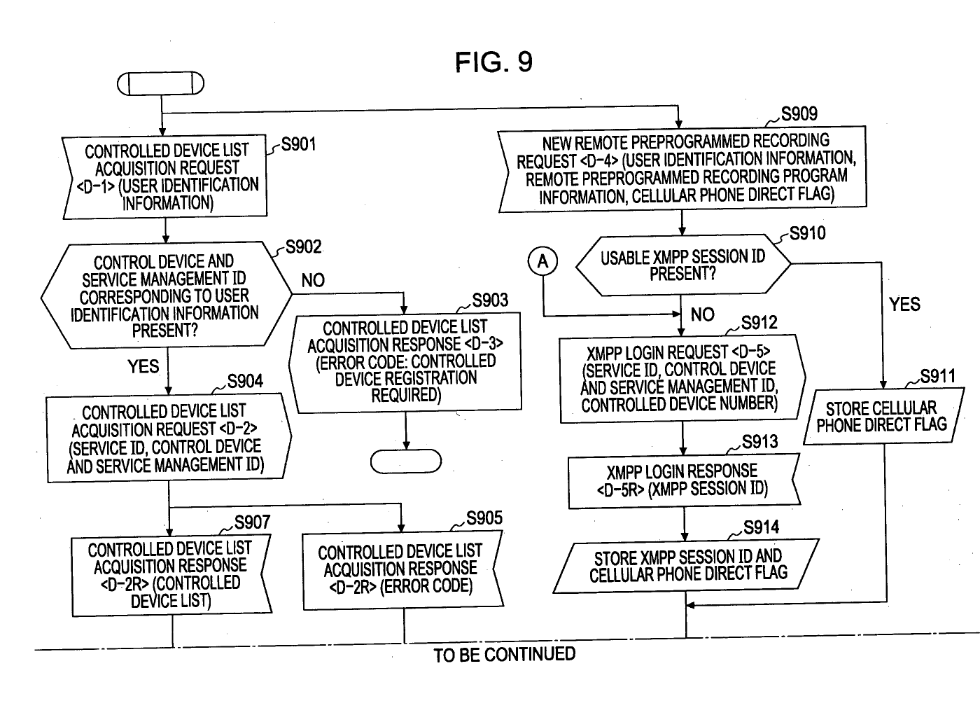

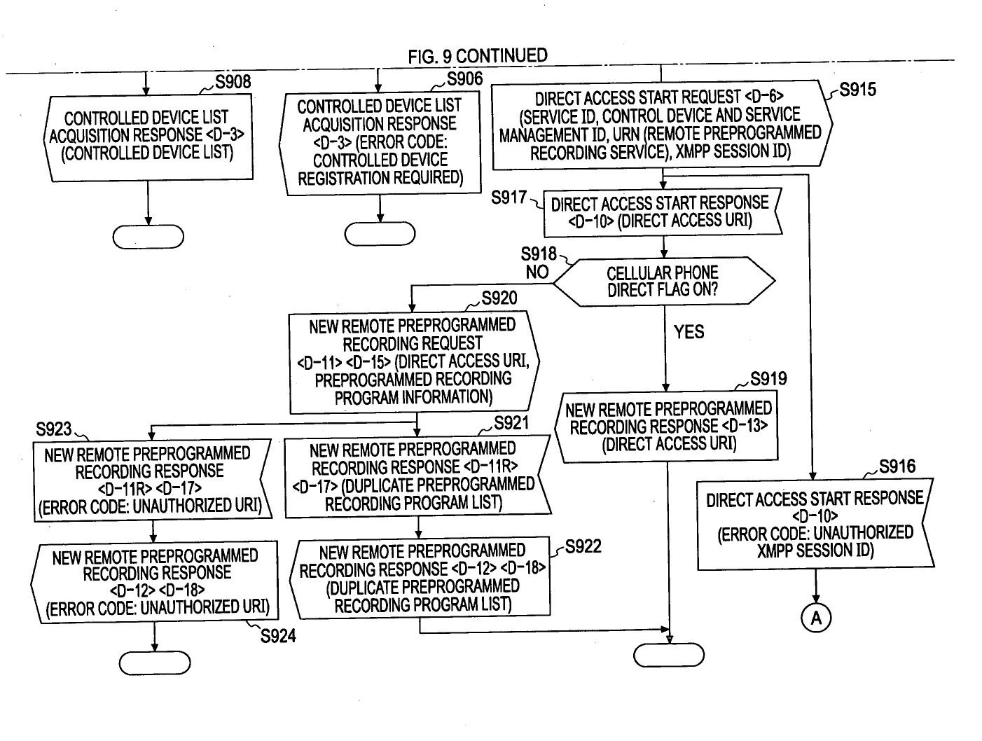

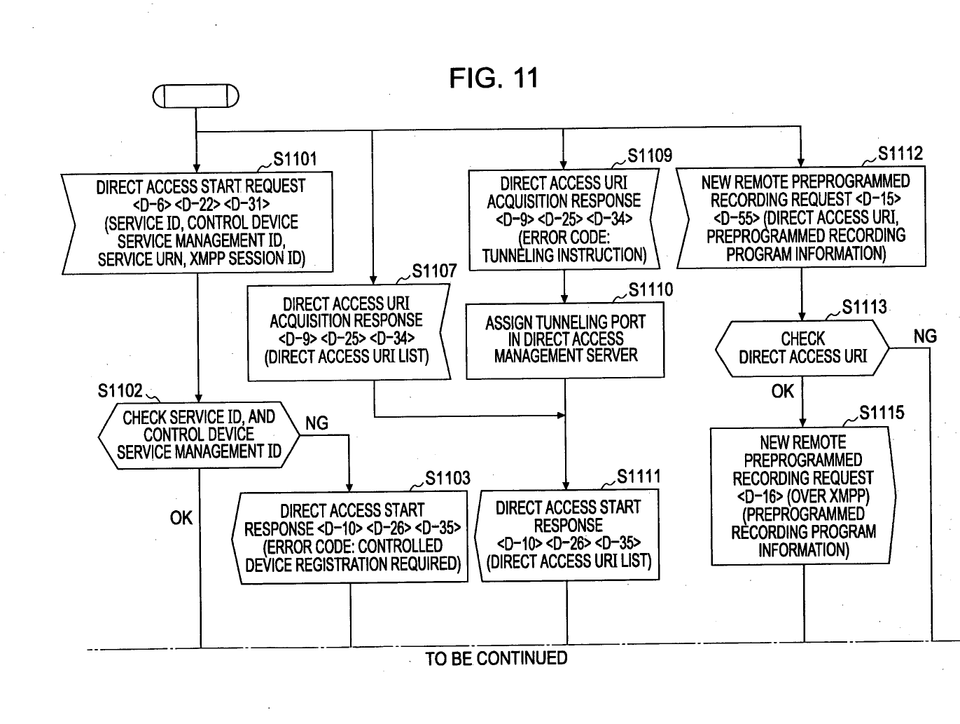

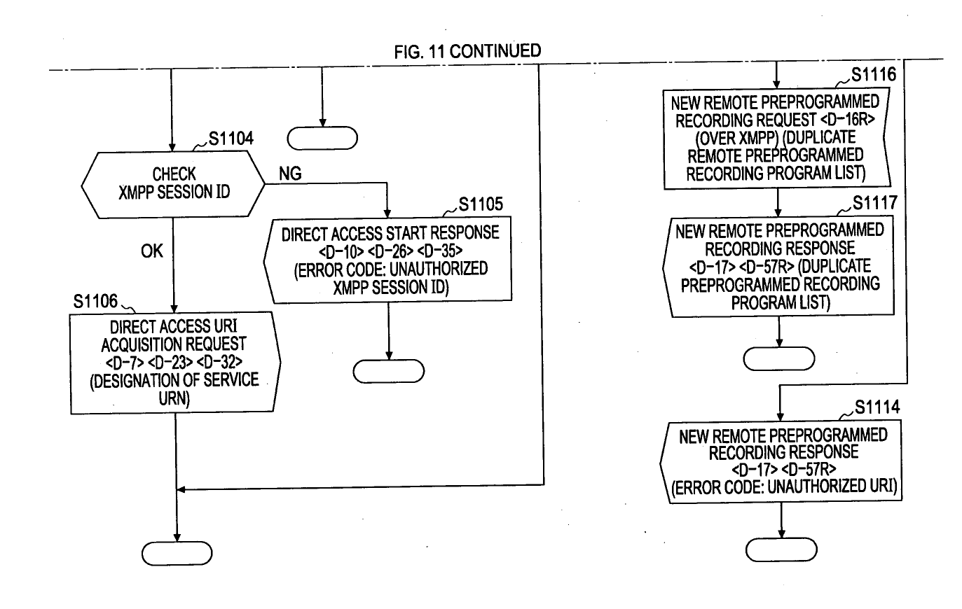

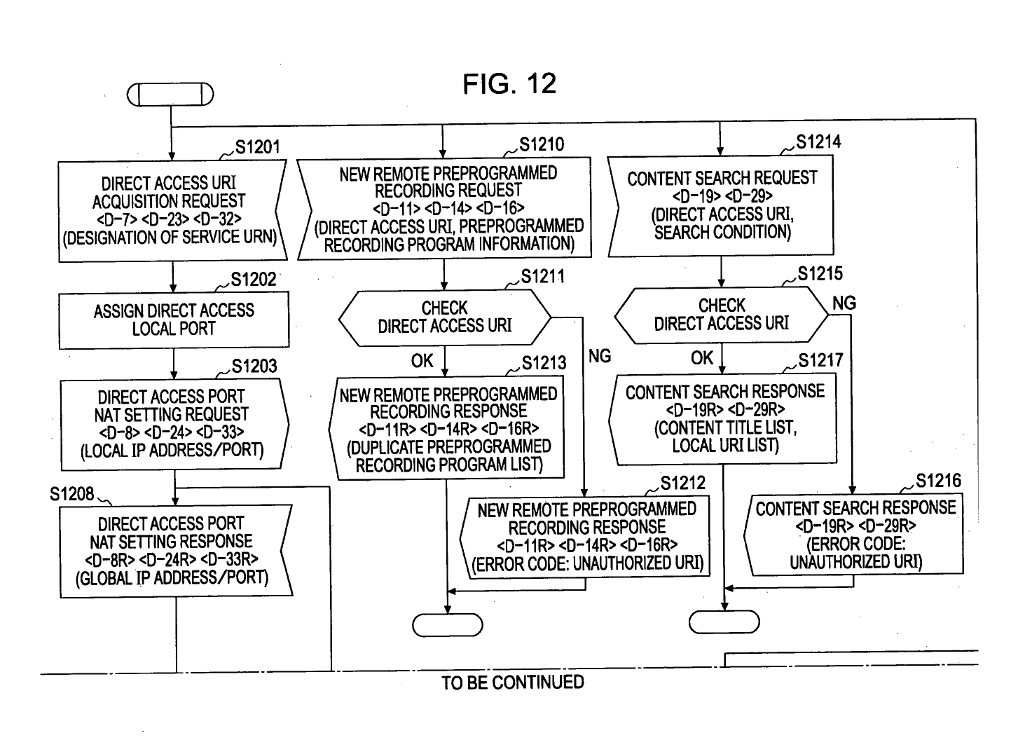

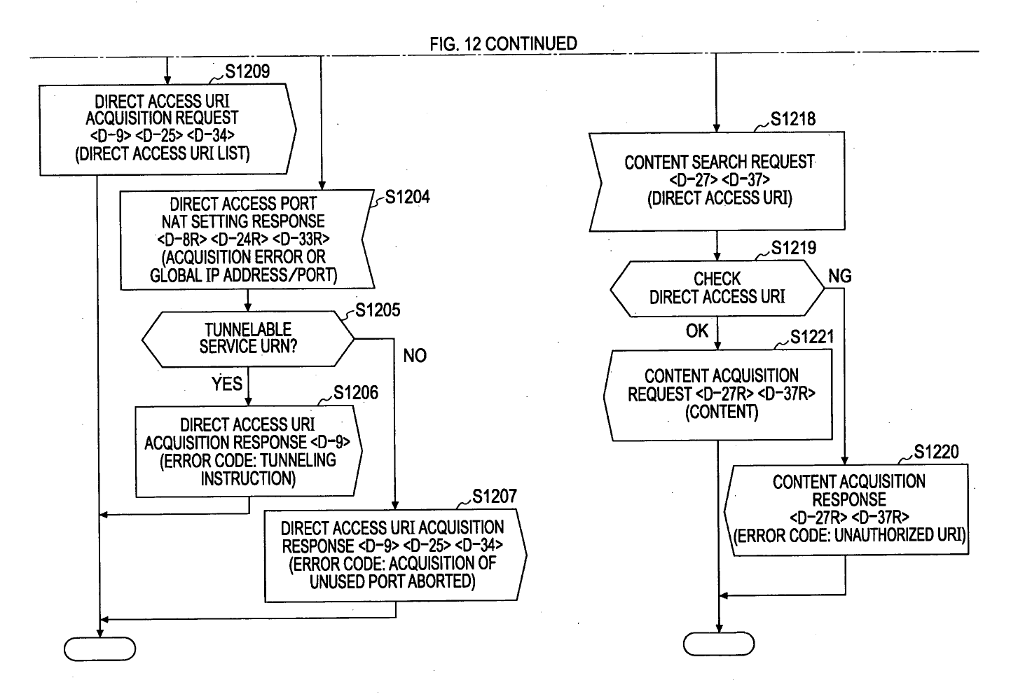

FIG. 7 is partly a sequence chart of a flow of information in the remote preprogrammed recording operation. FIG. 8 is a flowchart illustrating operation of the cellular phone 10 in the remote preprogrammed recording process. FIG. 9 is a flowchart of operation of the service server 30 in the remote preprogrammed recording process. FIGS. 10 and 11 are flowcharts of operation of the direct access management server 40 in the remote preprogrammed recording process and content acquisition process. FIG. 12 is a flowchart of operation of the DVR 20 in the remote preprogrammed recording process and the content acquisition process.

When the user of the cellular phone 10 provides an instruction to start the use of a direct access to the cellular phone 10 to receive a remote preprogrammed recording service (FIG. 8: step S801), the cellular phone 10 transmits to the service server 30 a controlled device list acquisition request <D-1> containing the user identification information preset in the cellular phone 10 (FIG. 8: step S802).

Upon receiving the controlled device list acquisition request <D-1> from the cellular phone 10, the service server 30 determines whether the control device and service management ID corresponding to the user identification information contained in the controlled device list acquisition request <D-1> is stored on the storage unit 31 (FIG. 9: step S902). If the control device and service management ID corresponding to the user identification information is not stored on the storage unit 31, the service server 30 transmits to the cellular phone 10 an error code as a controlled device list acquisition response <D-3> indicating that the controlled device needs to be registered (FIG. 9: step S903). If the control device and service management ID corresponding to the user identification information is stored on the storage unit 31, the service server 30 acquires a list of controlled devices associated with the control device and service management IDs managed by the direct access management server 40. To this end, the service server 30 transmits to the direct access management server 40 a controlled device list acquisition request <D-2> containing the ServiceID identifying service and the control device and service management ID (FIG. 9: step S904).

Upon receiving the controlled device list acquisition request <D-2> from the service server 30 (FIG. 10: step S1012), the direct access management server 40 determines whether a combination of the ServiceID and the control device and service management ID contained in the controlled device list acquisition request <D-2> is stored on the storage unit 41 (FIG. 10: step S1013). If the combination of the ServiceID and the control device and service management ID is not stored on the storage unit 41, the direct access management server 40 transmits to the service server 30 an error code as a controlled device list acquisition response <D-2R> indicating that the controlled device is unregistered (FIG. 10: step S1014). Upon receiving the error code as the controlled device list acquisition response <D-2R> indicating that the controlled device is unregistered from the direct access management server 40 (FIG. 9: step S905), the service server 30 transmits to the cellular phone 10 an error code as a controlled device list acquisition response <D-3> indicating that the controlled device needs to be registered (FIG. 9: step S906). Upon receiving the error code as the controlled device list acquisition response <D-3> from the service server 30 (FIG. 8: step S803), the cellular phone 10 displays an error message on a display to the user prompting the user to register the target controlled device (FIG. 8: step S804).

If the determination in step S1013 shows that the ServiceID and the control device and service management ID contained in the controlled device list acquisition request <D-2> are stored on the storage unit 41, the direct access management server 40 generates the controlled device list. The controlled device list includes a number re-assigned to the controlled device management ID of a controlled device controllable from the cellular phone 10 and a device name contained in the device authentication information of the controlled device. The number is re-assigned to the controlled device in accordance with the linking content between the control device and service management ID and the controlled device management ID stored on the storage unit 41. The direct access management server 40 stores the controlled device list with the control device and service management ID associated therewith on the storage unit 41, and transmits to the service server 30 a controlled device list acquisition response <D-2R> containing the controlled device list (FIG. 10: step S1015). Upon receiving the controlled device list acquisition response <D-2R> containing the controlled device list from the direct access management server 40 (FIG. 9: step S907), the service server 30 transmits a controlled device list acquisition response <D-3> containing the controlled device list to the cellular phone 10 (FIG. 9: step S908).

The cellular phone 10 receives the controlled device list acquisition response <D-3> containing the controlled device list (FIG. 8: step S805), and then determines whether a plurality of controlled device numbers is present in the controlled device list (FIG. 8: step S806). If there is a plurality of controlled device numbers, the cellular phone 10 displays the content of the controlled device list on the display (FIG. 8: step S807), prompts the user to select one from the controlled device numbers (FIG. 8: step S808), and stores the selected controlled device number on the storage unit 11 (FIG. 8: steps S809 and S811). If there is no plurality of controlled device numbers, the cellular phone 10 stores the single controlled device number on the storage unit 11 (FIG. 8: steps S810 and S811).

The cellular phone 10 has one of two options to go ahead depending on whether or not the service (remote preprogrammed recording) to be used is accessible from the cellular phone 10 to the controlled device (FIG. 8: step S812). If the user uses a service direct accessible from the cellular phone 10, the cellular phone 10 transmits to the service server 30 a new remote preprogrammed recording request <D-4> containing the user identification information, the controlled device number, and cellular phone direct flag (on) stored on the storage unit 11 (FIG. 8: step S813). The flag of the cellular phone direct flag is set to be on when the service direct accessible from the cellular phone 10 is used, and set to be off when a service direct inaccessible from the cellular phone 10 is used. When the service direct inaccessible from the cellular phone 10 is used, the cellular phone 10 transmits to the service server 30 a new remote preprogrammed recording request <D-4> containing the user identification information, preprogrammed recording program information, the controlled device number, and the cellular phone direct flag (off) (FIG. 8: step S814). The preprogrammed recording program information includes information concerning a preprogrammed recording start time, length of a program to be recorded, type of broadcast, channel, a forced preprogrammed flag, for example.

The service server 30 receives the new remote preprogrammed recording request <D-4> from the cellular phone 10 (FIG. 9: step S909), and determines whether a usable XMPP session ID is stored on the storage unit 31 (FIG. 9: step S910). The XMPP session ID identifies a connection session established with the XMPP server 43 linked to the user identification information of the cellular phone 10 contained in the new remote preprogrammed recording request <D-4>. If the usable XMPP session ID is not stored on the storage unit 31, the service server 30 transmits to the direct access management server 40 an XMPP login request <D-5> containing the ServiceID, the control device and service management ID, and the controlled device number to establish the XMPP session with the XMPP server 43 (FIG. 9: step S912).

Upon receiving the XMPP login request <D-5> from the service server 30 (FIG. 10: step S1016), the direct access management server 40 determines whether a combination of the ServiceID, the control device and service management ID, and the controlled device number contained in the XMPP login request <D-5> is stored on the storage unit 41 (FIG. 10: step S1017). If the combination is not stored on the storage unit 41, the direct access management server 40 transmits to the service server 30 an error code as an XMPP login response <D-5R> indicating that the target controlled device is not present (FIG. 10: step S1018). The process of the direct access management server 40 is thus completed. If the target controlled device is stored on the storage unit 41, the direct access management server 40 generates an XMPP session ID and stores the generated XMPP session ID with the ServiceID, the control device and service management ID and the controlled device number associated therewith on the storage unit 41 (FIG. 10: step S1019). The direct access management server 40 transmits to the service server 30 an XMPP login response <D-5R> containing the XMPP session ID (FIG. 10: step S1020).

The service server 30 receives the XMPP login response <D-5R> containing the XMPP session ID from the direct access management server 40 (FIG. 9: step S913). The service server 30 then stores the XMPP session ID contained in the XMPP login response <D-5R> and the value of the cellular phone direct flag contained in the new remote preprogrammed recording request <D-4> in step S909 with the ServiceID, the control device and service management ID, and the controlled device list associated therewith on the storage unit 31 (FIG. 9: step S914).

If the determination result of the service server 30 in step S910 shows that the usable XMPP session ID is stored on the storage unit 31, the service server 30 stores the value of the cellular phone direct flag contained in the new remote preprogrammed recording request <D-4> with the ServiceID, the control device and service management ID and the controlled device number associated therewith on the storage unit 31 (FIG. 9: step S911).

Subsequent to step S911 or subsequent to the storage of the cellular phone direct flag in step S914, the service server 30 transmits to the direct access management server 40 a direct access start request <D-6> containing the ServiceID, the control device and service management ID, a service URN (Uniform Resource Name), and the XMPP session ID (FIG. 9: step S915). The service URN is information specifying one service (application) the controlled device can provide. The cellular phone 10 performs here a remote preprogrammed recording operation on the DVR 20 and service URN is information specifying a remote preprogrammed recording service.

The direct access management server 40 receives the direct access start request <D-6> from the service server 30 (FIG. 11: step S1101). The direct access management server 40 determines whether a combination of the ServiceID and the control device and service management ID contained in the direct access start request <D-6> is stored on the storage unit 41 (FIG. 11: step S1102). If the combination is not stored on the storage unit 41, the direct access management server 40 transmits to the service server 30 an error code as a direct access start response <D-10> indicating that the controlled device needs to be registered (FIG. 11: step S1103). If the combination of the ServiceID and the control device and service management ID contained in the direct access start request <D-6> is stored on the storage unit 41, the direct access management server 40 determines whether the XMPP session ID contained in the direct access start request <D-6> is stored in association with the combination of the ServiceID and the control device and service management ID contained in the direct access start request <D-6> on the storage unit 41 (FIG. 11: step S1104). If the XMPP session ID is not stored in association with the combination on the storage unit 41, the direct access management server 40 transmits to the service server 30 an error code as a direct access start response <D-10> indicating that the XMPP session ID is unauthorized (FIG. 11: step S1105). Upon receiving the error code as a direct access start response <D-10> indicating that the XMPP session ID is unauthorized (FIG. 9: step S916), the service server 30 returns to step S912 and transmits the XMPP login request <D-5> to the direct access management server 40 to establish again the XMPP session.

If it is determined in step S1104 that the XMPP session ID contained in the direct access start request <D-6> is stored in association with the combination of the ServiceID and the control device and service management ID contained in the direct access start request <D-6> on the storage unit 41, the direct access management server 40 transmits a direct access URI acquisition request <D-7> to the DVR 20 as the controlled device using a stay-connected session established between the XMPP server 43 and the DVR 20 (FIG. 11: step S1106). The direct access URI acquisition request <D-7> includes the service URN as information identifying the service specified by the direct access start request <D-6>.

The DVR 20 receives the direct access URI acquisition request <D-7> containing the information designating the service URN from the direct access management server 40 (FIG. 12: step S1201), and assigns a direct access local port (FIG. 12: step S1202). The DVR 20 transmits to the router 50 a direct access port NAT (Network Address Translation) setting request <D-8> containing a local IP address pre-assigned to the DVR 20 and a port number of a direct access local port. The DVR 20 thus requests the router 50 to map a global IP address accessible from the Internet and a port number to the local IP address (FIG. 12: step S1203). To assign a direct access URI, the DVR 20 accesses the router 50 by means of UPnP IGD DCP (Device Control Protocol), and acquires beforehand the global IP address and the port number accessible from the Internet.

In response to the direct access port NAT setting request <D-8> in step S1203, the DVR 20 receives, from the router 50 the local IP address and the port number of the DVR 20 as a NAT setting response <D-8R> (FIG. 12: step S1208). Using the global IP address and the port number, the DVR 20 generates a direct access URI list, and transmits the direct access URI list as a direct access URI acquisition response <D-9> to the direct access management server 40 (FIG. 12: step S1209). The direct access URI list is a URI list of devices to which one of the service server 30 and the cellular phone 10 directly accesses via the network.

Upon receiving the direct access URI list as the direct access URI acquisition response <D-9> (FIG. 11: step S1107), the XMPP server 43 in the direct access management server 40 transmits the direct access URI list as a direct access start response <D-10> to the service server 30 (FIG. 11: step S1111).

Upon receiving an acquisition error of the global IP address and the port number as the direct access port NAT setting response <D-8R> (FIG. 12: step S1204), the DVR 20 determines based on the service URN designating information acquired in step S1201 whether the service URN is tunnelable (FIG. 12: step S1205). A particular service from among services provided is set to be tunnelable beforehand. For example, a service such as a remote preprogrammed recording typically handling data having a relatively small data size is categorized as a tunnelable service. A service such as content acquisition typically handling data having a relatively large data size is categorized as a untunnelable service. If the service URN designating information contained in the direct access URI acquisition request <D-7> is determined to be a new remote preprogrammed recording service, the DVR 20 transmits to the direct access management server 40 an error code requesting tunneling as a direct access URI acquisition response <D-9> (FIG. 12: step S1206). The tunneling may be requested by filling all address in the direct access URI with “0s.”

Upon receiving the error code requesting tunneling as the direct access URI acquisition response <D-9> (FIG. 11: step S1109), the XMPP server 43 in the direct access management server 40 assigns a tunneling port in the direct access management server 40 (FIG. 11: step S1110). The XMPP server 43 generates the direct access URI list using the port number of the assigned tunneling port in the direct access management server 40 and the global IP address of the direct access management server 40. The XMPP server 43 then transmits the a direct access start response <D-10> containing the direct access URI list to the service server 30 (FIG. 11: step S1111). The service server 30 and the cellular phone 10 can access the DVR 20 without being conscious of tunneling.

If the determination in step S1205 shows that the service URN designating information contained in the direct access URI acquisition request <D-7> is an untunnelable service URN, the DVR 20 transmits to the direct access management server 40 an error code indicating an aborted attempt to acquire an unused port as the direct access URI acquisition response <D-9> (FIG. 12: step S1207).

Upon receiving the direct access start response <D-10> containing the direct access URI list from the direct access management server 40 (FIG. 9: step S917), the service server 30 determines whether the cellular phone direct flag is on or off (FIG. 9: step S918). If the cellular phone direct flag is on, the service server 30 transmits to the cellular phone 10 a new remote programmed response <D-13> containing the direct access URI in order for the cellular phone 10 to directly access the device designated by the direct access URI (FIG. 9: step S919). If the cellular phone direct flag is off, the service server 30 transmits to the direct access URI a new remote preprogrammed recording request containing the direct access URI and the preprogrammed recording program information acquired in response to the new remote preprogrammed recording request <D-4> from the cellular phone 10 (FIG. 10: step S920).

Specific examples of the preprogrammed recording request performed by the cellular phone 10 to the DVR 20 are described below.

[3.1. Remote Preprogrammed Recording Using Proxy Access in the Service Server 30: FIG. 7]

In response to an instruction from the cellular phone 10, the service server 30 by proxy performs a remote preprogrammed recording operation on the DVR 20. The operation is described below. Part of FIG. 7 shows a sequence chart of a flow of information in the remote preprogrammed recording operation the service server 30 performs by proxy on the DVR 20 in response to an instruction from the cellular phone 10.

The processes up to the direct access start response <D-10> in the flow of information performed by the cellular phone 10, the DVR 20, the service server 30, the direct access management server 40 and the router 50 have already been described above.

The service server 30 performs the remote preprogrammed recording operation on the DVR 20 in response to the instruction from the cellular phone 10. This remote preprogrammed recording operation is performed when it is determined in step S918 that the cellular phone direct flag is off, and further the URI transmitted in the direct access URI acquisition response <D-9> in step S1209 by the DVR 20 is contained in the direct access start response <D-10> received in step S917 by the service server 30. Since the service server 30 simply accesses the direct access URI received in the direct access start response <D-10> as previously discussed, it is not necessary to determine whether the direct access URI supports the DVR 20 or the tunneling of the direct access management server 40.

The service server 30 accesses the address of the DVR 20 contained in the direct access URI received as the direct access start response <D-10> in step S917, and transmits a new remote preprogrammed recording request <D-11> containing the remote preprogrammed recording program information acquired in response to the new remote preprogrammed recording request <D-4> from the cellular phone 10 (FIG. 9: step S920).

Upon receiving the new remote preprogrammed recording request <D-11> from the service server 30 (FIG. 12: step S1210), the DVR 20 checks authenticity of the direct access URI contained in the new remote preprogrammed recording request <D-11> (FIG. 12: step S1211). If the direct access URI is unauthorized, the DVR 20 transmits to the service server 30 an error code as a new remote preprogrammed recording response <D-11R> indicating an unauthorized direct access URI (FIG. 12: step S1212). The authenticity of the direct access URI is checked by adding a difficult to repeat random number to the direct access URI at the issuance thereof and then checking whether the random number is contained in the direct access URI of the new remote preprogrammed recording request <D-11>. If the URI is authorized, the DVR 20 determines based on the remote preprogrammed recording program information whether the preprogrammed recording requested from the service server 30 is duplicated in the scheduled preprogrammed recording and preprogrammed date and time. If there is no duplication in the preprogrammed recording, the DVR 20 programs recording based on the preprogrammed recording program information, and then produces duplicate preprogrammed recording list without duplicated programming. If duplicate preprogrammed recording is found, the DVR 20 produces a duplicate preprogrammed recording program list including recording date and time, channel, and program title of a duplicate preprogrammed recording program. The DVR 20 then transmits to the service server 30 a new remote preprogrammed recording response <D-11R> containing the duplicate preprogrammed recording program list (FIG. 12: step S1213).

Upon receiving the new remote preprogrammed recording response <D-11R> (FIG. 9: step S921), the service server 30 transmits to the cellular phone 10 the duplicate preprogrammed recording program list of the new remote preprogrammed recording response <D-11R> as a new remote preprogrammed recording response <D-12> (FIG. 9: step S922). Upon receiving the error code of the unauthorized URI as the new remote preprogrammed recording response <D-11R> (FIG. 9: step S923), the service server 30 transmits that error code as a new remote preprogrammed recording response <D-12> to the cellular phone 10 (FIG. 9: step S924).

Upon receiving the new remote preprogrammed recording response <D-12> containing the duplicate preprogrammed recording program list from the service server 30 (FIG. 8: step S823, the cellular phone 10 determines from the duplicate preprogrammed recording program list whether a duplicate program is present (FIG. 8: step S824). If a duplicate program is present, the cellular phone 10 displays the duplicate program on a display unit to the user (FIG. 8: step S825). If no duplicate program is present, the cellular phone 10 displays a message on the display unit to the user indicating a successful setting of the remote preprogrammed recording (FIG. 8: step S826).

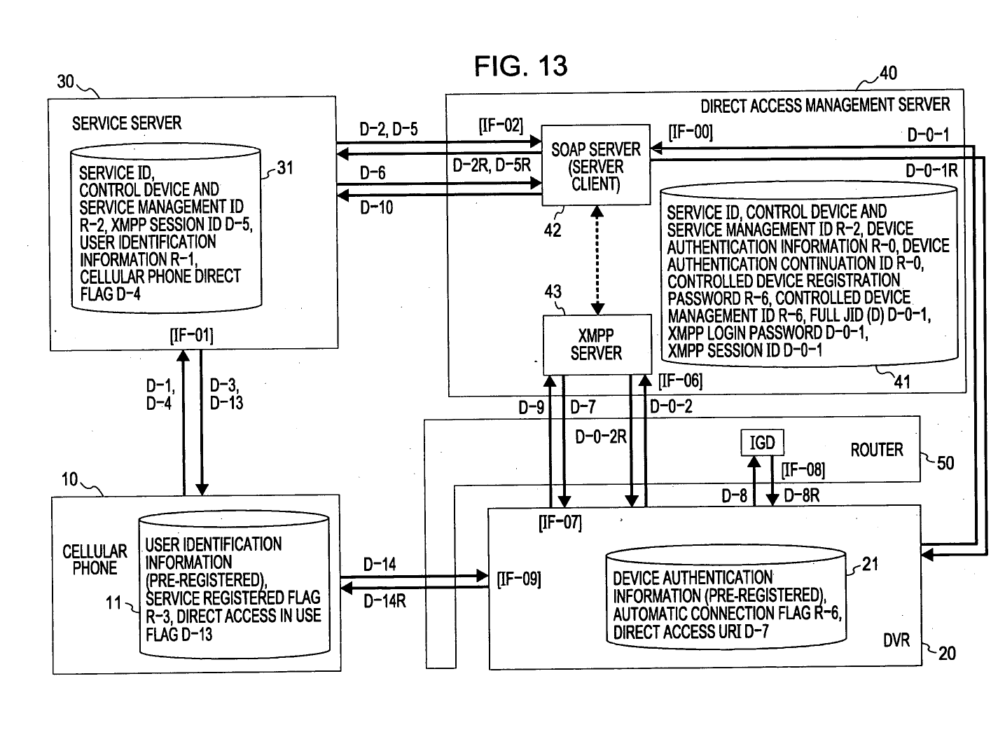

Upon receiving the error code of the unauthorized URI as the new remote preprogrammed recording response <D-12> from the service server 30 (FIG. 8: step S827), the cellular phone 10 displays an error message on the display to the user indicating an aborted direct access (FIG. 8: step S828).

[3.2. Remote Preprogrammed Recording Directly from the Cellular Phone 10: FIG. 13]

The remote preprogrammed recording setting operation of the cellular phone 10 to the DVR 20 without using the service server 30 is described below. FIG. 13 is a sequence chart of a flow of information in the remote preprogrammed recording setting operation the cellular phone 10 directly performs on the DVR 20.

The flow of information up to the direct access start response <D-10> performed by the cellular phone 10, the DVR 20, the service server 30, the direct access management server 40 and the router 50 shown in FIG. 13 remains unchanged from the one shown in FIG. 7, and the discussion thereof is omitted.

The cellular phone 10 directly performs the remote preprogrammed recording setting operation on the DVR 20. This operation is performed when it is determined in step S918 that the cellular phone direct flag is on, and when the URI transmitted as the direct access URI acquisition response <D-9> in step S1209 by the DVR 20 is contained in the new remote preprogrammed recording response <D-13> transmitted from the service server 30 to the cellular phone 10 in step S919. Since the service server 30 simply accesses the direct access URI received in the new remote preprogrammed recording response <D-13> as previously discussed, it is not necessary to determine whether the direct access URI supports the DVR 20 or the tunneling of the direct access management server 40.

The cellular phone 10 receives the new remote preprogrammed recording response <D-13> containing the direct access URI from the service server 30 (FIG. 8: step S815). The cellular phone 10 accesses the address of the DVR 20 contained in the direct access URI, thereby transmitting to the DVR 20 a new remote preprogrammed recording request <D-14> containing the direct access URI and the preprogrammed recording program information (FIG. 8: step S816).

Upon receiving the new remote preprogrammed recording request <D-14> from the cellular phone 10 (FIG. 12: step S1210), the DVR 20 checks authenticity of the direct access URI contained in the new remote preprogrammed recording request <D-14> (FIG. 12: step S1211). If the direct access URI is unauthorized, the DVR 20 transmits to the cellular phone 10 an error code indicating the unauthorized direct access URI as a new remote preprogrammed recording response <D-14R> (FIG. 12: step S1212). The authenticity of the direct access URI is checked by adding a difficult to repeat random number to the direct access URI at the issuance thereof and then checking whether the random number is contained in the direct access URI of the new remote preprogrammed recording request <D-14>. If the URI is authorized, the DVR 20 determines based on the remote preprogrammed recording program information whether the preprogrammed recording requested from the cellular phone 10 is duplicated in the scheduled preprogrammed recording and preprogrammed date and time. If there is no duplication in the preprogrammed recording, the DVR 20 programs recording based on the preprogrammed recording program information, and then produces a duplicate preprogrammed recording list without duplicated programming. If duplicate preprogrammed recording is found, the DVR 20 produces a duplicate preprogrammed recording program list including recording date and time, channel, and program title of a duplicate preprogrammed recording program. The DVR 20 then transmits to the cellular phone 10 a new remote preprogrammed recording response <D-14R> containing the duplicate preprogrammed recording program list (FIG. 12: step S1213).

Upon receiving the new remote preprogrammed recording response <D-14R> (FIG. 8: step S817), the cellular phone 10 determines whether a duplicate preprogrammed recording program is present in the duplicate preprogrammed recording program list (FIG. 8: step S818). If a duplicate preprogrammed recording program is present, the cellular phone 10 displays information of the duplicate preprogrammed recording program on the display unit to the user (FIG. 8: step S819). If no duplicate preprogrammed recording program is present, the cellular phone 10 displays on the display unit to the user a message indicating a successful remote preprogrammed recording setting (FIG. 8: step S820).

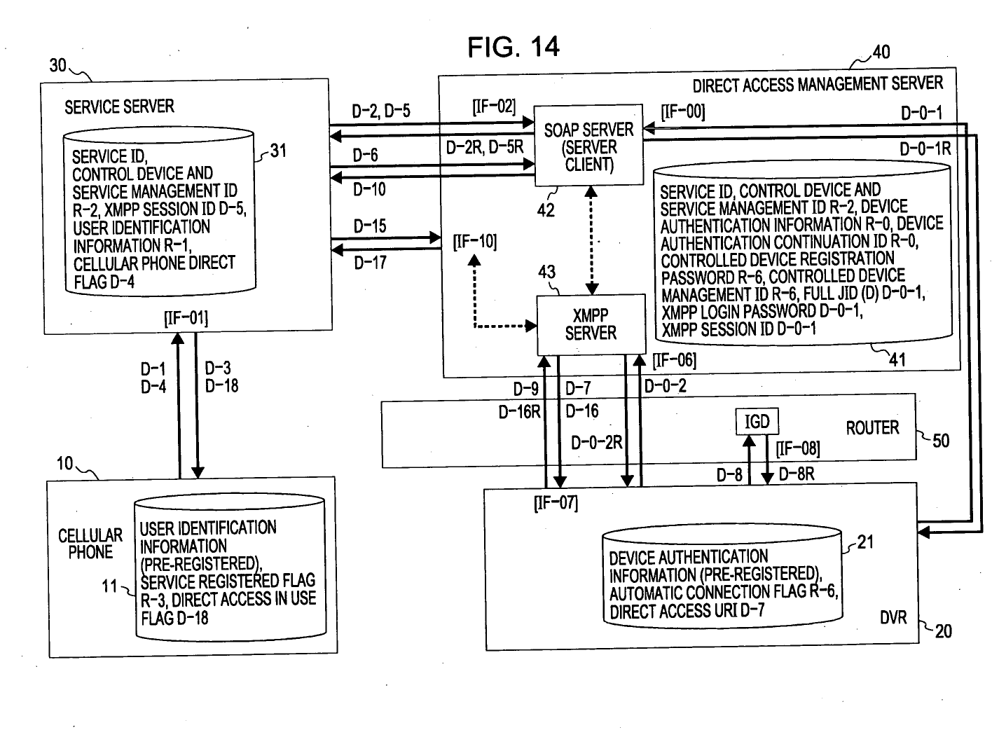

Upon receiving the error code of the unauthorized URI as the new remote preprogrammed recording response <D-14R> (FIG. 8: step S821), the cellular phone 10 displays a message indicating an aborted direct access on the display unit to the user (FIG. 8: step S822).

[3.3. Remote Preprogrammed Recording Setting using Tunneling from the Service Server 30: FIG. 14]

In response to an instruction from the cellular phone 10, the service server 30 performs the remote preprogrammed recording setting operation to the DVR 20 using tunneling of the XMPP server 43 in the direct access management server 40. The remote preprogrammed recording setting operation of the service server 30 is described below. FIG. 14 is a sequence chart of a flow of information in the remote preprogrammed recording setting operation the service server 30 performs on the DVR 20 using the tunneling of the XMPP server 43 in response to the instruction from the cellular phone 10.

The flow of information up to the direct access start response <D-10> performed by the cellular phone 10, the DVR 20, the service server 30, the direct access management server 40 and the router 50 shown in FIG. 14 remains unchanged from the one shown in FIG. 7, and the discussion thereof is omitted herein.

In response to the instruction from the cellular phone 10, the service server 30 performs the remote preprogrammed recording setting operation to the DVR 20 using tunneling of the XMPP server 43. This operation is performed when it is determined in step S918 that the cellular phone direct flag is off and further when the URI for tunneling assigned in step S1110 by the direct access management server 40 is contained in the direct access start response <D-10> received in step S917 by the service server 30. Since the service server 30 simply accesses the direct access URI received in the direct access start response <D-10> as previously discussed, it is not necessary to determine whether the direct access URI supports the DVR 20 or the tunneling of the direct access management server 40.

The service server 30 accesses the address of the direct access management server 40 contained in the direct access URI received as the direct access start response <D-10> in step S917. The service server 30 then transmits to the direct access management server 40 a new remote preprogrammed recording request <D-15> containing the direct access URI and the preprogrammed recording program information acquired from the new remote preprogrammed recording request <D-4> from the cellular phone 10 (FIG. 9: step S920).

The direct access management server 40 receives the new remote preprogrammed recording request <D-15> containing the direct access URI and the preprogrammed recording program information (FIG. 11: step S1112). The direct access management server 40 checks the direct access URI contained in the new remote preprogrammed recording request <D-15> (FIG. 11: step S1113). If the direct access URI is unauthorized, the direct access management server 40 transmits to the service server 30 an error code indicating the unauthorized URI as a new remote preprogrammed recording response <D-17> (FIG. 11: step S1114). If the direct access URI is authorized, the direct access management server 40 transmits a new remote preprogrammed recording request <D-16> containing the preprogrammed recording program information to the DVR 20 via the XMPP server 43 (FIG. 11: step S1115). In this case, all the address part of the direct access URI is filled with “0s” to indicate that the DVR 20 accesses through a tunneling process via the XMPP server 43 in the direct access management server 40.

The DVR 20 receives the new remote preprogrammed recording request <D-16> from the direct access management server 40 (FIG. 12: step S1210). The DVR 20 checks the authenticity of the direct access URI contained in the new remote preprogrammed recording request <D-16> (FIG. 12: step S1211). If the direct access URI is unauthorized, the DVR 20 transmits to the direct access management server 40 an error code indicating the unauthorized URI as a new remote preprogrammed recording response <D-16R> (FIG. 12: step S1212). If the direct access URI is authorized, the DVR 20 transmits to the direct access management server 40 a new remote preprogrammed recording response <D-16R> containing the duplicate preprogrammed recording program list (FIG. 12: step S1213).

The direct access management server 40 receives the new remote preprogrammed recording response <D-16R> containing the duplicate programmed recording program list from the DVR 20 (FIG. 11: step S1116), and then transmit a new remote preprogrammed recording response <D-17> containing the duplicate programmed recording program list (FIG. 11: step S1117).

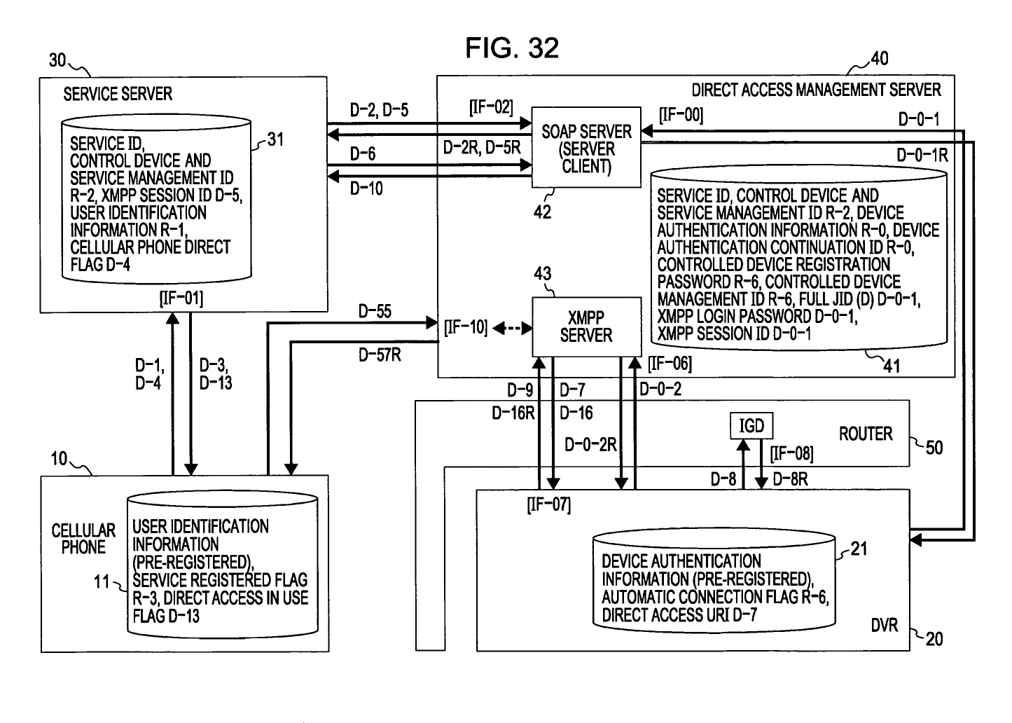

Upon receiving the new remote preprogrammed recording response <D-17> containing the duplicate programmed recording program list (FIG. 9: step S921), the service server 30 transmits to the cellular phone 10 a new remote preprogrammed recording response <D-18> containing the duplicate programmed recording program list (FIG. 9: step S922). Upon receiving the error code as the new remote preprogrammed recording response <D-17> from the direct access management server 40 (FIG. 9: step S923), the service server 30 transmits to the cellular phone 10 the error code as a new remote preprogrammed recording response <D-18> (FIG. 9: step S924). The subsequent operation of each of the service server 30 and the cellular phone 10 remains the same as described above.

[3.4. Remote Preprogrammed Recording Setting Using Tunneling from the Cellular Phone: FIG. 32]

The cellular phone 10 performs the remote preprogrammed recording setting operation to the DVR 20 through the tunneling of the XMPP server 43 in the direct access management server 40 without using the service server 30. The remote preprogrammed recording setting operation of the cellular phone 10 is described below. FIG. 32 is a sequence chart of a flow of information in the remote preprogrammed recording setting operation the cellular phone 10 performs the DVR 20 through the tunneling of the XMPP server 43 in the direct access management server 40 without using the service server 30.

The flow of information up to the direct access start response <D-10> performed by the cellular phone 10, the DVR 20, the service server 30, the direct access management server 40 and the router 50 shown in FIG. 32 remains unchanged from the one shown in FIG. 7, and the discussion thereof is omitted herein.

The cellular phone 10 performs the remote preprogrammed recording setting operation to the DVR 20 using the tunneling of the XMPP server 43 without using the service server 30. The remote preprogrammed recording setting operation of the cellular phone 10 is performed when it is determined in step S918 that cellular phone direct flag is on and when the URI for tunneling assigned in step S1110 by the direct access management server 40 is contained in the new remote preprogrammed recording response <D-13> transmitted in step S919 from the service server 30 to the cellular phone 10. The cellular phone 10 simply accesses the direct access URI received in the new remote preprogrammed recording response <D-13> as previously discussed, it is not necessary to determine whether the direct access URI supports the DVR 20 or the tunneling of the direct access management server 40.

The cellular phone 10 receives the new remote preprogrammed recording response <D-13> containing the direct access URI from the service server 30 (FIG. 8: step S815). The cellular phone 10 accesses the address of the direct access management server 40 contained in the direct access URI and transmits to the direct access management server 40 a new remote preprogrammed recording request <D-55> containing the direct access URI and the preprogrammed recording program information (FIG. 8: step S816).

The direct access management server 40 receives the new remote preprogrammed recording request <D-55> from the cellular phone 10 (FIG. 11: step S1112), and checks the direct access URI contained in the new remote preprogrammed recording request <D-55> (FIG. 11: step S1113). If the direct access URI is unauthorized, the direct access management server 40 transmits to the cellular phone 10 an error code indicating an unauthorized URI as a new remote preprogrammed recording request <D-57R> (FIG. 11: step S1114). If the direct access URI is authorized, the direct access management server 40 transmits to the DVR 20 a new remote preprogrammed recording request <D-16> containing the preprogrammed recording program information via the XMPP server 43 (FIG. 11: step S1115). In this case, all the address part of the direct access URI is filled with “0s” to indicate that the DVR 20 accesses through the tunneling process via the XMPP server 43 in the direct access management server 40.

The DVR 20 receives the new remote preprogrammed recording request <D-16> from the direct access management server 40 (FIG. 12: step S1210), and checks the authenticity of the direct access URI contained in the new remote preprogrammed recording request <D-16> (FIG. 12: step S1211). If the direct access URI is unauthorized, the DVR 20 transmits to the direct access management server 40 an error code indicating an unauthorized direct access URI as a new remote preprogrammed recording response <D-16R> (FIG. 12: step S1212). If the direct access URI is authorized, the DVR 20 transmits to the direct access management server 40 information, containing a duplicate preprogrammed recording program list, as the new remote preprogrammed recording response <D-16R> (FIG. 12: step S1213).

Upon receiving the new remote preprogrammed recording response <D-16R> from the DVR 20 (FIG. 11: step S1116), the direct access management server 40 transmits to the cellular phone 10 a new remote preprogrammed recording response <D-57R> containing the duplicate programmed recording program list (FIG. 11: step S1117). Upon receiving the error code as the new remote preprogrammed recording response <D-16R> from the DVR 20, the direct access management server 40 transmits to the cellular phone 10 the error code as the new remote preprogrammed recording request <D-57R>. The subsequent process of the cellular phone 10 is performed as previously described.

As described above, the cellular phone 10 can perform the preprogrammed recording setting operation using not only the direct access to the DVR 20, but also the proxy access by the service server 30, or the tunneling process of the direct access management server 40 using XMPP.

[4. Content Acquisition]

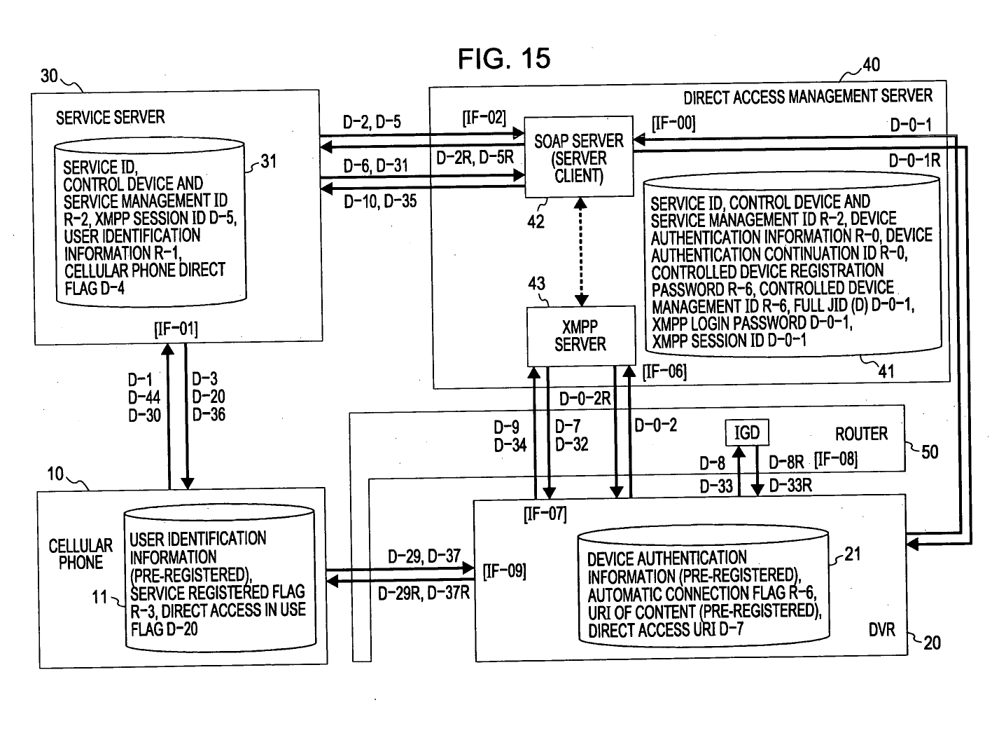

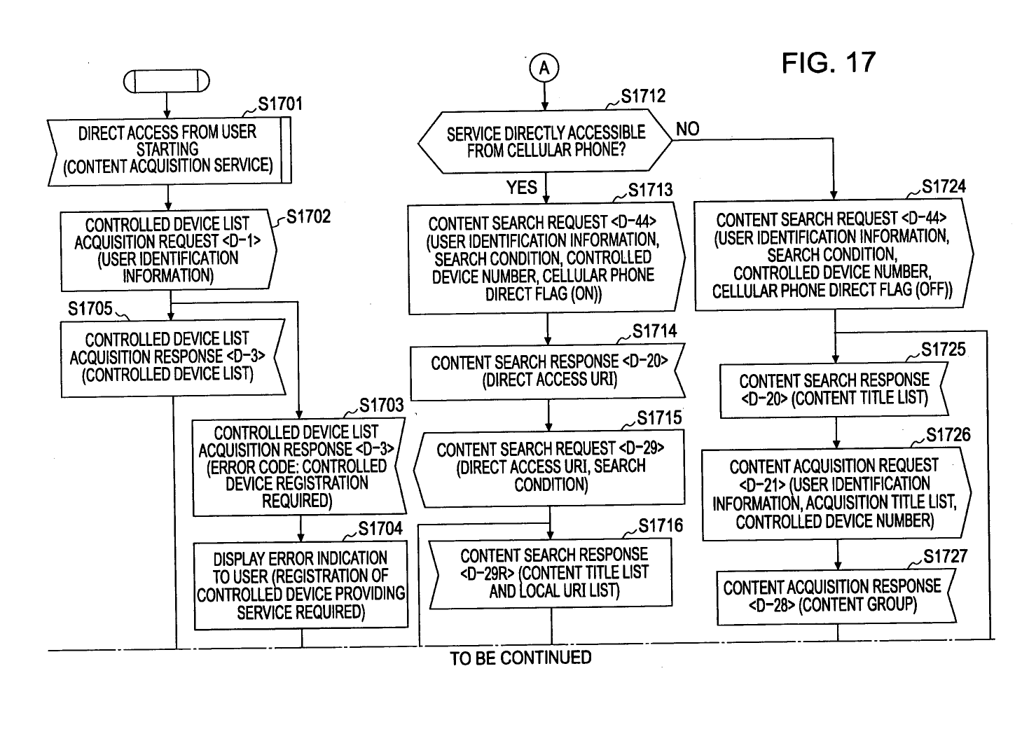

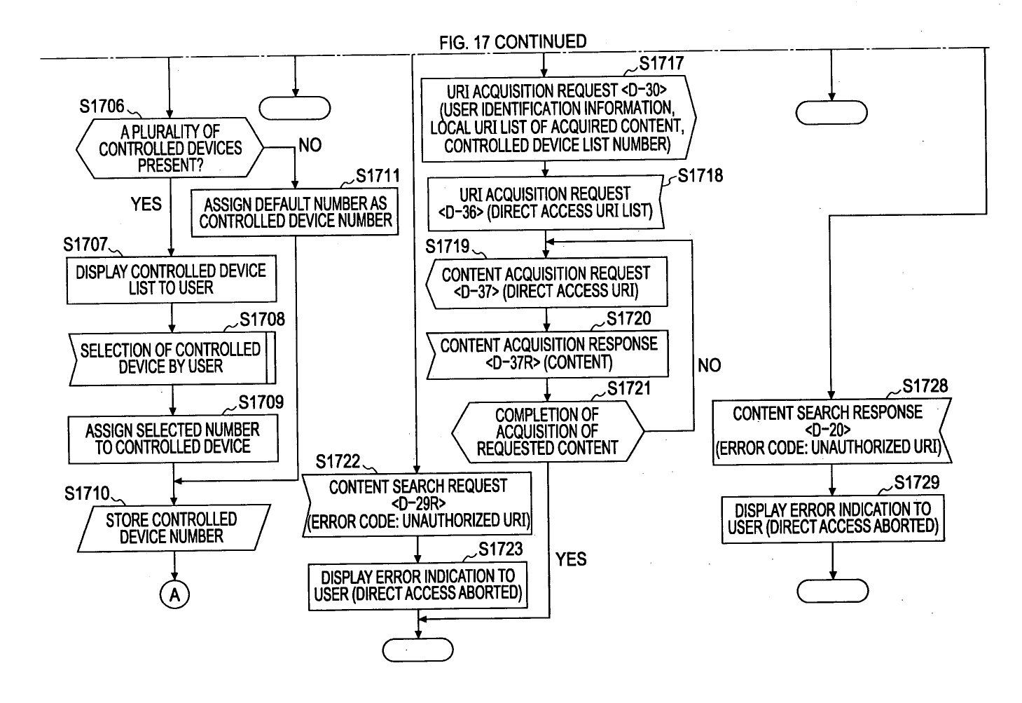

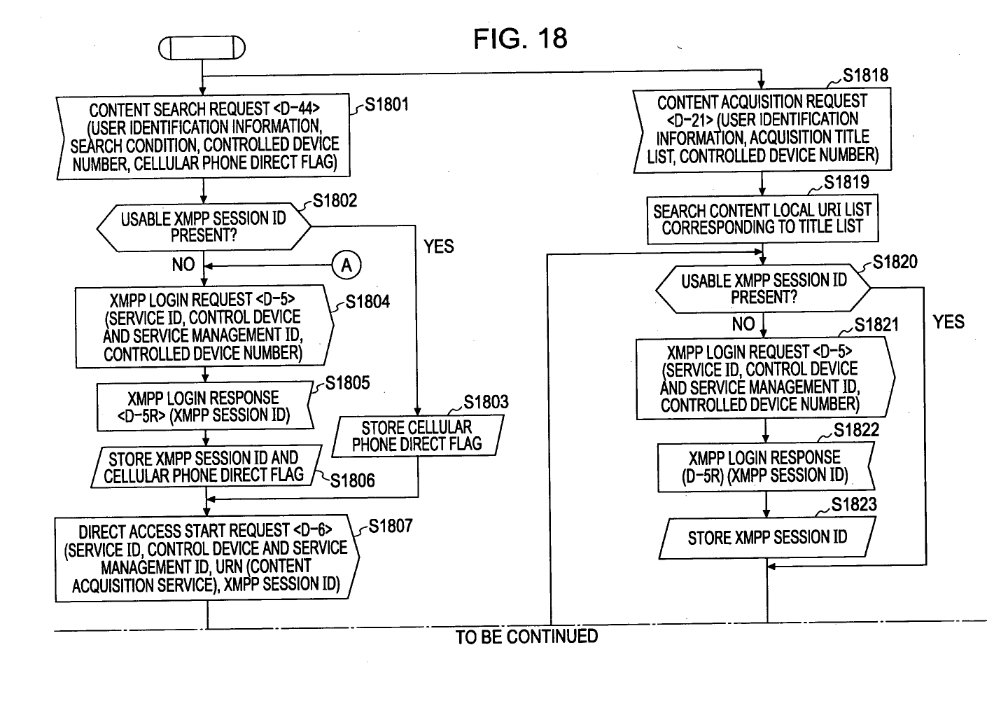

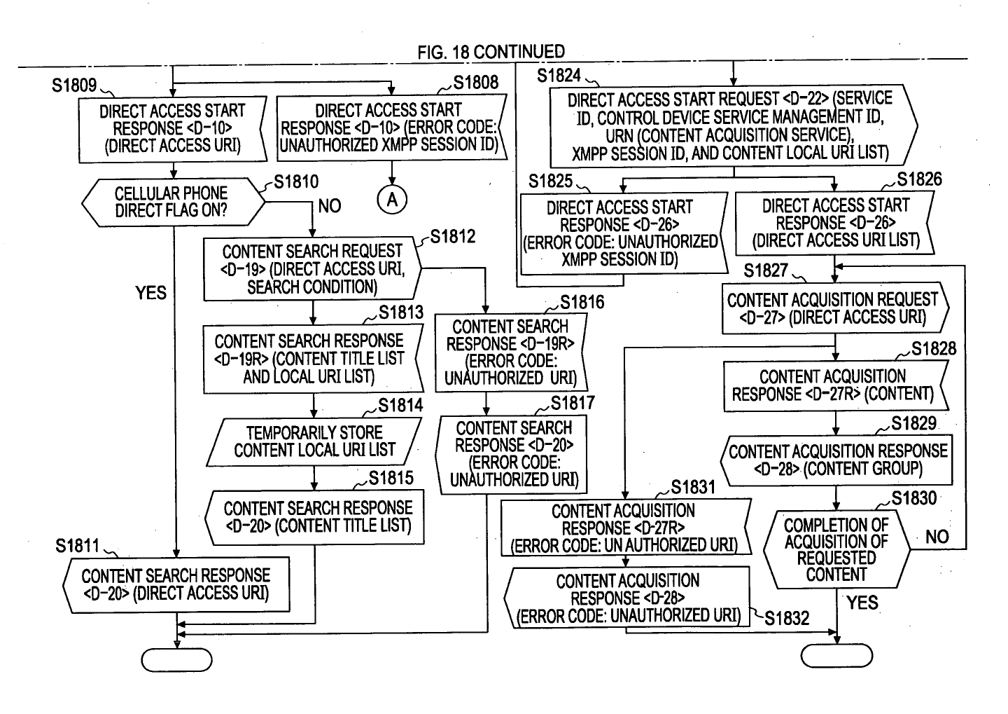

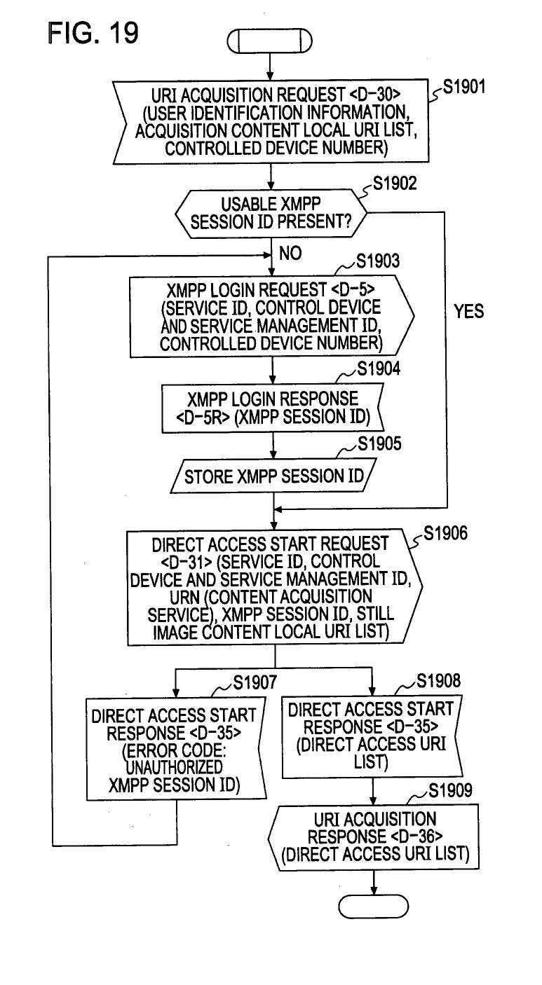

Operation of the cellular phone 10 for acquiring content from the DVR 20 is described below. FIG. 15 is a sequence chart of a flow of information in the direct access of the cellular phone 10 to the DVR 20. FIG. 17 is a flowchart of a content acquisition operation of the cellular phone 10, and FIGS. 18 and 19 are flowcharts of the content acquisition operation of the service server 30.

The user provides a direct access start instruction to the cellular phone 10 to receive a content acquisition service (FIG. 17: step S1701). The cellular phone 10 transmits to the service server 30 the controlled device list acquisition request <D-1> containing the user identification information set therewithin (FIG. 17: step S1702).

Upon receiving the controlled device list acquisition request <D-1> from the cellular phone 10 (FIG. 9: step S901), the service server 30 determines whether the control device and service management ID corresponding to the user identification information contained in the controlled device list acquisition request <D-1> is stored on the storage unit 31 (FIG. 9: step S902). If the control device and service management ID corresponding to the user identification information is not stored on the storage unit 31, the service server 30 transmits to the cellular phone 10 an error code indicating that the target controlled device needs to be registered as the controlled device list acquisition response <D-3> (FIG. 9: step S903). If the control device and service management ID corresponding to the user identification information is stored on the storage unit 31, the service server 30 transmits to the direct access management server 40 the controlled device list acquisition request <D-2> containing the ServiceID identifying service and the control device and service management ID. This is performed to acquire a list of controlled devices linked to control device and service management IDs managed by the direct access management server 40.

The direct access management server 40 receives the controlled device list acquisition request <D-2> from the service server 30 (FIG. 10: step S1012). The direct access management server 40 determines whether the combination of the ServiceID and the control device and service management ID contained in the controlled device list acquisition request <D-2> matches the one stored on the storage unit 41 (FIG. 10: step S1013). If the combination is not stored on the storage unit 41, the direct access management server 40 transmits to the service server 30 an error code indicating the controlled device is unregistered as the controlled device list acquisition response <D-2R> (FIG. 10: step S1014). If it is determined that the combination of the ServiceID and the control device and service management ID contained in the controlled device list acquisition request <D-2> is stored on the storage unit 41, the direct access management server 40 generates the controlled device list. The controlled device list includes a number re-assigned to the controlled device management ID of the controlled device controllable from the cellular phone 10 and device authentication information of the controlled device. The number is re-assigned to the controlled device in accordance with the linking content between the control device and service management ID and the device name of the controlled device management ID stored on the storage unit 41. The direct access management server 40 stores the controlled device list with the control device and service management ID associated therewith on the storage unit 41, and transmits a controlled device list acquisition response <D-2R> containing the controlled device list to the service server 30 (FIG. 10: step S1015).

Upon receiving the error code indicating the unregistered controlled device as the controlled device list acquisition response <D-2R> from the direct access management server 40 (FIG. 9: step S905), the service server 30 transmits to the cellular phone 10 an error code indicating that the controlled device needs to be registered as a controlled device list acquisition response <D-3> (FIG. 9: step S906). Upon receiving the controlled device list acquisition response <D-2R> containing the controlled device list from the direct access management server 40 (FIG. 9: step S907), the service server 30 transmits to the cellular phone 10 the controlled device list acquisition response <D-3> containing the controlled device list (FIG. 9: step S908).

Upon receiving the error code as the controlled device list acquisition response <D-3> from the service server 30 (FIG. 17: step S1703), the cellular phone 10 displays on the display unit to the user a message indicating that the controlled device needs to be registered (FIG. 17: step S1704). Upon receiving the controlled device list acquisition response <D-3> containing the controlled device list (FIG. 17: step S1705), the cellular phone 10 determines whether a plurality of controlled device numbers is present in the controlled device list (FIG. 17: step S1706). If a plurality of control device numbers is present, the cellular phone 10 displays the content of the controlled device list on the display unit (FIG. 17: step S1707), prompts the user to select one of the controlled device numbers (FIG. 17: step S1708), and stores the selected controlled device number on the storage unit 11 (FIG. 17: steps S1709 and S1710). If a plurality of controlled device numbers is not present, the cellular phone 10 stores the single controlled device number on the storage unit 11 (FIG. 17: steps S1711 and S1710).

The cellular phone 10 determines whether to select one of two options based on the cellular phone direct flag preset thereon, namely directly accessing the content acquisition service of the DVR 20 or accessing via the service server 30 (FIG. 17: step S1712).

To access the content acquisition service of the DVR 20, the cellular phone 10 transmits to the service server 30 a content search request <D-44> containing the user identification information, search condition, controlled device number, and cellular phone direct flag (on) (FIG. 17: step S1713). To acquire content via the service server 30, the cellular phone 10 transmits to the service server 30 the content search request <D-44> containing the user identification information, search condition, controlled device number, and cellular phone direct flag (off) (FIG. 17: step S1724). The search conditions serve as conditions for searching content, and for example, specify that the content is still image data, or that the content is recorded video data. The search condition may include more detailed items such as date and data size.

The service server 30 receives the content search request <D-44> from the cellular phone 10 (FIG. 18: step S1801), and determines whether a usable XMPP session ID is stored on the storage unit 31 (FIG. 18: step S1802). If a usable XMPP session ID is stored on the storage unit 31, the service server 30 stores on the storage unit 31 the value of the cellular phone direct flag contained in the content search request <D-44> with the ServiceID, the control device and service management ID, and the controlled device number associated therewith (FIG. 18: step S1803). If the usable XMPP session ID is not stored, the service server 30 transmits to the direct access management server 40 the XMPP login request <D-5> containing the ServiceID, the control device and service management ID, and the controlled device number (FIG. 18: step S1804).

The direct access management server 40 receives the XMPP login request <D-5> from the service server 30 (FIG. 10: step S1016), and determines whether a combination of the ServiceID, the control device and service management ID, and the controlled device number contained in the XMPP login request <D-5> is stored on the storage unit 41 (FIG. 10: step S1017). If the combination is not stored on the storage unit 41, the direct access management server 40 transmits an error code indicating that no target controlled device is not present as the XMPP login response <D-5R> (FIG. 10: step S1018). If the target controlled device is stored on the storage unit 41, the direct access management server 40 generates and stores an XMPP session ID (FIG. 10: step S1019), and transmits the XMPP login response <D-5R> containing the XMPP session ID to the service server 30 (FIG. 10: step S1020).

The service server 30 receives the XMPP login response <D-5R> containing the XMPP session ID from the direct access management server 40 (FIG. 18: step S1805), and stores on the storage unit 31 the XMPP session ID contained in the XMPP login response <D-5R> and the value of the cellular phone direct flag contained in the content search request <D-44> in step S1801 with the ServiceID, the control device and service management ID, and the controlled device list associated therewith (FIG. 18: step S1806).

Subsequent to step S1803 and the storage of the cellular phone direct flag in step S1806, the service server 30 transmits to the direct access management server 40 the direct access start request <D-6> containing the ServiceID, the control device and service management ID, the service URN, and the XMPP session ID (FIG. 18: step S1807). Since the cellular phone 10 is now going to acquire the content from the DVR 20, the service URN designates the content acquisition service.

The direct access management server 40 receives the direct access start request <D-6> from the service server 30 (FIG. 11: step S1101), and then determines whether a combination of the ServiceID and the control device and service management ID contained in the direct access start request <D-6> is stored on the storage unit 41 (FIG. 11: step S1102). If the combination is not stored on the storage unit 41, the direct access management server 40 transmits to the service server 30 an error code indicating that the controlled device needs to be registered as the direct access start response <D-10> (FIG. 11: step S1103). If the combination of the ServiceID and the control device and service management ID contained in the direct access start request <D-6> is stored on the storage unit 41, the direct access management server 40 determines whether the XMPP session ID contained in the direct access start request <D-6> is stored on the storage unit 41 with the combination of the ServiceID and the control device and service management ID contained in the direct access start request <D-6> associated therewith (FIG. 11: step S1104). If the XMPP session ID is not stored on the storage unit 41, the direct access management server 40 transmits to the service server 30 an error code indicating that the XMPP session ID is unauthorized as the direct access start response <D-10> (FIG. 11: step S1105). If the XMPP session ID contained in the direct access start request <D-6> is stored on the storage unit 41 with the combination of the ServiceID and the control device and service management ID contained in the direct access start request <D-6> associated therewith, the direct access management server 40 transmits the direct access URI acquisition request <D-7> to the DVR 20 via the XMPP server 43 in the direct access management server 40 (FIG. 11: step S1106). The direct access URI acquisition request <D-7> contains the information of the service URN designated in the direct access start request <D-6>.

The service server 30 receives the error code indicating the unauthorized XMPP session ID as the direct access start response <D-10> from the direct access management server 40 (FIG. 18: step S1808). The service server 30 returns to step S1804, and transmits again the XMPP login request <D-5> to the direct access management server 40 to re-establish the XMPP session.

The DVR 20 receives the direct access URI acquisition request <D-7> containing the service URN designating information from the direct access management server 40 (FIG. 12: step S1201), and assigns a direct access local port (FIG. 12: step S1202). The DVR 20 then transmits to the router 50 a direct access port NAT setting request <D-8> containing the local IP address pre-assigned to the DVR 20 and the port number of the direct access local port, and then requests the router 50 to map the global IP address accessible from the Internet and the port number to the local IP address and the port number (FIG. 12: step S1203).

The DVR 20 receives from the router 50 an acquisition error of the global IP address and the port number as the NAT setting response <D-8R> in response to the direct port NAT setting request <D-8> in step S1203 (FIG. 12: step S1204). Based on the service URN designating information acquired in step S1201, the DVR 20 determines the service URN is tunnelable (FIG. 12: step S1205). If it is determined that the service URN contained in the direct access URI acquisition request <D-7> is tunnelable, the DVR 20 transmits to the direct access management server 40 the error code indicating tunneling as the direct access URI acquisition response <D-9> (FIG. 12: step S1206). If it is determined that the service URN designating information contained in the direct access URI acquisition request <D-7> is not tunnelable, the DVR 20 transmits to the direct access management server 40 an error code indicating an aborted unused port acquisition attempt as the direct access URI acquisition response <D-9> (FIG. 12: step S1207). Since the content acquisition service handles data of a larger data size than the remote preprogrammed recording setting operation, the service URN is an untunnelable URN. The present invention is not limited to this. Whether to tunnel or not may be set by a service provider depending the capability of the direct access management server 40.

In response to the direct port NAT setting request <D-8>, the DVR 20 may receive the global IP address and the port number in association with the local IP address of the DVR 20 and the port number as the NAT setting response <D-8R> (FIG. 12: step S1208). The DVR 20 generates the direct access URI using the global IP address and the port number and transmits to the direct access management server 40 the direct access URI as the direct access URI acquisition response <D-9> (FIG. 12: step S1209).

The XMPP server 43 in the direct access management server 40 receives the direct access URI list as the direct access URI acquisition response <D-9> (FIG. 11: step S1107), and transmits to the service server 30 the direct access URI list as the direct access start response <D-10> (FIG. 11: step S111).

The direct access management server 40 receives an error code requesting the content acquisition through tunneling as the direct access URI acquisition response <D-9> (FIG. 11: step S1109), and assigns a tunneling port in the direct access management server 40 (FIG. 11: step S1110). The direct access management server 40 generates the direct access URI using the port number of the assigned tunneling port in the direct access management server 40 and the global IP address in the direct access management server 40. The direct access management server 40 then transmits to the service server 30 the direct access start response <D-10> containing the direct access URI list (FIG. 11: step S1111).

The service server 30 receives the direct access start response <D-10> from the direct access management server 40 (FIG. 18: step S1809), and determines whether the cellular phone direct flag is on (FIG. 18: step S1810). If the cellular phone direct flag is on, the service server 30 transmits to the cellular phone 10 a content search response <D-20> containing the direct access URI in order to allow the cellular phone 10 access directly the device designated in accordance with the direct access URI (FIG. 18: step S1811). If the cellular phone direct flag is off, the service server 30 transmits to the DVR 20 a content search request <D-19> containing the direct access URI and the search condition acquired in the content search request <D-44> from the cellular phone 10 (FIG. 18: step S1812).

Specific examples of the content acquisition request the cellular phone 10 performs to the DVR 20 are described below.

[4.1. Direct Access from Cellular Phone 10: FIG. 15]

The cellular phone 10 directly performs the content acquisition process to the DVR 20 without using the service server 30. FIG. 15 is a sequence chart of a flow of information in the direct content acquisition process performed by the cellular phone 10 to the DVR 20.

The process of each of the cellular phone 10, the DVR 20, the service server 30, the direct access management server 40 and the router 50 shown in FIG. 15 up to the direct access start response <D-10> remains unchanged from the process discussed previously.

The cellular phone 10 directly performs the content acquisition service on the DVR 20 when it is determined in step S1810 that that cellular phone direct flag is on and when no tunneling operation is performed on the direct access management server 40.

The cellular phone 10 directly requests the DVR 20 to search content, and acquires a title list of content matching the search condition.

The cellular phone 10 receives the content search response <D-20> containing the direct access URI from the service server 30 (FIG. 17: step S1714). The cellular phone 10 accesses the address of the DVR 20 contained in the direct access URI and then transmits to the DVR 20 a content search request <D-29> containing the direct access URI and the search condition (FIG. 17: step S1715).

The DVR 20 receives from the cellular phone 10 the content search request <D-29> containing the direct access URI and the search condition (FIG. 12: step S1214), and checks the authenticity of the direct access URI contained in the content search request <D-29> (FIG. 12: step S1215). If the direct access URI is unauthorized, the DVR 20 transmits to the cellular phone 10 an error code indicating the unauthorized direct access URI as a content search response <D-29R> (FIG. 12: step S1216). If the direct access URI is authorized, the DVR 20 searches the storage unit 21 for content matching the search condition in the content search request <D-29> and generates a title list of the content of search results and a LocalURI list. The DVR 20 transmits to the cellular phone 10 the generated title list and the LocalURI list as a content search response <D-29R> (FIG. 12: step S1217). The LocalURI is information (URI) indicating a local storage location of the content. For example, the LocalURI may be information showing a storage location within the DVR 20 identified by a local designating method in the DVR 20, or a storage location within a home network identified by a local address in the home network with the DVR 20 connected thereto.

Upon receiving from the DVR 20 the error code indicating the unauthorized URI as the content search response <D-29R> (FIG. 17: step S1722), the cellular phone 10 display a message indicating an aborted direct access on the display unit to the user (FIG. 17: step S1723).

Upon receiving from the DVR 20 the content search response <D-29R> containing the title list of content and the LocalURI (FIG. 17: step S1716), the cellular phone 10 proceeds to a process to acquire the content.

The content acquisition service of the cellular phone 10 to the DVR 20 is described below.

The cellular phone 10 receives the content search response <D-29R> containing the title list of the content and the LocalURI list from the DVR 20 (FIG. 17: step S1716), displays a list of titles of received content on the display unit, extracts the LocalURI corresponding to a content selected by the user from the displayed titles, and produces a LocalURI list for requesting the content. The cellular phone 10 transmits to the service server 30 a URI acquisition request <D-30> containing the user identification information, the LocalURI list of the selected content, and the controlled device number (FIG. 17: step S1717). The cellular phone 10 acquires the direct access URI to the DVR 20 again because the LocalURI acquired in step S1716 points to a location inaccessible from the Internet.

Upon receiving the URI acquisition request <D-30> (FIG. 19: step S1901), the service server 30 determines whether the usable XMPP session ID is stored on the storage unit 31 (FIG. 19: step S1902). If the usable XMPP session ID is not stored on the storage unit 31, the service server 30 transmits the XMPP login request <D-5> to the direct access management server 40 (FIG. 19: step S1903). The service server 30 receives the XMPP login response <D-5R> from the direct access management server 40 (FIG. 19: step S1904), and stores the XMPP session ID contained in the received XMPP login response <D-5R> onto the storage unit 31 (FIG. 19: step S1905). The service server 30 transmits to the direct access management server 40 a direct access start request <D-31> containing the ServiceID, the control device and service management ID, the service URN, the XMPP session ID, and the LocalURI list of the content (FIG. 19: step S1906). If the usable XMPP session ID is already stored on the storage unit 31, the service server 30 also transmits the direct access start request <D-31> to direct access management server 40 (FIG. 19: step S1906). Since the cellular phone 10 is going to acquire the content from the DVR 20, the service URN is information designating the content acquisition service.

The direct access management server 40 receives the direct access start request <D-31> (FIG. 11: step S1101), and determines whether a combination of the ServiceID and the control device and service management ID contained in the direct access start request <D-31> is stored on the storage unit 41 (FIG. 11: step S1102). If the combination is not stored on the storage unit 41, the direct access management server 40 transmits to the service server 30 as a direct access start response <D-35> an error code indicating that the controlled device needs to be registered (FIG. 11: step S1103). If the combination of the ServiceID and the control device and service management ID is stored on the storage unit 41, the direct access management server 40 determines whether the XMPP session ID contained in the direct access start request <D-31> is stored on the storage unit 41 with the combination of the ServiceID and the control device and service management ID contained in the direct access start request <D-31> associated therewith (FIG. 11: step S1104). If the XMPP session ID is not stored in association with the combination of the ServiceID and the control device and service management ID, the direct access management server 40 transmits to the service server 30 an error code indicating that the XMPP session ID is unauthorized as the direct access start response <D-35> (FIG. 11: step S1105). If the XMPP session ID is stored in association with the combination of the ServiceID and the control device and service management ID on the storage unit 41, the direct access management server 40 transmits to the DVR 20 a direct access URI acquisition request <D-32> containing the service URN and the LocalURI list designated in the direct access start request <D-31> (FIG. 11: step S1106).

Upon receiving the error code as the direct access start response <D-35> from the direct access management server 40 (FIG. 19: step S1907), the service server 30 returns to step S1903. The service server 30 issues again the XMPP login request <D-5> to the direct access management server 40 and receives the XMPP login response <D-5R> from the direct access management server 40 (FIG. 19: step S1904). The service server 30 stores the XMPP session ID contained in the XMPP login response <D-5R> on the storage unit 41 (FIG. 19: step S1905).

The DVR 20 receives a direct access URI acquisition request <D-32> from the direct access management server 40 (FIG. 12: step S1201), and assigns a direct access local port (FIG. 12: step S1202). The DVR 20 transmits to the router 50 a direct access port NAT setting request <D-33> containing the local IP address and the port number of the direct access local port (FIG. 12: step S1203).

The DVR 20 receives an acquisition error of the global IP address and the port number as a NAT setting response <D-33R> from the service server 30 (FIG. 12: step S1204), and determines, based on the service URN designation information received in step S1201, whether the service URN is tunnelable (FIG. 12: step S1205). If it is determined that the service URN is tunnelable, the DVR 20 transmits to the direct access management server 40 an error code requesting tunneling as a direct access URI acquisition response <D-34> (FIG. 12: step S1206). If it is determined that the service URN is not tunnelable, the DVR 20 transmits to the direct access management server 40 an error code indicating an aborted unused port acquisition as the direct access URI acquisition response <D-34> (FIG. 12: step S1207).

In response to the direct access port NAT setting request <D-33>, the DVR 20 receives from the router 50 the global IP address and the port number associated with the local IP address and the port number of the DVR 20 as a NAT setting response <D-33R> (FIG. 12: step S1208). The DVR 20 generates the direct access URI list using the global IP address and the port number and transmits the generated direct access URI list as the direct access URI acquisition response <D-34> to the direct access management server 40 (FIG. 12: step S1209).

Upon receiving the direct access URI list as the direct access URI acquisition response <D-34> (FIG. 11: step S1107), the XMPP server 43 in the direct access management server 40 transmits to the service server 30 the direct access URI list as the direct access start response <D-35> (FIG. 11: step S1111).

The direct access management server 40 receives the error code requesting the content acquisition through tunneling as the direct access URI acquisition response <D-34> (FIG. 11: step S1109), and assigns a tunneling port in the direct access management server 40 (FIG. 11: step S1110). The direct access management server 40 generates a direct access URI list using the port number of the assigned tunneling port in the direct access management server 40 and the global IP address of the direct access management server 40, and transmits to the service server 30 the direct access start response <D-35> containing the direct access URI list (FIG. 11: step S1111).

The service server 30 receives the direct access start response <D-35> containing the direct access URI list (FIG. 19: step S1908), and then transmits to the cellular phone 10 a URI acquisition response <D-36> containing the direct access URI list (FIG. 19: step S1909).

Upon receiving the direct access URI to acquire directly the content from the DVR 20, the cellular phone 10 starts a process to acquire the selected content from the DVR 20. The direct access URI list that the cellular phone 10 has received as the URI acquisition response <D-36> includes the direct access URI corresponding to each content selected by the user.

Upon receiving the URI acquisition response <D-36> containing the direct access URI list (FIG. 17: step S1718), the cellular phone 10 selects the direct access URI of the content to be acquired from the direct access URI list, and transmits directly to the DVR 20 a content acquisition request <D-37> containing the direct access URI (FIG. 17: step S1719).

The DVR 20 receives the content acquisition request <D-37> containing the direct access URI from the cellular phone 10 (FIG. 12: step S1218), and checks the authenticity of the direct access URI contained in the content acquisition request <D-37> (FIG. 12: step S1219). If the direct access URI is unauthorized, the DVR 20 transmits to the cellular phone 10 an error code indicating an unauthorized URI as a content acquisition response <D-37R> (FIG. 12: step S1220). If the URI is authorized, the DVR 20 transmits to the cellular phone 10 the content designated by the direct access URI as a content acquisition response <D-37R> (FIG. 12: step S1221).

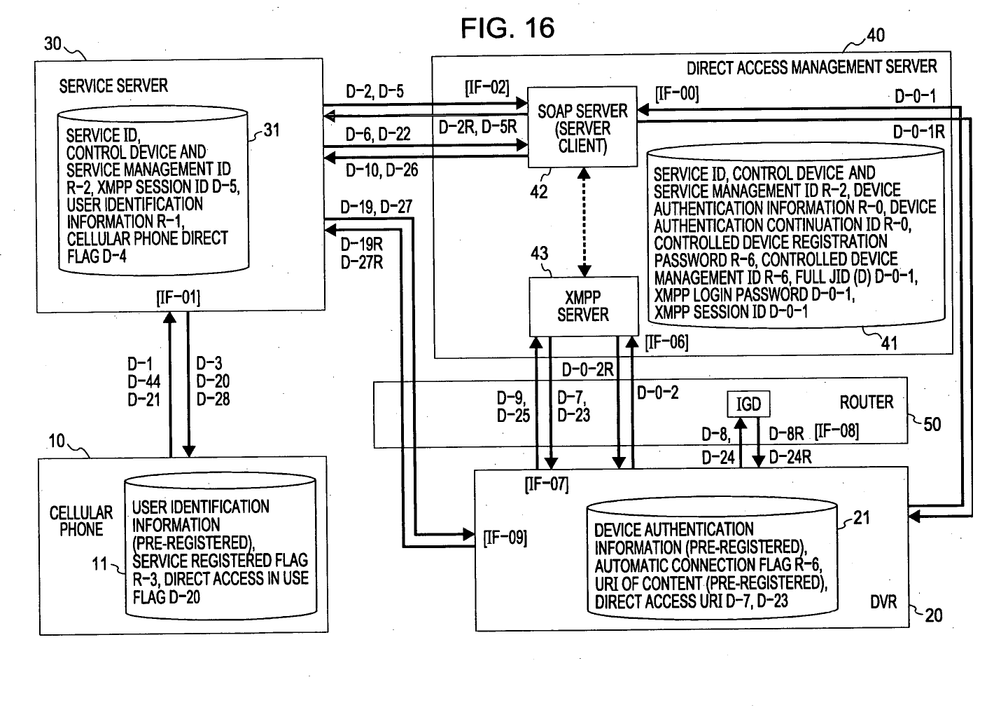

Upon receiving the content as the content acquisition response <D-37R> from the DVR 20 (FIG. 17: step S1720), the cellular phone 10 repeats the transmission of the content acquisition response <D-37R> in step S1719 until the acquisition of all content listed in the direct access URI list is completed (FIG. 17: step S1721). Upon receiving an error code indicating an unauthorized URI from the DVR 20, the cellular phone 10 displays a message on the display unit to the user indicating an aborted direct access.

[4.2. Content Acquisition via the Service Server 30: FIG. 16]

The content acquisition service of the cellular phone 10 for acquiring the content from the DVR 20 via the service server 30 is described below. FIG. 16 is a sequence chart of a flow of information in the content acquisition service in the direct access from the service server 30 to the DVR 20.

The flow of information among the cellular phone 10, the service server 30, the direct access management server 40 and the router 50 shown in FIG. 16 is identical to that of FIG. 15 up to the direct access start response <D-10>, and the discussion thereof is omitted herein.

The cellular phone 10 performs the content acquisition process to the DVR 20 via the service server 30 when it is determined in step S1810 that the cellular phone direct flag is off and when the tunneling process is not performed in the direct access management server 40.

In the process discussed below, the cellular phone 10 requests the DVR 20 via the service server 30 to search content and acquires a title list of content satisfying the search condition.

The DVR 20 receives the content search request <D-19> containing the direct access URI and the search condition transmitted in step S1812 from the service server 30 (FIG. 12: step S1214), and checks the authenticity of the direct access URI contained in the content search request <D-19> (FIG. 12: step S1215). If the URI is unauthorized, the DVR 20 transmits to the service server 30 an error code indicating an unauthorized URI as a content search response <D-19R> (FIG. 12: step S1216). If the URI is authorized, the DVR 20 searches the DVR 20 for content satisfying the search condition contained in the content search request <D-19>, and generates the title list of the content as search results and the LocalURI list. The DVR 20 transmits the generated title list and LocalURI list as a content search response <D-19R> to the service server 30 (FIG. 12: step S1217).

The service server 30 receives from the DVR 20 the title list and the LocalURI list of the content as the content search response <D-19R> (FIG. 18: step S1813), stores temporarily the LocalURI list of the content (FIG. 18: step S1814), and transmits a content search response <D-20> containing the title list of the content to cellular phone 10 (FIG. 18: step S1815).

Upon receiving from the DVR 20 the error code indicating an unauthorized URI as the content search response <D-19R> (FIG. 18: step S1816), the service server 30 transmits the error code as a content search response <D-20> to the cellular phone 10 (FIG. 18: step S1817).

The cellular phone 10 receives the error code indicating the unauthorized URI as the content search response <D-20> from the service server 30 (FIG. 17: step S1728), and displays on the display unit to the user a message indicating an aborted direct access (FIG. 17: step S1729). Upon receiving the title list of the content as the content search response <D-20> from the service server 30 (FIG. 17: step S1725), the cellular phone 10 starts a process to acquire the content.

The content acquisition process performed by the cellular phone 10 to the DVR 20 via the service server 30 is described below.

The cellular phone 10 receives a content search response <D-20> containing the title list of the content from the service server 30 (FIG. 17: step S1725), and displays a list of tiles of the received content on the display unit. The cellular phone 10 extracts a title of the content selected by the user from among the display titles, and generates an acquisition title list for requesting the acquisition of the content.

The cellular phone 10 transmits to the service server 30 a content acquisition request <D-21> containing the user identification information, the title list of the selected content (acquisition title list), and the controlled device number (FIG. 17: step S1726). Upon receiving the content acquisition request <D-21> (FIG. 18: step S1818), the service server 30 searches the storage unit 31 for the LocalURI list of the content corresponding to the title list contained in the content acquisition request <D-21> (FIG. 18: step S1819), extracts the LocalURI corresponding to the content selected by the user, and generates the LocalURI list for requesting the acquisition of the content.

The service server 30 determines whether the usable XMPP session ID is stored on the storage unit 31 (FIG. 18: step S1820). If the usable XMPP session ID is not stored on the storage unit 31, the service server 30 transmits to the direct access management server 40 a XMPP login request <D-5> (FIG. 18: step S1821). The service server 30 receives a XMPP login response <D-5R> from the direct access management server 40 (FIG. 18: step S1822), and stores the XMPP session ID contained in the received XMPP login response <D-5R> on the storage unit 31 (FIG. 18: step S1823). The service server 30 then transmits to the direct access management server 40 a direct access start request <D-22> containing the ServiceID, the control device and service management ID, the service URN, the XMPP session ID, and the LocalURI list of the content (FIG. 18: step S1824). If the usable XMPP session ID is already stored on the storage unit 31, the service server 30 transmits a direct access start request <D-22> to the direct access management server 40 (FIG. 18: step S1824). Since the content acquisition process is performed to the DVR 20, the service URN designates a content acquisition service.

The direct access management server 40 receives the direct access start request <D-22> (FIG. 11: step S1101), and determines whether a combination of the ServiceID and the control device and service management ID is stored on the storage unit 41 (FIG. 11: step S1102). If the combination is not stored on the storage unit 41, the direct access management server 40 transmits to the service server 30 an error code indicating that the controlled device needs to be registered as a direct access start response <D-26> (FIG. 11: step S1103). If the combination of the ServiceID and the control device and service management ID is stored on the storage unit 41, the direct access management server 40 determines whether the XMPP session ID contained in the direct access start request <D-22> is stored on the storage unit 41 with the combination of the ServiceID and the control device and service management ID contained in the direct access start request <D-22> associated therewith (FIG. 11: step S1104). If the combination of the ServiceID and the control device and service management ID is not stored, the direct access management server 40 transmits to the service server 30 an error code indicating an unauthorized XMPP session ID as a direct access start response <D-26> (FIG. 11: step S1105). If the XMPP session ID is stored in association with the combination of the ServiceID and the control device and service management ID on the storage unit 41, the direct access management server 40 transmits to the DVR 20 a direct access URI acquisition request <D-23> containing the service URN and the LocalURI list designated by the direct access start request <D-31> (FIG. 11: step S1106).

Upon receiving from the direct access management server 40 the error code indicating the unauthorized XMPP session ID (FIG. 18: step S1825), the service server 30 returns to step S1820 to determine again whether the usable XMPP session ID is stored on the storage unit 31.

The DVR 20 receives from the direct access management server 40 the direct access URI acquisition request (FIG. 12: step S1201), and assigns the direct access local port (FIG. 12: step S1202). The DVR 20 transmits to the router 50 a direct access port NAT setting request <D-24> containing the local IP address and the port number of the direct access local port (FIG. 12: step S1203).

The DVR 20 receives from the router 50 the acquisition error of the global IP address and the port number as a NAT setting response <D-24R> from the router 50 (FIG. 12: step S1204). Based on the service URN designating information acquired in step S1201, the DVR 20 determines whether the service URN is tunnelable (FIG. 12: step S1205). If the service URN is determined to be tunnelable, the DVR 20 transmits to the direct access management server 40 an error code indicating a tunneling process as a direct access URI acquisition response <D-25> (FIG. 12: step S1206). If the service URN is not tunnelable, the DVR 20 transmits to the direct access management server 40 an error code indicating an aborted unused port acquisition as the direct access URI acquisition response <D-25> (FIG. 12: step S1207).

The DVR 20 receives the global IP address and the port number associated with the local IP address and the port number of the DVR 20 as a NAT setting response <D-24R> in response to the direct access port NAT setting request <D-24> (FIG. 12: step S1208). The DVR 20 generates the direct access URI list using the global IP address and the port number and transmits to the direct access management server 40 the direct access URI list as the direct access URI acquisition response <D-25> (FIG. 12: step S1209).

The XMPP server 43 in the direct access management server 40 receives direct access URI as the direct access URI acquisition response <D-25> (FIG. 11: step S1107), and transmits to the service server 30 the direct access URI as a direct access start response <D-26> (FIG. 11: step S1111).

The direct access management server 40 receives the error code requesting the content acquisition through tunneling as the direct access URI acquisition response <D-25> (FIG. 11: step S1109), and assigns a tunneling port in the direct access management server 40 (FIG. 11: step S1110). The direct access management server 40 generates a direct access URI using the port number of the assigned tunneling port in the direct access management server 40 and the global IP address of the direct access management server 40, and transmits to the service server 30 the direct access URI as the direct access start response <D-26> (FIG. 11: step S1111).

Upon receiving the direct access URI for directly acquiring the content from the DVR 20, the service server 30 starts a process for acquiring the selected content from the DVR 20. The direct access URI that the service server 30 has received as the direct access start response <D-26> includes the direct access URI corresponding to each content selected by the user.

The service server 30 receives the direct access start response <D-26> containing the direct access URI (FIG. 18: step S1826), selects the direct access URI corresponding to the content to be acquired from the direct access URI list, and then transmits to the DVR 20 a content acquisition request <D-27> containing the direct access URI (FIG. 18: step S1827). Upon receiving the content acquisition request <D-27> from the service server 30, the DVR 20 (FIG. 12: step S1218), the DVR 20 checks the authenticity of the direct access URI contained in the content acquisition request <D-27> (FIG. 12: step S1219). If the URI is unauthorized, the DVR 20 transmits to the service server 30 an error code indicating an unauthorized URI as a content acquisition response <D-27R> (FIG. 12: step S1220). If the URI is authorized, the DVR 20 transmits to the service server 30 a content designated by the direct access URI as a content acquisition response <D-27R> (FIG. 12: step S1221).

The service server 30 receives the content as the content acquisition response <D-27R> from the DVR 20 (FIG. 18: step S1828), and transmits to the cellular phone 10 the content as a content acquisition response <D-28> (FIG. 18: step S1829). The service server 30 repeats to transmit to the DVR 20 the content acquisition request <D-27> in step S1827 until the transmission of all content listed in the direct access URI list to the cellular phone 10 is completed (FIG. 18: step S1830. Upon receiving a content acquisition response <D-28> containing the content (FIG. 17: step S1727), the cellular phone 10 displays the received content on the display unit to the user.

Upon receiving the error code indicating the unauthorized URI as the content acquisition response <D-27R> from the DVR 20 (FIG. 18: step S1831), the service server 30 transmits the error code as the content acquisition response <D-28> to the cellular phone 10 (FIG. 18: step S1832).

As described above, the cellular phone 10 can acquire the content from the DVR 20 by directly accessing the DVR 20 or by using the proxy access via the service server 30. In the above discussion, the content acquisition service is untunnelable service. The tunneling process discussed with reference to the remote preprogrammed recording service may be applied to the content acquisition service. In the content acquisition service, the tunneling process via the XMPP server 43 in the direct access management server 40 may be used to acquire the content from the DVR 20.

[5. Completion of Direct Access]

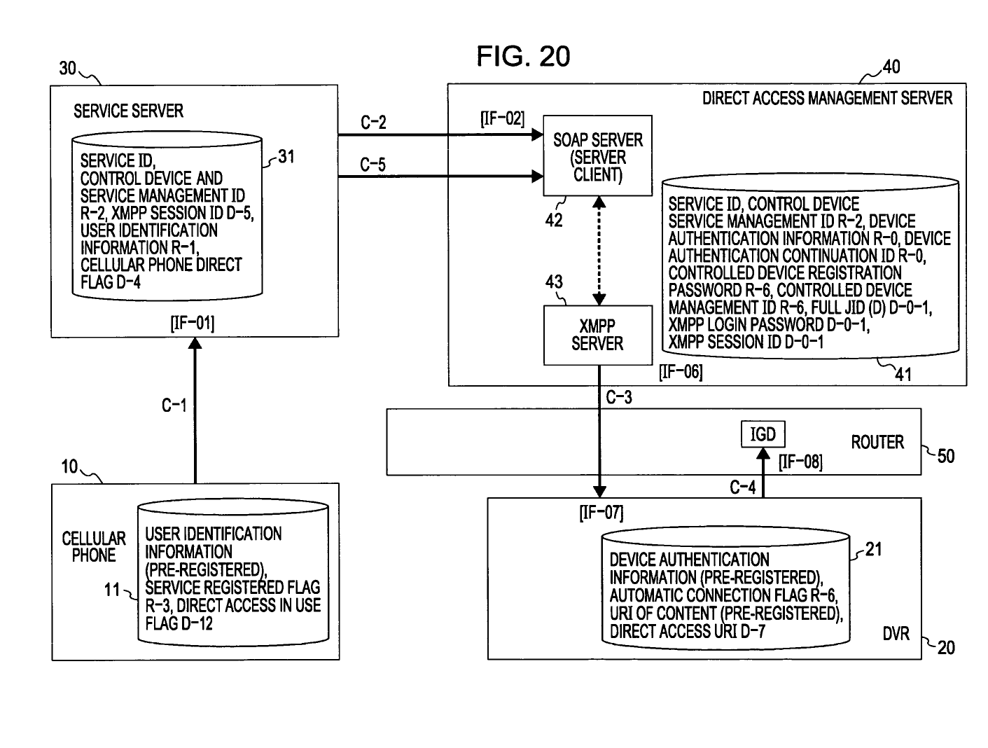

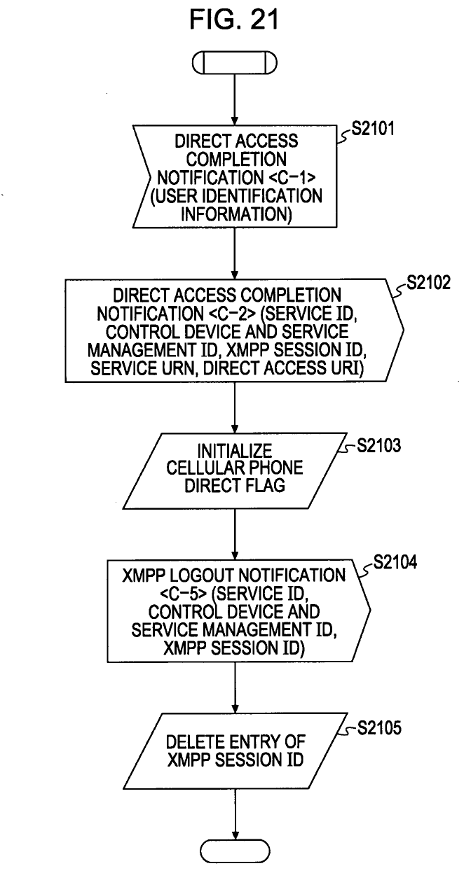

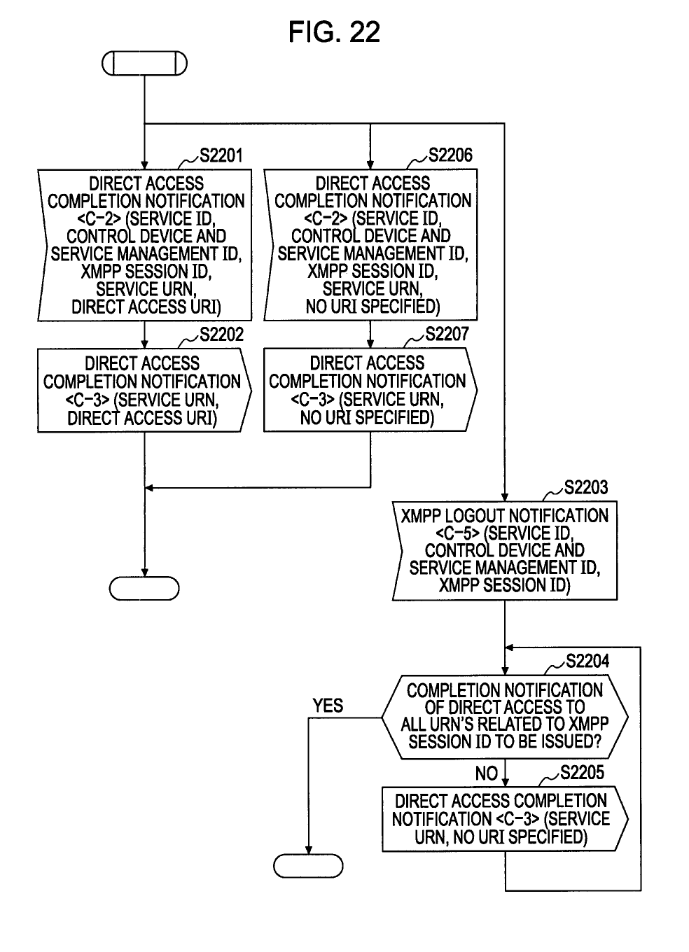

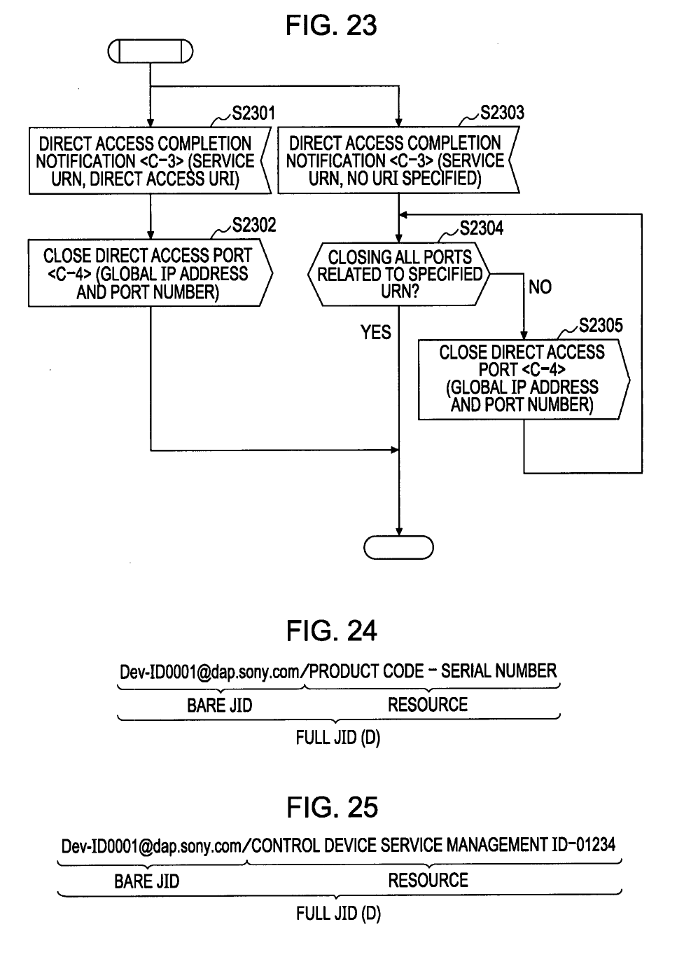

A process of completing the direct access in each of the service server 30, the direct access management server 40, and the DVR 20 subsequent to each of the above-referenced processes is described below. FIG. 20 is a sequence chart of a flow of information at the completion of the direct access. FIG. 21 is a flowchart of a direct access completion operation of the service server 30. FIG. 22 is a flowchart of the direct access completion operation of the direct access management server 40. FIG. 23 is a flowchart of the direct access completion operation of the DVR 20.

The service server 30 receives from the cellular phone 10 a direct access completion notification <C-1> containing the user identification information (FIG. 21: step S2101), and transmits to the direct access management server 40 a direct access completion notification <C-2> containing the ServiceID, the control device and service management ID, the XMPP session ID, the service URN, and the direct access URI (FIG. 21: step S2102).

Upon receiving the direct access completion notification <C-2> (FIG. 22: step S2201), the direct access management server 40 transmits to the DVR 20 a direct access completion notification <C-3> containing the service URN and the direct access URI (FIG. 22: step S2202). If no direct access URI is designated in the direct access completion notification <C-2> (FIG. 22: step S2206), the direct access management server 40 transmits to the DVR 20 the direct access completion notification <C-3> containing only the service URN (FIG. 22: step S2207).

The DVR 20 receives the direct access completion notification <C-3> containing the service URN and the direct access URI (FIG. 23: step S2301), and closes the direct access port containing the global IP address and the port number of the designated direct access URI <C-4> (FIG. 23: step S2302).

After transmitting the direct access completion notification <C-2>, the service server 30 initializes the cellular phone direct flag (FIG. 21: step S2103). The service server 30 transmits to the direct access management server 40 an XMPP logout notification <C-5> containing the ServiceID, the control device and service management ID, and the XMPP session ID (FIG. 21: step S2104). The service server 30 then deletes an XMPP session ID entry (FIG. 21: step S2105).

The direct access management server 40 receives the XMPP logout notification <C-5> containing the ServiceID, the control device and service management ID, and the XMPP session ID (FIG. 22: step S2203), and determines whether the completion notification of the direct access of all service URNs relating to the XMPP session ID is issued to the DVR 20 (FIG. 22: step S2204). If a service URN requiring to be notified of the completion notification of the direct access remains, only the service URN is designated. The direct access management server 40 transmits to the DVR 20 the direct access finalizing notification <C-3> having no direct access URI designated (FIG. 22: step S2205). When all completion notifications are performed, the direct access management server 40 waits on standby for the direct access completion notification <C-2> from the service server 30.

The DVR 20 receives the direct access completion notification <C-3> with no direct access URI designated from the direct access management server 40 (FIG. 23: step S2303), and closes all ports relating to the service URN designated by the direct access completion notification <C-3> (FIG. 23: steps S2304 and S2305).

By performing the above-described processes, the direct access in each of the service server 30, the direct access management server 40 and the DVR 20 is completed.

In the above embodiment, the service server 30 acquires the controlled device registration password as a one-time password from the direct access management server 40 in response to the request from the cellular phone 10. In accordance with the present embodiment, the DVR 20 (controlled device) may acquire the controlled device registration password as the one-time password from the direct access management server 40.

### Second Embodiment of the Present Invention

A second embodiment of the present invention is described below.

In accordance with the first embodiment, the service server 30 acquires the controlled device registration password as a one-time password from the direct access management server 40 in response to the request from the cellular phone 10. In accordance with the second embodiment, the DVR 20 (controlled device) acquires the controlled device registration password as a one-time password from the direct access management server 40.

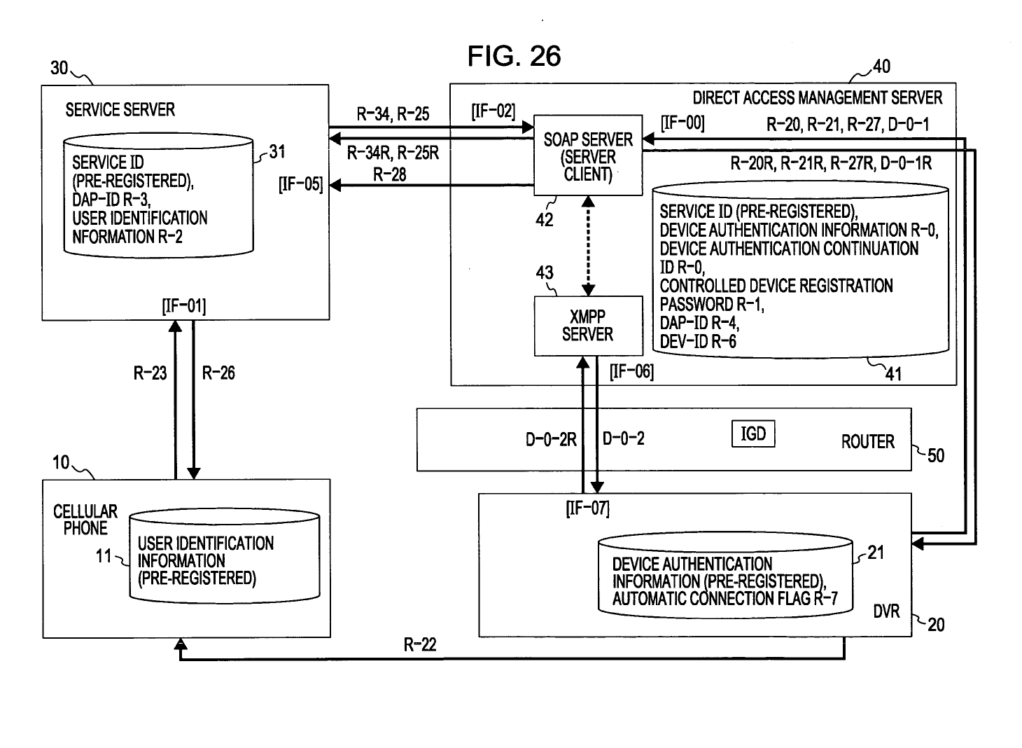

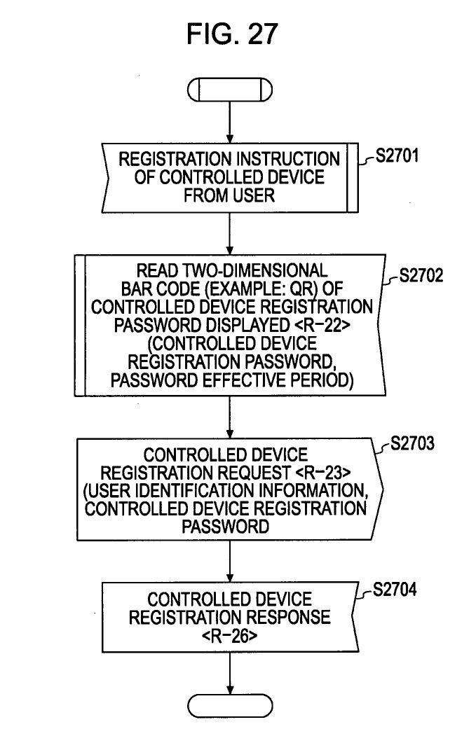

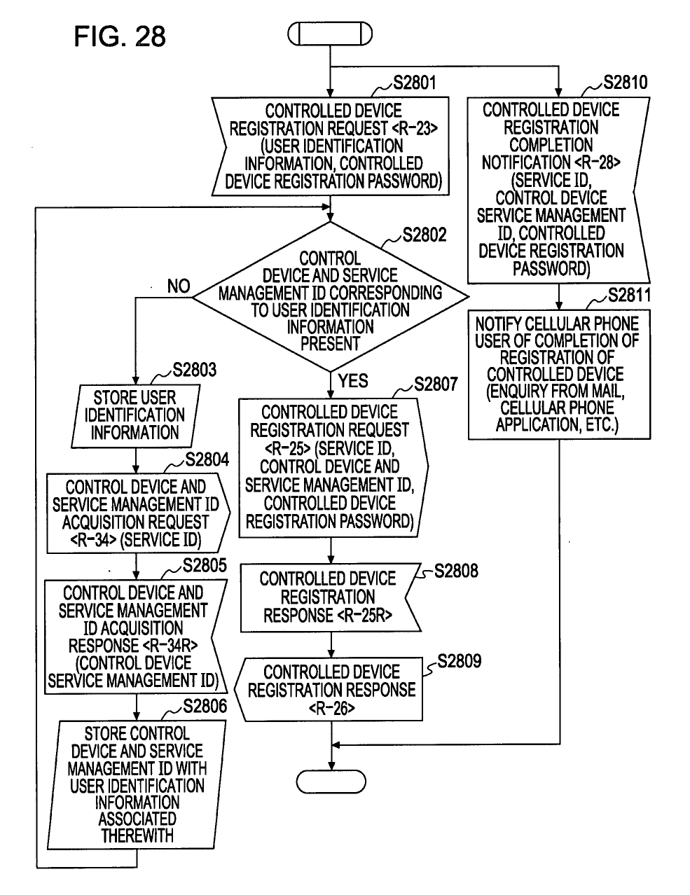

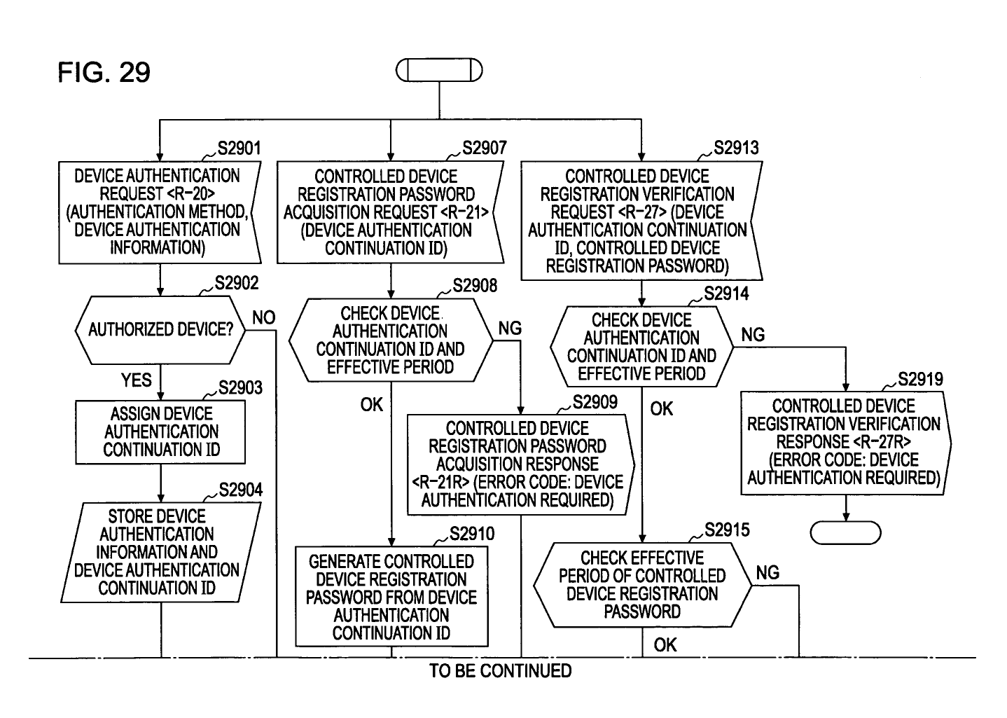

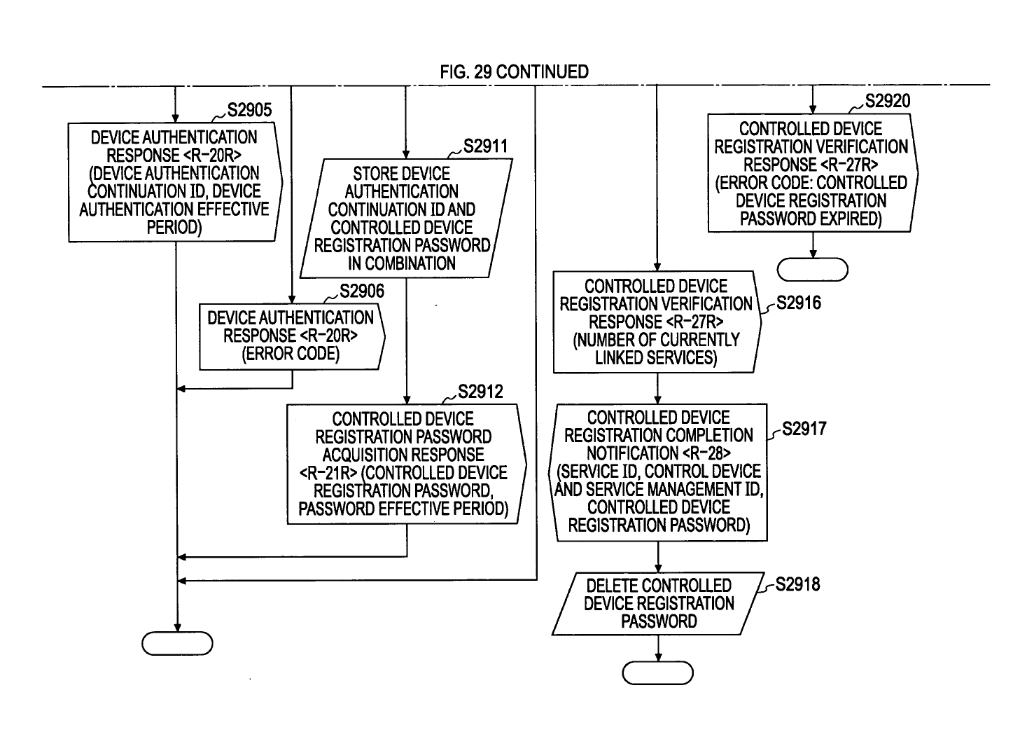

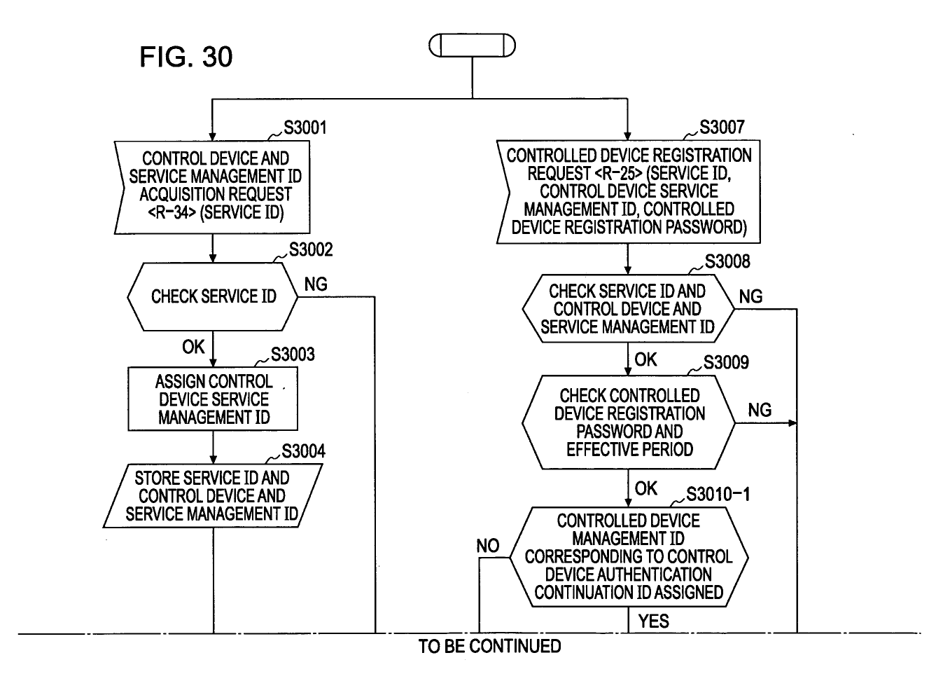

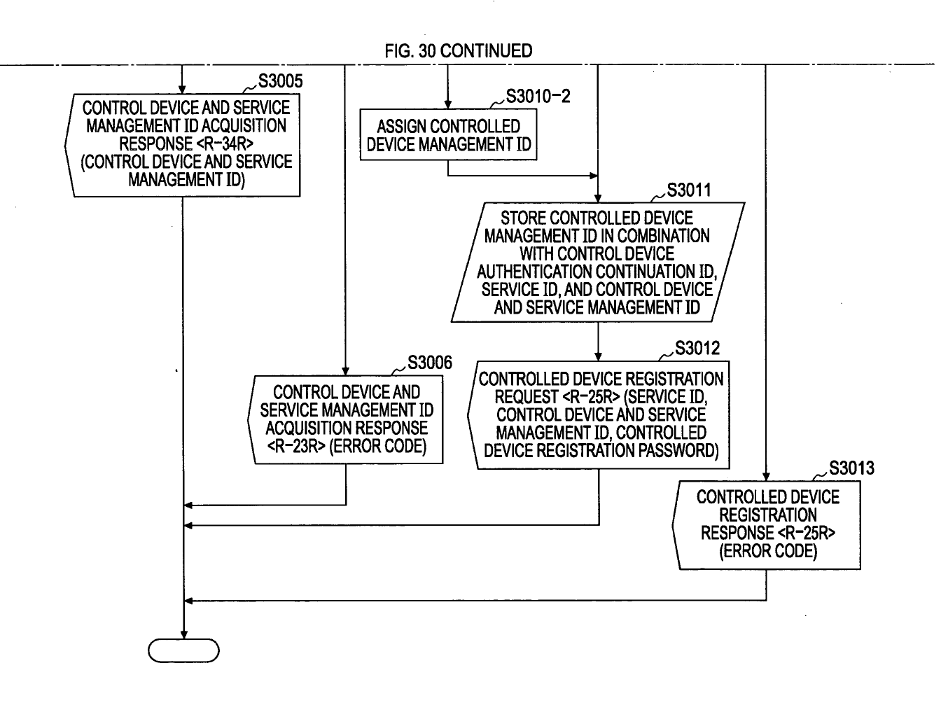

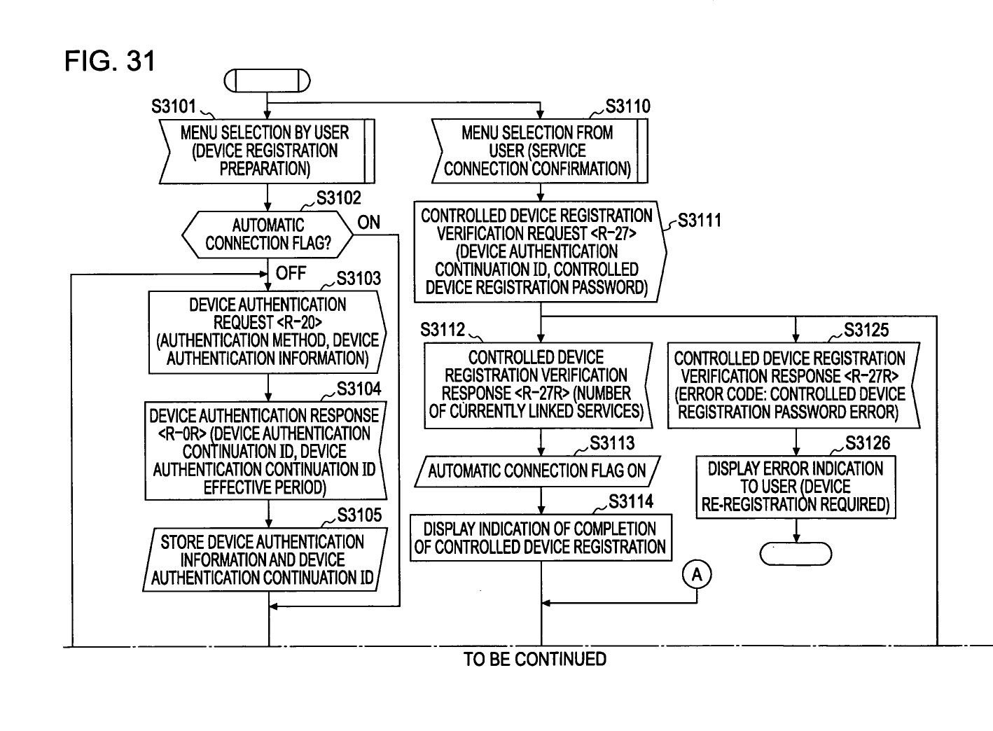

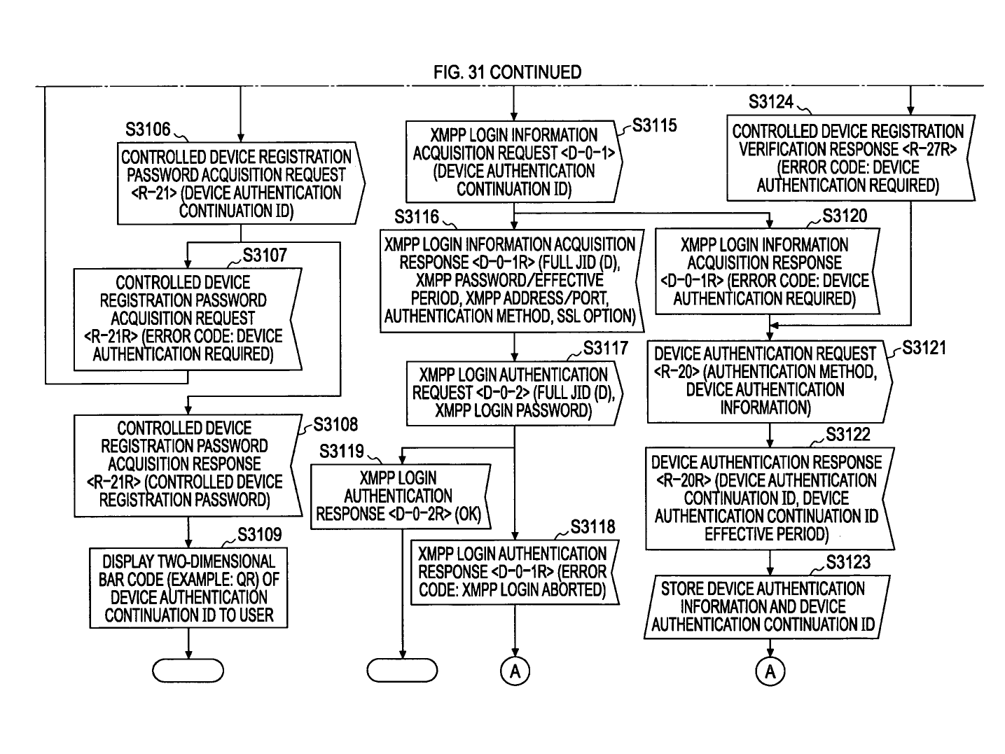

FIG. 26 is a sequence chart in a flow of information in the registration of a combination of the cellular phone 10 and service and the registration of the DVR 20 in accordance with the second embodiment of the present invention. FIG. 27 is a flowchart illustrating a registration process of the cellular phone 10. FIG. 28 is a flowchart illustrating a registration process of the service server 30. FIGS. 29 and 30 are flowcharts of a registration process of the direct access management server 40. FIG. 31 is a flowchart of a registration process of the DVR 20.

The user gives an instruction to prepare the device registration of the DVR 20 by performing a selection operation on a menu displayed on a screen of a TV connected to the DVR 20 (FIG. 31: step S3101). The automatic connection flag held at the DVR 20 is off (FIG. 31: step S3102) because the DVR 20 is unregistered in the direct access management server 40 at this point of time. The DVR 20 starts a process for registering the DVR 20 itself on the direct access management server 40.

To register the DVR 20 itself on the direct access management server 40, the DVR 20 transmits to the SOAP server 42 in the direct access management server 40 a device authentication request <R-20> containing information concerning the authentication method and device authentication information set in the DVR 20 (FIG. 31: step S3103).

The SOAP server 42 in the direct access management server 40 receives the device authentication request <R-20> from the DVR 20 (FIG. 29: step S2901), and determines, based on the information concerning the authentication method and the device authentication information contained in the device authentication request <R-20>, whether the DVR 20 is an authorized device (FIG. 29: step S2902). If the DVR 20 is an unauthorized device, the SOAP server 42 transmits to the DVR 20 an error code as a device authentication response <R-20R> (FIG. 29: step S2906). If it is determined that the DVR 20 is an authorized device, the SOAP server 42 generates a device authentication continuation ID to be assigned to the DVR 20 (FIG. 29: step S2903), and stores the device authentication continuation ID on the storage unit 41 with the effective period of the device authentication continuation ID and the device authentication information of the DVR 20 associated therewith (FIG. 29: step S2904). The SOAP server 42 transmits to the DVR 20 information containing the generated device authentication continuation ID and the information of the effective period thereof as a device authentication response <R-20R> (FIG. 29: step S2905).

Upon receiving the error code as the device authentication response <R-20R> from the SOAP server 42 in the direct access management server 40, the DVR 20 displays an error message indicating that the DVR 20 is unauthorized. Upon receiving as the device authentication response <R-20R> the information containing the device authentication continuation ID and the information concerning the effective period thereof (FIG. 31: step S3104), the DVR 20 stores on the storage unit 21 the device authentication continuation ID and the information concerning the effective period contained in the device authentication response <R-20R> with the device authentication information associated therewith (FIG. 31: step S3105). The DVR 20 proceeds to a controlled device registration password acquisition process to register the DVR 20 itself as a device to be controlled by the cellular phone 10.

The automatic connection flag may be on in step S3102 when the user enters an instruction to the DVR 20 to register the DVR 20. In this case, the DVR 20 must have performed the device authentication process (steps S3103-S3105) with the direct access management server 40 and the controlled device registration password acquisition process (steps S3106-S3109), and the registration process (steps S3110-S3114). The DVR 20 therefore has completed the device authentication and the device registration with the direct access management server 40, and has received the device authentication continuation ID from the direct access management server 40. For this reason, the DVR 20 skips the device authentication process from step S3103 through step S3105, and then proceeds to the controlled device registration password acquisition process to link the DVR 20 to a new control device using the device authentication continuation ID acquired from the direct access management server 40.

In a process to be discussed below, the cellular phone 10 as a control device is registered, and linked to the DVR 20.

The DVR 20 as the device to be controlled by the cellular phone 10 acquires a password to register the DVR 20 itself on the direct access management server 40.

The DVR 20 transmits to the direct access management server 40 a controlled device registration password acquisition request <R-21> containing the device authentication continuation ID and the information concerning the effective period acquired from the direct access management server 40 (FIG. 31: step S3106).

The direct access management server 40 receives from the DVR 20 the controlled device registration password acquisition request <R-21> (FIG. 29: step S2907), and checks the device authentication continuation ID and the effective period of the device authentication continuation ID contained in the controlled device registration password acquisition request <R-21> (FIG. 29: step S2908). If a no good check result is obtained, the device authentication continuation ID contained in the controlled device registration password acquisition request <R-21> fails to match any device authentication continuation ID stored in association with the device authentication information on the storage unit 41, or the effective period of the device authentication continuation ID has expired. In such a case, the direct access management server 40 transmits to the DVR 20 an error code indicating that the controlled device needs to be registered as a controlled device registration password acquisition response <R-21R> (FIG. 29: step S2909).

The DVR 20 receives the controlled device registration password acquisition response <R-21R> containing the error code (FIG. 31: step S3107), and returns to step S3102. The DVR 20 re-transmits to the SOAP server 42 in the direct access management server 40 the device authentication request <R-20> containing the information of the authentication method and the device authentication information preset therewithin (FIG. 31: step S3103). In this way, the DVR 20 performs device authentication process with the direct access management server 40, thereby updating the device authentication continuation ID having a new effective period.

If an OK result is obtained in the checking of the device authentication continuation ID and the effective period thereof by the direct access management server 40 (FIG. 29: step S2908), the device authentication continuation ID contained in the controlled device registration password acquisition request <R-21> matches a device authentication continuation ID stored in association with the device authentication information on the storage unit 41, and the effective period of the device authentication continuation ID has not expired. In such a case, the direct access management server 40 generates a controlled device registration password (FIG. 29: step S2910), and stores the generated controlled device registration password in association with the device authentication continuation ID on the storage unit 41 (FIG. 29: step S2911). The direct access management server 40 then transmits to the DVR 20 the generated controlled device registration password and the information concerning the effective period thereof as a controlled device registration password acquisition response <R-21R> (FIG. 29: step S2912).

The DVR 20 receives from the direct access management server 40 the controlled device registration password acquisition response <R-21R> containing the information concerning the controlled device registration password and the effective period thereof (FIG. 31: step S3108). In order to transfer to the cellular phone 10 the information concerning the controlled device registration password and the effective period thereof <R-22>, the DVR 20 internally generates a two-dimensional bar code such as QR code (Registered Trade Mark), for example, and displays the bar code on a TV screen connected to the DVR 20 (FIG. 31: step S3109).

Upon receiving a registration instruction of a controlled device (FIG. 27: step S2701) from the user, the cellular phone 10 acquires the information concerning the controlled device registration password and the effective period thereof <R-22>. For example, using a camera mounted in the cellular phone 10, the user takes a picture of the two-dimensional bar code such as the QR code (Registered Trade Mark) displayed on the TV screen connected to the DVR 20. The cellular phone 10 recognizes the bar code image captured, thereby acquiring the information concerning the controlled device registration password and the effective period thereof <R-22> (FIG. 27: step S2702).

The cellular phone 10 then causes the direct access management server 40 to link the cellular phone 10 as the control device to the DVR 20 as the controlled device.

The cellular phone 10 transmits to the service server 30 a controlled device registration request <R-23> containing the acquired controlled device registration password and the user identification information pre-registered in the cellular phone 10 (FIG. 27: step S2703).

The service server 30 receives the controlled device registration request <R-23> containing the acquired controlled device registration password and the user identification information (FIG. 28: step S2801), and determines whether the control device and service management ID corresponding to the user identification information contained in the controlled device registration request <R-23> is stored on the storage unit 31 in the service server 30 (FIG. 28: step S2802).

If the control device and service management ID corresponding to the user identification information is not stored on the storage unit 31 in the service server 30, the service server 30 stores the user identification information contained in the controlled device registration request <R-23> (FIG. 28: step S2803). The service server 30 transmits to the SOAP server 42 in the direct access management server 40 a control device and service management ID acquisition request <R-34> containing the ServiceID assigned to the service server 30 (FIG. 28: step S2804). Since the cellular phone 10 uses, for the first time, the service provided by the service server 30, the service server 30 requests the direct access management server 40 to issue a control device and service management ID. The control device and service management ID uniquely determines the combination of the cellular phone 10 as the control device and the service provided by the service server 30. The service server 30 uses the control device and service management ID with the direct access management server 40 in the service request from the cellular phone 10. The control device and service management ID thus uniquely identifies a combination of each service provided by a respective service provider and a control device.

The SOAP server 42 in the direct access management server 40 receives the control device and service management ID acquisition request <R-34> (FIG. 30: step S3001), and determines whether the ServiceID contained in the control device and service management ID acquisition request <R-34> is stored on the storage unit 41 in the direct access management server 40 (FIG. 30: step S3002). If the ServiceID contained in the control device and service management ID acquisition request <R-34> is not stored on the storage unit 41, the service server 30 is not a service server of a service provider authorized by the direct access management server 40. The SOAP server 42 transmits an error code indicating that the ServiceID is unregistered as a control device and service management ID acquisition response <R-34R> (FIG. 30: step S3006). If the ServiceID is stored on the storage unit 41, the SOAP server 42 issues a new control device and service management ID (FIG. 30: step S3003), registers the association relationship between the control device and service management ID and the ServiceID on the storage unit 41 (FIG. 30: step S3004), and transmits to the service server 30 the control device and service management ID as the control device and service management ID acquisition response <R-34R> (FIG. 30: step S3005). By storing the control device and service management ID and the ServiceID in association with each other, the direct access management server 40 can uniquely identify the combination of the cellular phone 10 requesting the service and the service server 30 in subsequent service providing operations.

The service server 30 receives from the direct access management server 40 the control device and service management ID acquisition response <R-34R> containing the control device and service management ID (FIG. 28: step S2805), and registers the control device and service management ID in association with the user identification information of the cellular phone 10 (FIG. 28: step S2806).

Subsequent to the storage of the control device and service management ID in association with the user identification information on the storage unit 31, or if the control device and service management ID corresponding to the user identification information contained in the controlled device registration request <R-23> is already stored on the storage unit 31, the service server 30 transmits to the SOAP server 42 in the direct access management server 40 a controlled device registration request <R-25> containing the control device and service management ID and the ServiceID and the controlled device registration password acquired in step S2801 from the cellular phone 10 (FIG. 28: step S2807). The service server 30 requests the direct access management server 40 to link the DVR 20 as the controlled device identified by the controlled device registration password transmitted from the cellular phone 10 to the control device and service management ID identifying the combination of the cellular phone 10 as the control device and the service of the service server 30.

The SOAP server 42 in the direct access management server 40 receives the controlled device registration request <R-25> from the service server 30 (FIG. 30: step S3007), and determines whether the combination of the control device and service management ID and the ServiceID contained in the controlled device registration request <R-25> is registered (FIG. 30: step S3008). If the combination is not registered on the storage unit 41, the SOAP server 42 transmits to the service server 30 an error code, as a controlled device registration response <R-25R>, indicating that the combination of the control device and service management ID and the ServiceID is unregistered (FIG. 30: step S3013).

If the combination of the control device and service management ID and the ServiceID contained in the controlled device registration request <R-25> is already stored on the storage unit 41, the SOAP server 42 checks the controlled device registration password and the effective period (FIG. 30: step S3009). If the storage unit 41 does not store the password matching the controlled device registration password acquired from the service server 30, or if the effective period has expired, the SOAP server 42 transmits to the service server 30 an error code, as a controlled device registration response <R-25R>, indicating that the controlled device registration password contained in the controlled device registration request <R-25> is invalid (FIG. 30: step S3013).

The service server 30 receives from the SOAP server 42 the controlled device registration response <R-25R> containing one of the error code indicating the unregistered device and the error code indicating that the controlled device registration password is invalid (FIG. 28: step S2808). The service server 30 transmits to the cellular phone 10 an error code, as a controlled device registration response <R-26>, containing an error code indicating that an error has occurred in the registration process of the controlled device (FIG. 28: step S2809).

If the check result in step S3009 shows that the controlled device registration password acquired from the service server 30 is stored on the storage unit 41 and that the effective period has not expired, the SOAP server 42 searches for the device authentication continuation ID corresponding to the controlled device registration password acquired from the service server 30. This searching is performed with reference to the association of the controlled device registration password stored in step S2911 on the storage unit 41 with the device authentication continuation ID. The SOAP server 42 determines whether the controlled device management ID associated with the device authentication continuation ID as a result of the search is already assigned (FIG. 30: step S3010-1). If no controlled device management ID is assigned, the SOAP server 42 issues a new controlled device management ID (FIG. 30: step S3010-2). The SOAP server 42 thus stores on the storage unit 41 the ServiceID and the control device and service management ID corresponding to the device authentication continuation ID and the newly assigned controlled device management ID in association with each other (FIG. 30: step S3011). If it is determined in step S3010-1 that the controlled device management ID associated with the device authentication continuation ID is already assigned, the SOAP server 42 stores on the storage unit 41 the already assigned controlled device management ID and the ServiceID and the control device and service management ID corresponding to the device authentication continuation ID in association with each other.

The controlled device management ID is identification information uniquely assigned to the controlled device by the direct access management server 40. In this way, the control device and service management ID uniquely assigned to the combination of the control device and the service is linked to the controlled device management ID uniquely assigned to the controlled device. In the linking operation, a single control device and service management ID may be linked to a plurality of controlled device management IDs, or conversely, a single control device and service management ID may be linked to a plurality of controlled device management IDs.

The SOAP server 42 transmits to the service server 30 the controlled device registration response <R-25R> indicating that the controlled device has been registered (FIG. 30: step S3012). The service server 30 receives from the SOAP server 42 the controlled device registration response <R-25R> indicating the registration has been completed (FIG. 28: step S2808), and then transmits to the cellular phone 10 a controlled device registration response <R-26> indicating that the registration of the controlled device has been completed (FIG. 28: step S2809).

Upon receiving the controlled device registration response <R-26> from the service server 30 (FIG. 27: step S2704), the cellular phone 10 completes the registration process of the controlled device.

Subsequent to the completion of the registration process, the user issues to the DVR 20 an instruction to confirm that the controlled device management ID assigned to the DVR 20 is linked to the control device and service management ID by selecting a menu displayed on the TV screen connected to the DVR 20 (FIG. 31: step S3110).

Upon receiving the instruction to verify the link, the DVR 20 transmits to the SOAP server 42 in the direct access management server 40 a controlled device registration verification request <R-27> containing the device authentication continuation ID of the DVR 20 and the controlled device registration password stored on the storage unit 21 (FIG. 31: step S3111).

Upon receiving the controlled device registration verification request <R-27> from the DVR 20 (FIG. 29: step S2913), the SOAP server 42 checks the device authentication continuation ID and the effective period of the device authentication continuation ID contained in the controlled device registration verification request <R-27> (FIG. 29: step S2914).

If the check result in step S2914 is OK, i.e., the device authentication continuation ID of the DVR 20 is stored on the storage unit 41 with the effective period unexpired, the SOAP server 42 checks the effective period of the controlled device registration password (FIG. 29: step S2915). If the check result shows that the effective period of the controlled device registration password acquired from the DVR 20 has expired, the SOAP server 42 transmits to the DVR 20 an error code, as a controlled device registration verification response <R-27R>, indicating that the effective period of the controlled device registration password contained in the controlled device registration verification request <R-27> has expired (FIG. 29: step S2920). If the effective period of the controlled device registration password has not expired, the SOAP server 42 references information stored on the storage unit 41. The SOAP server 42 thus searches for the controlled device management ID stored on the storage unit 41 in association with the controlled device registration password contained in the controlled device registration verification request <R-27>, and examines the number of control device and service management IDs linked to the controlled device management ID as the number of services linked to the DVR 20.

After examining the number of services linked to the DVR 20, the SOAP server 42 transmits to the DVR 20 the information concerning the number of services as the controlled device registration verification response <R-27R> (FIG. 29: step S2916). In order to notify the service server 30 of the completion of the device registration of the DVR 20 as the controlled device, the SOAP server 42 transmits to the service server 30 a controlled device registration completion notification <R-28> containing the ServiceID of the service server 30 stored on the storage unit 41, the control device and service management ID associated with that ServiceID, and the controlled device registration password (FIG. 29: step S2917). The SOAP server 42 deletes the controlled device registration password of the DVR 20 stored on the storage unit 41 (FIG. 29: step S2918).

Upon receiving the controlled device registration completion notification <R-28> from the SOAP server 42 (FIG. 28: step S2310), the service server 30 notifies the cellular phone 10 of the completion of the registration of the controlled device (FIG. 28: step S2811). The service server 30 can notify the cellular phone 10 of the completion of the registration of the controlled device using an electronic mail, or an application prepared to communicate by another means with the cellular phone 10.

The DVR 20 receives from the SOAP server 42 the controlled device registration verification response <R-27R> containing the information concerning the number of services (FIG. 31: step S3112), sets the automatic connection flag to on (FIG. 31: step S3113), and displays a message indicating the completion of the registration of own device on the TV screen connected to own device (FIG. 31: step S3114).

If a no good check result is obtained in step S2814, the device authentication continuation ID of the DVR 20 is not stored on the storage unit 41, or the effective period of the device authentication continuation ID has expired. In such a case, the SOAP server 42 transmits to the DVR 20 an error code, as the controlled device registration verification response <R-27R>, indicating the check error of the device authentication continuation ID and the controlled device registration password (FIG. 30: step S3013). Upon receiving the error code indicating the check error as the controlled device registration verification response <R-27R> (FIG. 31: step S3125), the DVR 20 displays a message indicating that the device needs re-registration on the TV screen connected to own device (FIG. 31: step S3126). The operation of the DVR 20 thus ends.

After the automatic connection flag is set to be on on the DVR 20 (FIG. 31: step S3113) and the message indicating the completion of the registration of own device is displayed on the TV screen connected to own device (FIG. 31: step S3114), the DVR 20 transmits to the SOAP server 42 in the direct access management server 40 the XMPP login information acquisition request <D-0-1> containing the device authentication continuation ID of own device in order to establish a two-way stay-connected session with the XMPP server as the direct access management server 40 (FIG. 31: step S3115).

As in the network system of the first embodiment, the XMPP server 43 is used to establish a two-way stay-connected session with the controlled device in the direct access management server 40 in the network system of the present embodiment. The DVR 20 log in with the XMPP server 43 to establish the stay-connected session between the DVR 20 and the XMPP server 43 in order for the cellular phone 10 as the control device to access the DVR 20 as the controlled device. Each of the service server 30 and the cellular phone 10 acquires required information from the DVR 20 as necessary. As in the first embodiment, the XMPP protocol is hidden in the direct access management server 40 to simplify the design of the service server 30 in the network system of the present embodiment. With the SOAP interface only, the DVR 20 exchanges information with the XMPP server 43 with the two-way stay-connected session set therebetween.

Since the operation of the direct access management server 40 with the DVR 20 logging in with the XMPP server 43 remains unchanged from the operation of the counterpart in the first embodiment, FIG. 10 used to describe the first embodiment is also used in the description of the second embodiment of the present invention.

The direct access management server 40 receives from the DVR 20 the XMPP login information acquisition request <D-0-1> containing the device authentication continuation ID (FIG. 10: step S1001) and checks the device authentication continuation ID and the effective period of the device authentication continuation ID, contained in the XMPP login information acquisition request <D-0-1> (FIG. 10: step S1002). If the device authentication continuation ID contained in the XMPP login information acquisition request <D-0-1> fails to match the one stored on the storage unit 41 in the direct access management server 40, or if the effective period has expired, the DVR 20 may not be correctly registered in the direct access management server 40 or the effective period of the device authentication continuation ID, even if registered in the past, may have expired. The direct access management server 40 transmits to the DVR 20 an error code as an XMPP login information acquisition response <D-0-1R> indicating that device authentication is required (FIG. 10: step S1003). If the device authentication continuation ID is stored on the storage unit 41, if the effective period of the device authentication continuation ID has not expired, and if the check result in step S1002 is OK, the direct access management server 40 searches for the controlled device management ID linked to the device authentication continuation ID and the device authentication information on the storage unit 41 (FIG. 10: step S1004). From the controlled device management ID and the device authentication information, the direct access management server 40 generates FullJID(D) as an XMPP login ID required for the DVR 20 to log in with the SOAP server 42, an XMPP login password, and information relating to an effective period of the XMPP login password (FIG. 10: step S1005), and stores these pieces of information with the device authentication continuation ID associated therewith onto the storage unit 41 (FIG. 10: step S1006). The direct access management server 40 adds an XMPP address and port number, information concerning the authentication method, an SSL (Secure Socket Layer) option to the generated FullJID(D), XMPP login password, and information concerning the effective period of the XMPP login password and transmits the resulting added information as an XMPP login information acquisition response <D-0-1R> to the DVR 20 (FIG. 10: step S1007).

Upon receiving the XMPP login information acquisition response <D-0-1R> containing the FullJID(D) and the XMPP login password from the SOAP server 42 in the direct access management server 40 (FIG. 31: step S3116), the DVR 20 transmits to the XMPP server 43 in the direct access management server 40 an XMPP login authentication request <D-0-2> containing the FullJID(D) and the XMPP login password (FIG. 31: step S3117).

Upon receiving the XMPP login authentication request <D-0-2> from the DVR 20 (FIG. 10: step S1008), the XMPP server 43 in the direct access management server 40 checks the FullJID(D), the XMPP login password and the effective period of the XMPP login password contained in the XMPP login authentication request <D-0-2> (FIG. 10: step S1009). If FullJID(D) fails to match the one stored on the storage unit 41, if the XMPP login password fails to match the one stored on the storage unit 41, or if the effective period of the XMPP login password has expired, the XMPP server 43 transmits to the DVR 20 an error code as an XMPP login authentication response <D-0-2R> indicating that the XMPP login has failed (FIG. 10: step S1010). All of FullJID(D), the XMPP login password, and the effective period are satisfied, the XMPP server 43 in the direct access management server 40 transmits to the DVR 20 a code as an XMPP login authentication response <D-0-2R> indicating an XMPP login permit (FIG. 10: step S1011).

Upon receiving the error code as the XMPP login authentication response <D-0-2R> indicating an aborted XMPP login from the direct access management server 40 (FIG. 31: step S3118), the DVR 20 returns to step S3115 to place an acquisition request for the XMPP login information. Since there is a possibility that the effective period of the XMPP login password has expired, an XMPP login information acquisition request process is performed.

Upon receiving a code as the XMPP login authentication request <D-0-2> indicating the XMPP login permit from the direct access management server 40 (FIG. 6: step S619), the DVR 20 completes the XMPP login process.

When the DVR 20 has received from the SOAP server 42 in the direct access management server 40 the error code as the XMPP login information acquisition response <D-0-1R> indicating that device authentication is required (FIG. 31: step S3120), the DVR 20 itself may not be correctly registered in the direct access management server 40 or the effective period of the device authentication continuation ID may have expired. For this reason, the DVR 20 transmits to the SOAP server 42 in the direct access management server 40 the device authentication request <R-20> containing the information concerning the authentication method preset therein and the device authentication information in order to register own device (FIG. 31: step S3121).

The DVR 20 receives a device authentication response <R-20R> from the SOAP server 42 in the direct access management server 40 (FIG. 31: step S3122), and stores the device authentication continuation ID and the effective period thereof contained in the device authentication response <R-20R> in association with the device authentication information on the storage unit 21 (FIG. 31: step S3123). The DVR 20 proceeds to step S3115 to transmit to the SOAP server 42 in the direct access management server 40 again the XMPP login information acquisition request <D-0-1> containing own device authentication continuation ID.

If device authentication continuation ID of the DVR 20 contained in the controlled device registration verification request <R-27> received in step S2913 fails in step S2914 to match the device authentication continuation ID stored on the storage unit 41, or if the effective period of the device authentication continuation ID has expired, the SOAP server 42 transmits to the DVR 20 an error code, as the controlled device registration verification response <R-27R>, indicating that device authentication is required (FIG. 29: step S2919).

If the DVR 20 receives the error code, as the controlled device registration verification response <R-27R>, indicating that the device authentication is required (FIG. 31: step S3124), it is likely that own device is not correctly registered in the direct access management server 40 or that the effective period of the device authentication continuation ID has expired. The DVR 20 thus transmits to the SOAP server 42 in the direct access management server 40 the device authentication request <R-20> containing the information concerning the authentication method preset on own device and the device authentication information (FIG. 31: step S3121).

Upon receiving the device authentication response <R-20R> from the SOAP server 42 in the direct access management server 40 (FIG. 31: step S3122), the DVR 20 stores on the storage unit 31 the information concerning the device authentication continuation ID and the effective period thereof contained in the device authentication response <R-20R> with the device authentication information associated therewith (FIG. 31: step S3123). The DVR 20 proceeds to step S3115 to transmit to the SOAP server 42 in the direct access management server 40 the XMPP login information acquisition request <D-0-1> containing the device authentication continuation ID of own device.

As described above, the DVR 20 (controlled device) can acquire from the direct access management server 40 the controlled device registration password as a one-time password.

In the above discussion, the two-dimensional bar code is imaged using the camera mounted on the cellular phone 10 in order to transfer the information concerning controlled device registration password and the effective period thereof to the cellular phone 10. Any method is acceptable as long as the DVR 20 can transfer the information concerning controlled device registration password and the effective period thereof. For example, the DVR 20 may be equipped with a contactless IC card writing device and the cellular phone 10 may be equipped with an IC card reading device. The DVR 20 writes the information concerning controlled device registration password and the effective period thereof onto an IC card, and the cellular phone 10 reads the information from the IC card. The IC card is used as a medium. A mechanism such as an antenna and an IC chip included in the IC card may be housed in the cellular phone 10 so that the writing device of the DVR 20 may directly write data on the cellular phone 10. Alternatively, each of the cellular phone 10 and the DVR 20 may be equipped with a wireless device such as a wireless LAN, Bluetooth, or an infrared communication unit so that the information concerning controlled device registration password and the effective period thereof may be transferred by means of wireless communications. Alternatively, each of the cellular phone 10 and the DVR 20 may be equipped with a wired communication device so that the information may be transferred by means of wired communication.

The configuration and operation of the network system of embodiments of the present invention have been discussed. Part of the function of the service server 30 may be transferred to the control device. For example, the accessing function to the SOAP interface, performed by the service server 30, may be transferred to the control device (cellular phone 10). The direct access sequence starting with the XMPP login request is thus directly performed between the control device (cellular phone 10) and the direct access management server 40.

The function of the control device and the function of the controlled device may be integrated. When the control device (cellular phone 10) accesses the XMPP session controlled device (DVR 20), information required to perform the direct access may be exchanged between XMPP sessions without using the SOAP server 42.

Direct access can be performed between controlled devices. In this case, the association of the controlled devices may be performed using the control device.

In the preceding embodiments, the service server 30 is interposed between the cellular phone 10 as the control device and the direct access management server 40, and the control device and service management ID generated for the combination of the cellular phone 10 and the service server 30 is stored with the controlled device management ID associated therewith. The present invention is not limited to this method. The present invention is applicable when communications are directly performed between the control device and the direct access management server 40 without the service server 30 involved. In this case, the direct access management server 40 generates a control device management ID identifying the control device instead of the control device and service management ID discussed in the preceding embodiments, and stores the control device management ID with the controlled device management ID associated therewith. The control device management ID may be generated by the direct access management server 40. Since an ID identifying the control device itself is publicly disclosed, that ID may be used as a control device management ID with the controlled device management ID associated therewith. The same is true of the controlled device management ID. If an ID identifying the controlled device itself is publicly disclosed, that ID may be used as a controlled device management ID with the control device management ID associated therewith. Device, as a control device and a controlled device, connected to the direct access management server 40 may contain both part controlled by another device and part controlling another device.

(Concept of the Present Invention)

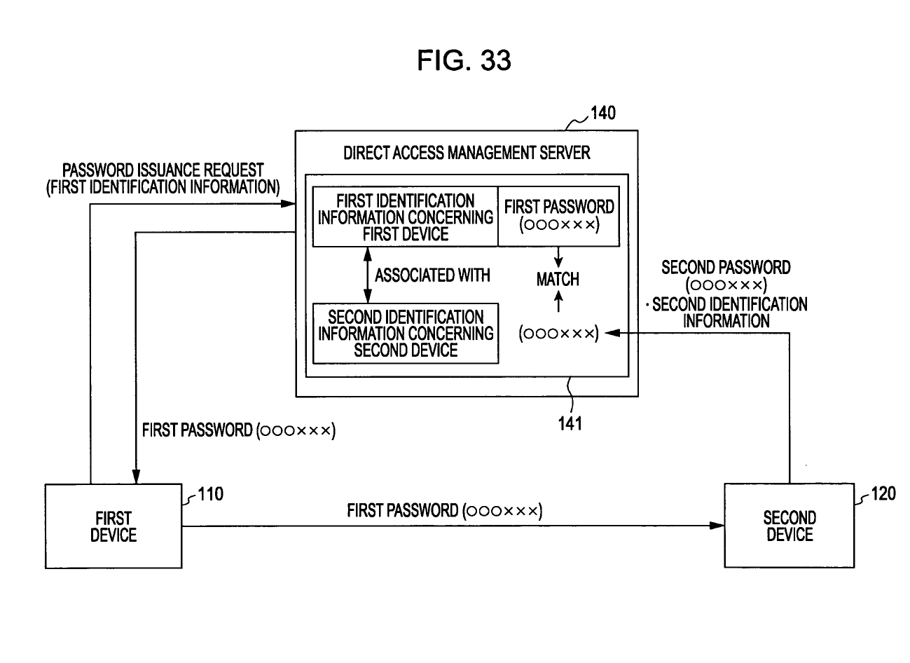

FIG. 33 illustrates features of the present invention. A server 140 of the present invention is connected to a first device 110 and a second device 120 via a network. The server 140 includes a storage unit 141. The storage unit 141 corresponds to the storage unit 41. The server 140 generates a first password in response to a password issuance request of a password containing first identification information relating to the first device 110, stores on the storage unit 141 the first password in association with the first identification information relating to the first device 110, and transmits the first password to the first device 110. Each of the first device 110 and the second device 120 contains both part controlling another device and part controlled by another device.

The first device 110 transfers the first password acquired from the server 140 to the second device 120, and the second device 120 stores the first password as a second password. The second device 120 transmits to the server 140 the second password and the second identification information relating to the second device 120 in order to request the server 140 to register the second device 120 itself. The server 140 determines whether the second password received from the second device 120 is stored on the storage unit 141. If the second password is stored on the storage unit 141, the server 140 registers on the storage unit 141 the second password relating to the second device 120 with first identification information corresponding to the first password identical to the second password. The server 140 thus completes the association between the first identification information of the first device 110 and the second identification information of the second device 120, i.e., associates the control device with the controlled device.

The first identification information of the first device 110 to be stored on the storage unit 141 in the server 140 may be the one generated by the server 140 or the one of own device supplied from the first device 110 itself. The second identification information of the second device 120 stored on the storage unit 141 in the server 140 may be the one the one generated by the server 140 or the one of own device supplied from the second device 120 itself.

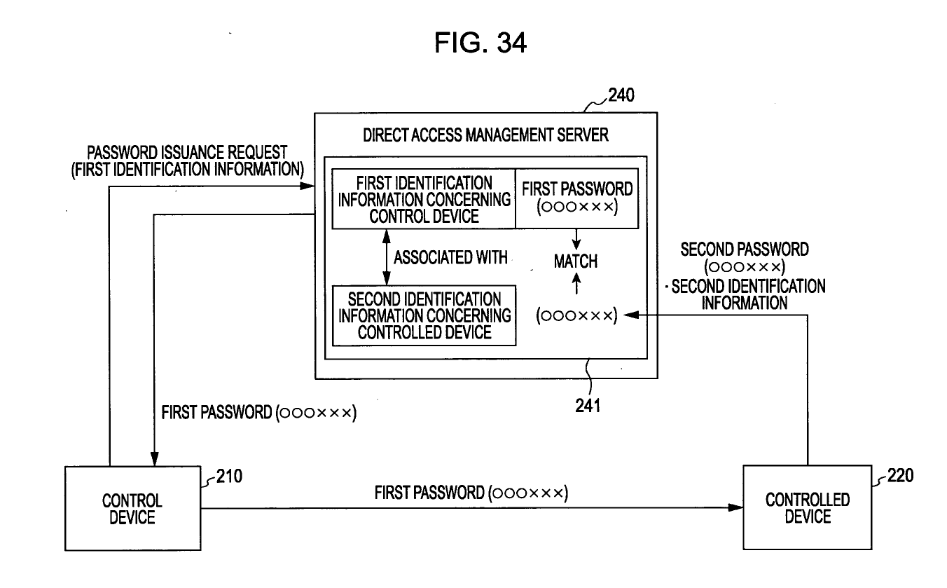

FIG. 34 illustrates a modification of the server of FIG. 33 in accordance with the present invention. In this embodiment, a server 240 is connected to a control device 210 and a controlled device 220 via a network. The server 240 generates a first password in response to a password issuance request from the control device 210 containing first identification information relating to the control device 210, stores on a storage unit 241 the first password with the first identification information relating to the control device 210 associated therewith, and then transmits the generated first password to the control device 210.

The control device 210 transmits the first password acquired from the server 240 to the second device 220, and the controlled device 220 stores the first password as a second password. The controlled device 220 transmits the second password and second identification information of the controlled device 220 to the server 240 in order to request the server 240 to register the controlled device 220 itself. The server 240 determines whether the second password received from the controlled device 220 is stored on the storage unit 241. If the second password is stored on the storage unit 241, the server 240 registers on the storage unit 241 the second identification information of the controlled device 220 with the first identification information corresponding to the first password identical to the second password associated therewith. The server 240 thus associates the first identification information of the control device 210 with the second identification information of the controlled device 220.

The first identification information of the control device 210 to be stored on the storage unit 241 in the server 240 may be the one generated by the server 240, or identification information of own device supplied from the control device 210 itself. The second identification information of the controlled device 220 to be stored on the storage unit 241 in the server 240 may be the one generated by the server 240 or identification information of own device supplied from the controlled device 220 itself.

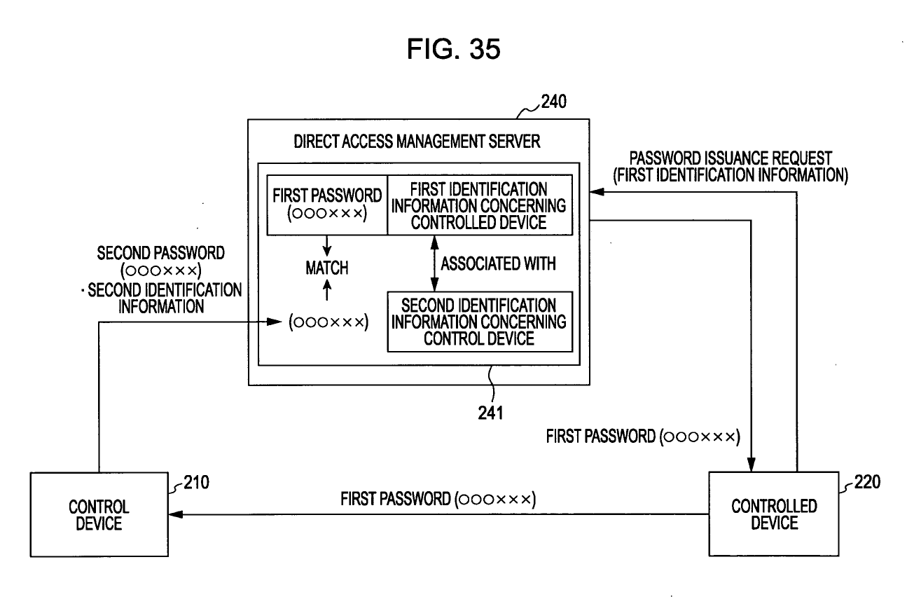

FIG. 35 illustrates another modification of the server of FIG. 33 in accordance with the present invention. In this modification, a server 340 is connected to a control device 310 and a controlled device 320 via a network as in the server 240 of FIG. 34. In this example, however, the server 340 generates a first password in response to a password issuance request from the controlled device 320 containing first identification information of the controlled device 320, stores the first password on a storage unit 341 with the first identification information of the controlled device 320 associated therewith, and transmits the first password to the controlled device 320.

The controlled device 320 transfers the first password acquired from the server 340 to the control device 310, and the control device 310 stores the first password as a second password. The control device 310 transmits the second password and second identification information of the control device 310 to the server 340 in order to request the server 340 to register the control device 310 itself. The server 340 determines whether the second password received from the control device 310 is stored on the storage unit 341. If the second password is stored on the storage unit 341, the server 340 registers the second identification information of the control device 310 on the storage unit 341 with the first identification information corresponding to the first password identical to the second password associated therewith. In this way, the server 340 associates the first identification information of the controlled device 320 with the second identification information of the control device 310.

The first identification information of the controlled device 320 to be stored on the storage unit 341 in the server 340 may be the one generated by the server 340 or identification information of own device supplied from the controlled device 320. The second identification information of the control device 310 to be stored on the storage unit 341 in the server 340 may be the one generated by the server 240 or identification information of own device supplied from the control device 310.

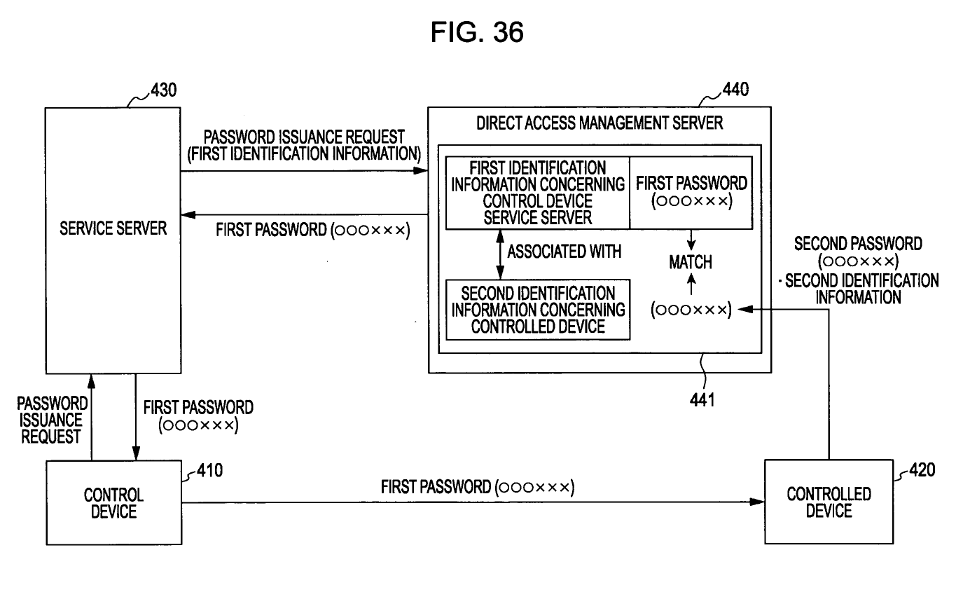

FIG. 36 is yet another modification of the server of FIG. 33 in accordance with the present invention. In this modification, a control device 410 is connected to a server 440 via a service server 430. The server 440 is connected to each of the service server 430 and a controlled device 420. The service server 430 provides a variety of services to the control device 410 such as a cellular phone accessing the controlled device 420 via a network. This modification thus corresponds to each of the first embodiment and the second embodiment.

The server 440 generates a first password in response to a password issuance request coming in from the control device 410 via the service server 430, stores on a storage unit 441 the first password with first identification information of the service server 430 and the control device 410 associated therewith, and transmits the first password to the control device 410 via the service server 430. The control device 410 transfers the first password acquired from the server 440 via the service server 430 to the controlled device 420 and the controlled device 420 stores the first password as a second password.

The controlled device 420 transmits the second password and the second identification information of the controlled device 420 to the server 440 in order to request the server 440 to register own device. The server 440 determines whether the second password received from the controlled device 420 is stored on a storage unit 441. If the second password is stored on the storage unit 441, the server 440 stores on the storage unit 441 the second identification information of the controlled device 420 with the first identification information corresponding to the first password identical to the second password associated therewith. In this way, the server 440 associates the first identification information of the control device 410 with the second identification information of the controlled device 420.

The present invention is not limited to the above-described embodiments, and a variety of changes may be incorporated in the present invention without departing from the scope of the present invention.

1. A server apparatus for registering a first device and a second device with the devices associated with each other, the first device being linked to the second device via a network, comprising:
storage means for storing information;
first processing means for generating a first password in response to a password issuance request from the first device, storing the first password with first identification of the first device associated therewith on the storage means, and transmitting the first password to the first device; and
second processing means for receiving a second password transmitted from the second device, determining whether the received second password is the one stored on the storage means, and storing second identification information of the second device with the first identification information associated therewith if the second password is stored on the storage means.

2. The server apparatus according to claim 1, wherein the first processing means generates the first identification information of the first device, and stores the first identification information and the first password in association with each other on the storage means.

3. The server apparatus according to claim 2, wherein the first device is connected to the server apparatus via a service server apparatus providing a service to the first device, and
wherein the first processing means generates, as the first identification information, identification information of the first device and the service server apparatus.

4. The server apparatus according to claim 3, wherein the first processing means generates, as the first identification information, identification information of a combination of the first device and the service provided by the service server apparatus.

5. The server apparatus according to claim 1, further comprising means for performing a device authentication process authenticating the second device, generating authentication identification information relating to authentication information required to authenticate the second device, and transmitting the generated authentication identification information to the second device,
wherein the second processing means stores, as the second identification information, the authentication identification information with the first identification information associated therewith on the storage means.

6. The server apparatus according to claim 1, wherein the first processing means sets an effective period to the first password, and
wherein the second processing means checks the effective period and if the effective period of the first password has expired, does not associate the second identification information with the first identification information.

7. The server apparatus according to claim 6, wherein the first processing means transmits to the first device the generated first password and information relating to the effective period of the first password.

8. The server apparatus according to claim 1, wherein the server apparatus associates a plurality of pieces of second identification information with the first identification information.

9. The server apparatus according to claim 1, wherein the server apparatus associates the second identification information with a plurality of pieces of first identification information.

10. The server apparatus according to claim 1, wherein the second processing means deletes the first password stored on the storage means when the second identification information is stored with the first identification information associated therewith.

11. The server apparatus according to claim 1, further comprising means for generating a list of the second identification information with the first identification information associated therewith based on association between the first identification information and the second identification information stored on the storage means and transmitting the list to the first device.

12. The server apparatus according to claim 1, wherein upon receiving a request from the first device forwarded to the second device, the server apparatus determines whether the first identification information of the first device is stored with the second identification information associated therewith on the storage means, and transmits an error signal to the first device if the first identification information is not stored with the second identification information associated therewith.

13. The server apparatus according to claim 1, wherein upon receiving a request from the first device forwarded to the second device, the server apparatus determines whether the first identification information of the first device is stored with the second identification information associated therewith on the storage means, and transmits the request from the first device to the second device if the first identification information is stored with the second identification information associated therewith.

14. A method of registering a first device and a second device with the devices associated with each other on a server apparatus, the first device being linked to the second device via a network, comprising:
a step of first processing means for generating a first password in response to a password issuance request from the first device, storing on storage means the first password with first identification information of the first device associated therewith, and transmitting the first password to the first device; and
a step of second processing means for receiving a second password transmitted from the second device, determining whether the received second password is the one stored on the storage means, and storing second identification information of the second device with the first identification information associated therewith if the second password is stored on the storage means.

15. A program for causing a computer, as a server apparatus, having a storage unit to store a first device and a second device with the devices associated with each other, the first device being linked to the second device via a network, the program comprising:
a first processing unit for causing the computer to generate a first password in response to a password issuance request from the first device, store on the storage unit the first password with first identification information of the first device associated therewith, and transmit the first password to the first device; and
a second processing unit for causing the computer to receive a second password transmitted from the second device, determine whether the received second password is the one stored on the storage unit, and store second identification information of the second device with the first identification information associated therewith if the second password is stored on the storage unit.

16. A recording medium storing a program for causing a computer, as a server apparatus, having a storage unit to store a first device and a second device with the devices associated with each other, the first device being linked to the second device via a network, the program comprising:
a first processing unit for causing the computer generate a first password in response to a password issuance request from the first device, store on the storage unit the first password with first identification information of the first device associated therewith, and transmit the first password to the first device; and
a second processing unit for causing the computer to receive a second password transmitted from the second device, determine whether the received second password is the one stored on the storage unit, and store second identification information of the second device with the first identification information associated therewith if the second password is stored on the storage unit.
